(19) United States
(12) Patent Application Publication
(10) Pub. No.: US 2018/0300788 A1
(43) Pub. Date: Oct. 18, 2018

(54) VECTOR-BASED CHARACTERIZATIONS OF PRODUCTS AND INDIVIDUALS WITH RESPECT TO PERSONAL PARTIALITIES SUCH AS A PROPENSITY TO BEHAVE AS A FIRST ADOPTER

(71) Applicant: Walmart Apollo, LLC, Bentonville, AR (US)

(72) Inventors: Todd D. Mattingly, Bentonville, AR (US); Bruce W. Wilkinson, Rogers, AR (US)

(21) Appl. No.: 15/953,113

(22) Filed: Apr. 13, 2018

Related U.S. Application Data
(60) Provisional application No. 62/502,870, filed on May 8, 2017.
(60) Provisional application No. 62/491,455, filed on Apr. 28, 2017.
(60) Provisional application No. 62/511,559, filed on May 26, 2017.
(60) Provisional application No. 62/571,867, filed on Oct. 13, 2017.
(60) Provisional application No. 62/485,045, filed on Apr. 13, 2017.

(51) Int. Cl. G06Q 30/06; G06Q 30/00

(52) U.S. Cl. CPC G06Q 30/0625; G06Q 30/016

(57) ABSTRACT

Various partialities (including but not limited to partialities based on values, aspirations, preferences, affinities, and/or propensities that exhibit first adopter behaviors) for individual persons are represented as corresponding vectors. The length and/or the angle of the vector represents the magnitude of the strength of the individual's belief in the good that comes from that imposed order. Vectors can also be specified to characterize corresponding products and/or services. These vectors for persons and products/services can be leveraged in any of a wide variety of ways.

### RELATED APPLICATION(S)

This application claims the benefit of U.S. Provisional Application No. 62/502,870, filed May 8, 2017, U.S. Provisional Application No. 62/491,455 filed Apr. 28, 2017, U.S. Provisional Application No. 62/511,559 filed May 26, 2017, U.S. Provisional Application No. 62/571,867 filed Oct. 13, 2017, and U.S. Provisional Application No. 62/485,045, filed Apr. 13, 2017, all of which are incorporated herein by reference in their entirety.

### TECHNICAL FIELD

These teachings relate generally to providing products and services to individuals.

### BACKGROUND

Various shopping paradigms are known in the art. One approach of long-standing use essentially comprises displaying a variety of different goods at a shared physical location and allowing consumers to view/experience those offerings as they wish to thereby make their purchasing selections. This model is being increasingly challenged due at least in part to the logistical and temporal inefficiencies that accompany this approach and also because this approach does not assure that a product best suited to a particular consumer will in fact be available for that consumer to purchase at the time of their visit.

Increasing efforts are being made to present a given consumer with one or more purchasing options that are selected based upon some preference of the consumer. When done properly, this approach can help to avoid presenting the consumer with things that they might not wish to consider. That said, existing preference-based approaches nevertheless leave much to be desired. Information regarding preferences, for example, may tend to be very product specific and accordingly may have little value apart from use with a very specific product or product category. As a result, while helpful, a preferences only-based approach is inherently very limited in scope and offers only a very weak platform by which to assess a wide variety of product and service categories.

### BRIEF DESCRIPTION OF THE DRAWINGS

The above needs are at least partially met through provision of the vector-based characterizations of products and individuals with respect to personal partialities such as a propensity to behave as a first adopter described in the following detailed description, particularly when studied in conjunction with the drawings, wherein:

FIG. 1 comprises a flow diagram as configured in accordance with various embodiments of these teachings;

FIG. 2 comprises a flow diagram as configured in accordance with various embodiments of these teachings;

FIG. 3 comprises a graphic representation as configured in accordance with various embodiments of these teachings;

FIG. 4 comprises a graph as configured in accordance with various embodiments of these teachings;

FIG. 5 comprises a flow diagram as configured in accordance with various embodiments of these teachings;

FIG. 6 comprises a graphic representation as configured in accordance with various embodiments of these teachings;

FIG. 7 comprises a graphic representation as configured in accordance with various embodiments of these teachings;

FIG. 8 comprises a graphic representation as configured in accordance with various embodiments of these teachings;

FIG. 9 comprises a flow diagram as configured in accordance with various embodiments of these teachings;

FIG. 10 comprises a flow diagram as configured in accordance with various embodiments of these teachings;

FIG. 11 comprises a graphic representation as configured in accordance with various embodiments of these teachings;

FIG. 12 comprises a graphic representation as configured in accordance with various embodiments of these teachings;

FIG. 13 comprises a block diagram as configured in accordance with various embodiments of these teachings;

FIG. 14 comprises a flow diagram as configured in accordance with various embodiments of these teachings;

FIG. 15 comprises a graph as configured in accordance with various embodiments of these teachings;

FIG. 16 comprises a flow diagram as configured in accordance with various embodiments of these teachings;

FIG. 17 comprises a block diagram as configured in accordance with various embodiments of these teachings;

FIG. 18 comprises a block diagram as configured in accordance with various embodiments of these teachings;

FIG. 19 comprises a flow diagram as configured in accordance with various embodiments of these teachings;

FIG. 20 comprises a flow diagram as configured in accordance with various embodiments of these teachings;

FIG. 21 comprises a block diagram as configured in accordance with various embodiments of these teachings;

FIG. 22 comprises a flow diagram as configured in accordance with various embodiments of these teachings;

FIG. 23 comprises a flow diagram as configured in accordance with various embodiments of these teachings;

FIG. 24 comprises a display diagram as configured in accordance with various embodiments of these teachings;

FIG. 25 is an exemplary block diagram of a system for virtual coaching on use of a product in accordance with some embodiments;

FIG. 26 is a schematic illustration of a library database in accordance with some embodiments;

FIG. 27 is an exemplary flow diagram of a system for virtual coaching on use of a product in accordance with some embodiments;

FIG. 28 is an exemplary flow diagram of a system for virtual coaching on use of a product in accordance with some embodiments;

FIG. 29 is an exemplary flow diagram of a system for virtual coaching on use of a product in accordance with some embodiments;

FIG. 30 is an exemplary flow diagram of a system for virtual coaching on use of a product in accordance with some embodiments;

FIG. 31 illustrates an exemplary system for use in implementing methods, techniques, devices, apparatuses, systems, servers, sources, and virtual coaching on use of a product, in accordance with some embodiments;

FIG. 32 is a schematic block diagram as configured in accordance with various embodiments of these teachings;

FIG. 33 is a flow diagram as configured in accordance with various embodiments of these teachings;

FIG. 34 is flow diagram as configured in accordance with various embodiments of these teachings; and

FIG. 35 is an illustrative system for use in implementing systems, apparatuses, devices, methods, techniques, and the like in managing the shopping system as configured in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, many of these embodiments provide for a memory having information stored therein that includes partiality information for each of a plurality of persons in the form of a plurality of partiality vectors for each of the persons wherein each partiality vector has at least one of a magnitude and an angle that corresponds to a magnitude of the person's belief in an amount of good that comes from an order associated with that partiality, wherein the partiality information includes, at least in part, information regarding a particular person's propensity to behave as a first adopter. This memory can also contain vectorized characterizations for each of a plurality of products, wherein each of the vectorized characterizations includes a measure regarding an extent to which a corresponding one of the products accords with a corresponding one of the plurality of partiality vectors.

Rules can then be provided that use the aforementioned information in support of a wide variety of activities and results. Although the described vector-based approaches (and certainly not content representing a particular person's propensity to behave as a first adopter) bear little resemblance (if any) (conceptually or in practice) to prior approaches to understanding and/or metricizing a given person's product/service requirements, these approaches yield numerous benefits including, at least in some cases, reduced memory requirements, an ability to accommodate (both initially and dynamically over time) an essentially endless number and variety of partialities and/or product attributes, and processing/comparison capabilities that greatly ease computational resource requirements and/or greatly reduced time-to-solution results.

So configured, these teachings can constitute, for example, a method for automatically correlating a particular product with a particular person by using a control circuit to obtain a set of rules that define the particular product from amongst a plurality of candidate products for the particular person as a function of vectorized representations of partialities for the particular person and vectorized characterizations for the candidate products. This control circuit can also obtain partiality information for the particular person in the form of a plurality of partiality vectors that each have at least one of a magnitude and an angle that corresponds to a magnitude of the particular person's belief in an amount of good that comes from an order associated with that partiality and vectorized characterizations for each of the candidate products, wherein each of the vectorized characterizations indicates a measure regarding an extent to which a corresponding one of the candidate products accords with a corresponding one of the plurality of partiality vectors. The control circuit can then generate an output comprising identification of the particular product by evaluating the partiality vectors and the vectorized characterizations against the set of rules.

The aforementioned set of rules can include, for example, comparing at least some of the partiality vectors for the particular person to each of the vectorized characterizations for each of the candidate products using vector dot product calculations. By another approach, in lieu of the foregoing or in combination therewith, the aforementioned set of rules can include using the partiality vectors and the vectorized characterizations to define a plurality of solutions that collectively form a multi-dimensional surface and selecting the particular product from the multi-dimensional surface. In such a case the set of rules can further include accessing other information (such as objective information) for the particular person comprising information other than partiality vectors and using the other information to constrain a selection area on the multi-dimensional surface from which the particular product can be selected.

By one approach these teachings will accommodate characterizations associated with products in augmented reality visualizations.

By another approach these teachings will accommodate being leveraged to support virtual coaching on the use of products. Generally, if a customer has a question regarding a particular use of a product while shopping at a retail store, the customer would either ask a retail associate the question or perform multiple searches online to find the particular use of the product the customer is looking for. These teachings, however, will support providing a system that includes a library database having libraries of product listings. Each of the libraries is associated with a particular customer of a plurality of customers. By one approach, the system may include a control circuit coupled to the library database. The control circuit may predict one or more intentions of the particular customer when the particular customer is at a retail store. In one configuration, the control circuit may determine at least one product associated with the one or more intentions of the particular customer. In another configuration, the control circuit may also provide a first how-to-use data associated with the at least one product to the particular customer in response to the control circuit determining the at least one product. By one example, the first how-to-use data associated with the at least one product may be provided, via at least one transceiver, to the particular customer during a time when the particular customer is at the retail store. By another approach, the control circuit may create a particular library in the libraries of product listings with a product identifier of the at least one product. By one example, the product identifier of the at least one product may be associated in the particular library with the first how-to-use data. In one configuration, the particular library may be associated with the particular customer. The system may also include the at least one transceiver coupled to the control circuit. The at least one transceiver may interface with at least one device associated with the particular customer.

In some embodiments, there is provided a method for virtual coaching on use of product including predicting one or more intentions of a particular customer when the particular customer is at a retail store. The method may include determining at least one product associated with the one or more intentions of the particular customer. By one approach, the method includes providing a first how-to-use data associated with the at least one product to the particular customer. By one example, providing the first how-to-use data may be in response to a control circuit determining the at least one product. The first how-to-use data associated with the at least one product may be provided to the particular customer via at least one transceiver at a time when the particular customer is at the retail store. By another approach, the method may include creating a particular library of the libraries of product listings with a product identifier of the at least one product. In one configuration, in the particular library, the product identifier of the at least one product may be associated with the first how-to-use data. In another configuration, the particular library may be associated with the particular customer. By another approach, the method may be implemented by a control circuit coupled to a library database. The library database may include libraries of product listings. In one configuration, each of the libraries may be associated with a particular customer of a plurality of customers.

In some embodiments, there is provided a retail coaching system that coaches on use of a product. The coaching system may include a library database having libraries of product listings. Each library may be associated with a customer and/or products. By one approach, a library may be added to the library database for each customer that enters a retail store (physical retail store and/or virtual retail store). By another approach, a library may be added for each customer associated in a customer profile database. In one configuration, one or more retail products are associated with each library. For example, a product may be associated with a library based on the customer's interaction with the product. Interactions may include historic purchases of a product, consideration of the product for a threshold period of time (e.g., touching, looking, or the like), selecting the product in the virtual retail store, searching online for the product, proximity to the product relative to other products in an area of the retail store, scanning a product identifier of the product, and/or verbal cues or utterance of the product's name and/or particular characteristics of the product, among other type of interactions that a customer may do towards a product.

In an illustrative non-limiting example, the customer may want to determine a general and/or a particular use of a product. For example, the customer may want to know situations where a product may be used, combined uses of the product with another product the customer may be purchasing, applicability and/or suitability of the product to a particular use the customer may have in mind, and/or other products the customer may need in conjunction with the general use and/or the particular use of the product, among other information the customer may want to know regarding the product. As such, the customer may want at least instructions, images and/or videos of how-to-use data (information) regarding one or more of possible uses. A database including at least multiple different how-to-use data (e.g., instructions, images, videos, audio, etc.) corresponding to multiple different products may be accessed. Thus, a library that is associated with a customer in a library database may include and/or updated with how-to-use data of at least one product. By one approach, the library may include identifiers of two products that are associated with one how-to-use data. In this approach, for example, the how-to-use data may correspond to video images of using the two products to accomplish a particular task, to build a particular item, or the like.

For example, to replace a non-working power outlet at home, a customer may decide to buy a voltmeter and a power outlet at a retail store. The coaching system may predict that the customer intend to replace a power outlet based, at least in part, on these two products. In one configuration, the system may provide the customer a how-to-use data (e.g., video stream) of replacing a power outlet through an electronic device interface. By one approach, the electronic device interface may operate on an electronic device (e.g., smartphone, tablet, laptop, computer, wearable device, etc.) associated with the customer. In one scenario, the how-to-use data may show, demonstrate, and/or explain usage of the voltmeter during an installation of the power outlet.

As such, the coaching system may predict one or more intentions of a customer based on at least one of customer's interactions with one or more products while at the retail store, previous predictions of the coaching system, sensor data captured by one or more sensors installed at the retail store, and customer's partiality vectors. By one approach, using the one or more sensors, such as optical sensors, the coaching system may determine products the customer considers while at the retail store by tracking the products the customer has looked at and/or touched, length of time the customer considered each of the products, whether the customer placed the products in a cart, and/or whether the customer considered other similar products, among other ways to determine that a customer is considering the products. Thus, the coaching system may predict the one or more intentions based on uses and/or functions that are typically attributable to each of the products. In on configuration, a product database including a plurality of products, where each of the plurality of products is associated with functions and uses attributable to the product.

In one configuration, a prediction of the coaching system may be based on previous predictions the coaching system have made. In such configuration, the coaching system may determine a level of similarity between uses and/or functions attributable to the products that the previous predictions were based on and to the products the customer are currently interacting with. In such approach, the coaching system may determine that the products are similar when the level of similarity is above a predetermined threshold. Alternatively or in addition to, the prediction of the coaching system may be based on the customer's partiality vectors. The coaching system may determine an alignment of vector characterizations associated with each of the products with each of the partiality vectors associated with the customer. As such, if there is a high magnitude of alignment of vector characterizations associated with the products with a particular partiality vector, the coaching system may predict the customer's intentions based on partiality associated with the partiality vectors. Further descriptions are describe in paragraphs below.

In another configuration, the coaching system may recommend another product the customer may want to at least consider and/or purchase based, at least, on a predicted intended use of one or more products. Alternatively or in addition to, the coaching system may recommend another product based, at least in part, on how-to-use data associated with the one or more products, and/or the products themselves. Continuing the example described above, the coaching system may also send a message to the customer through the electronic device interface indicating a recommendation to purchase wire caps that may be used in replacing the non-working power outlet. Thus, in addition to the how-to-use data regarding replacing a power outlet, the system may also send a second how-to-use data regarding usage of the wire caps and/or proper installation of the power outlet using the wire caps.

Continuing the example described above, in another configuration, the retail coaching system may recommend another product that is tangentially related to the power outlet and/or the voltmeter. A first product may be tangentially related with a second product when the first product is cooperatively used or used in conjunction with the second product to perform a particular function or usage. As such in the example described above, the coaching system may determine a third how-to-use data based on the power outlet, the voltmeter, the recommended tangential product, and/or the predicted intended use of the power outlet, the voltmeter, and/or the recommended tangential product. To illustrate, in the example described above, the coaching system may recommend a circuit breaker. The circuit breaker may be tangentially related to the power outlet and/or the voltmeter since removing, changing, and/or installing the power outlet does not generally lead to removing and/or changing the circuit breaker. However, the customer may need to replace and/or check the circuit breaker before or after changing the power outlet when, after replacing the power outlet, no voltage is detected at power outlet. By another approach, the coaching system may recommend another tangentially related product such as a lightning rod. Thus, the coaching system may provide a fourth how-to-use data regarding usage of a lightning rod.

To further illustrate, continuing from the example described above, the library of product listings associated with the customer may be associated with the voltmeter, the power outlet, the wire caps, the circuit breaker, and/or the lightning rod. By one approach, one or more of these products may each be associated with the library. In one configuration, the voltmeter, the power outlet, and the wire caps may be associated with a particular library of the library of product listings. By another approach, these products may also be associated in the library with a first how-to-use data. In another configuration, the wire caps may also be associated with a second how-to-use data. In yet in another configuration, the power outlet and the circuit breaker may be associated with a third how-to-use data. Yet, in another configuration, a forth how-to-use data may be associated with the power outlet, the voltmeter, and the lightning rod. In yet another configuration, a fifth how-to-use data may be associated with all five products. Thus, each library may be tailored or customized to a particular customer based, at least, on predicted intentions of the particular customer, products recommended to the particular customer, and/or corresponding how-to-use data associated with the recommended products. By one approach, the library of the particular customer may include one or more product identifiers associated with recommended products and corresponding how-to-use data associated with the recommended products. By another approach, the library of the particular customer may include memory pointers or links to the one or more product identifiers associated with the recommended products and the corresponding how-to-use data.

In another configuration, the coaching system dynamically updates and adjusts a library as a customer interacts with multiple products at one or more retail stores over a period of time. By one approach, each library may be attributable to a particular day and/or time of retail visit by the customer. Alternatively or in addition to, each library may be attributable to a visit to a particular store. By another approach, a customer may exclusively be associated with one particular library. In such approach, the one particular library may include a cumulative listing of interacted products, recommended products, and/or corresponding how-to-use data associated with the customer. Thus, in either approach, the how-to-use data may be initially provided to the customer at a retail store by the coaching system. Moreover, the same how-to-use data provided to the customer while at the retail store may also be provided to the customer at a location separate from the retail store (e.g., at the customer's house, vehicle, at a distinct retail store, among other places distinct from the retail store that the customer may want to view the how-to-use data for at least a second time).

In another configuration, one or more databases may be communicatively linked with a library database. For example, a customer profile database, a content database, and/or a product database may be communicatively linked with the library database. As such, upon adding a library in the library database, the coaching system may associate a customer to the library by accessing the customer profile database and determining a location of a customer profile of the customer in the customer profile database. Subsequently, the coaching system may create a link or a pointer in the library database to the location of the customer profile in the customer profile database. The created link or pointer may be associated with the library of the customer by the coaching system. For example, a link or a pointer may enable the coaching system to associate a particular library with a particular customer in the customer profile database.

In another configuration, the coaching system may access the product database to determine a location of a particular product identifier in the product database. By one approach, the coaching system may determine the particular product identifier based, at least, on a scan of the particular product identifier by the customer using at least one of a product scanner dispersed throughout the retail store and coupled to the coaching system. By another approach, the customer may use a smartphone to scan the particular product identifier. By another approach, an image recognition system coupled to the coaching system may identify the product identifier after recognizing a particular product and/or directly identify the product identifier itself from a plurality of video streams provided by one or more optical sensors. Subsequently, the coaching system may create a link or a pointer of the particular product identifier that can be associated with the library in the library database. Moreover, the coaching system may also access the content database to determine a location of a particular how-to-use data associated with the product and create a link or a pointer to this location and associate the link or the pointer with the library.

In another configuration, the coaching system may determine the particular how-to-use data based, at least in part, on interacted products, recommended products, and/or a customer associated with the library. By one approach, the particular how-to-use data may be associated with one or more keywords (e.g., tags, metadata, or the like). The keywords may comprise one or more product identifiers, functions or uses of the one or more products, or the like that facilitate associations of the particular how-to-use data with one or more products that are used in the particular how-to-use data. As such, the coaching system may determine the particular how-to-use data by comparing keywords associated with the interacted and/or recommended products with keywords associated with the how-to-use data. By this approach, the coaching system may perform keywords search in the content database including a plurality of how-to-use data.

In another configuration, each library in the library database may be associated with multiple links or pointers to multiple databases. In one configuration, the system may include a master database having multiple sub-databases, such as one or more of the customer profile database, the content database, the library database, and/or a product database. Each of the sub-databases may act independent of another sub-database. In another configuration, one or more of the sub-databases may cooperatively work together as a single database to the master database.

In an illustrative non-limiting example where the customer may eventually decide not to buy a product, prior to leaving the retail store, the customer may have interacted with one or more products as the customer strolls the retail store (physically or virtually (e.g., using a virtual head gear)) and/or browse a website of the retail store. In one scenario, the customer may pick up a wok momentarily and proceed to inspect the wok. Subsequently, the customer may walk towards an area of the retail store that has multiple types and/or brands of oven ranges. In one configuration, sensors may be installed throughout the retail store and may capture a plurality of data streams associated with the customer's activities and/or actions in the retail store, and/or areas in the retail store the customer may visit. Thus, in predicting one or more intentions the customer may have in visiting the retail store, the system may monitor activities, actions, and/or areas visited in the retail store, among other things the customer may do while at the retail store. As such, by one approach, the system may predict that the customer may be interested in a wok and may also be interested in an oven range based, at least in part, on the plurality of images captured by one or more of the sensors (e.g., video camera systems and video processing system), bar codes read by a bar coder reader sensor, RFID tags detected by an RFID reader sensor, etc. Thus, based on the interaction of the customer with the wok and the customer visiting the area of the retail store that has multiple oven ranges, the system may predict that the customer may intend to cook on an oven range using a wok.

In one configuration, the coaching system may determine and/or recommend a particular product for the customer based on products the customer interacted with. Continuing the example described above, the system may determine a couple of products, such as an interface induction piece and/or a wok ring adapter, based on the customer's interaction with the wok and the oven range. By one approach, the system may evaluate relationships between the products the customer interacted with to determine one or more products associated with these interacted products. Relationships between products may be evaluated by determining similarities of functions and/or usage between the products. The coaching system may compare keywords associated with each product (e.g., keywords associated with functions and/or usage attributable to the product) and determine the keywords that are similar between the products. The coaching system may determine those products that are closely related and/or associated by a number count of similar keywords and/or a number count of the same keywords resulting from the comparison. The higher the number of similarities and/or the number of the same keywords, the more related and/or associated the compared products are.

In one scenario, the coaching system may determine that the interface induction piece and/or the wok ring adapter are associated with using the wok in an induction oven range or an electric oven range, respectively. As such, by one approach, the coaching system may provide one or more how-to-use data regarding using a wok on an induction range and/or on an electric range to the customer, which further includes data regarding the interface induction piece and/or the wok ring adapter. In another scenario, the system may associate one or more how-to-use data with the induction piece and/or the wok ring adapter in the library associated with the customer. Thus, the coaching system may determine a how-to-use data to be provided to a customer based, at least in part, on predicted intentions of the customer and/or products interacted by the customer, among other ways to make a determination of how-to-use data that may be useful to the customer. By one approach, the coaching system may select a particular how-to-use data among a plurality of how-to-use data that may be associated with a particular product based, at least, on keywords attributable to functions and/or usage associated with the predicted intended use of the particular product.

By another approach, the coaching system may recommend to the customer, via a message sent to the customer's electronic device interface, the induction piece and/or the wok ring adapter. In one scenario, the message may have be sent based on one or more requests sent to the coaching system by the customer while the customer is at the retail store. In another scenario, receipt of a message may be based on a customer specified setting in the electronic device interface. In yet another scenario, sending of the requests may be based on the customer specified setting, such as settings maintained in the customer profile. In yet another scenario, the message may be sent while the customer is at the retail store and/or at a place outside of the retail store.

In one configuration, the customer may view the how-to-use data provided by system via an electronic device interface operated on an electronic device of the customer. The electronic device interface may operate on at least a computer, a smartphone, a smartwatch, a kiosk of the retail store, and/or a display device, among other possible type of display devices that display messages to a customer. By one approach, while the customer is at the retail store, the customer may request to view one or more how-to-use data on a kiosk of the retail store. In such approach, the kiosk may send the request to the system to access the one or more how-to-use data that are associated with a customer profile of the customer in a library of a library database. By another approach, the customer may make the request through the electronic device interface operated on the customer's electronic device. In yet another approach, the same how-to-use data may be viewed at a place outside of the retail store, such as at the customer's house, restaurants, car, to name a few. The customer may have a customized setting in the electronic device interface that enable the customer to schedule when the how-to-use data are viewed. Thus, in addition to having a customized and/or associated listing of how-to-use data, the customer may have access to the customized and/or associated listing of how-to-use data anywhere and/or anytime the customer chooses.

In another configuration, based on a customer specified setting, the coaching system may automatically provide and/or send one or more messages asking the customer one or more questions regarding possible use of the product or products that the customer is or had interacted with while at the retail store. In continuing the non-limiting illustrative example described above, the coaching system may ask the customer what vegetables, meat, sauces, and/or food items he/she may have in the house. In response to the customer responding to the question, the coaching system may provide a how-to-use data of using the wok to cook a stir-fry dish with one or more items provided by the customer. By one approach, the how-to-use data may include a recipe and/or a video of cooking the recipe using the wok or a product similar to the wok. By another approach, the customer may send a query to the system via the electronic device interface regarding recipes and/or cooking video associated with using the wok or similar to the wok. Accordingly, the system may provide a how-to-use data based on products the customer interacted with while at the store, products the customer bought, and/or products the customer already owned prior to buying more products and/or products that are available at the customer's house.

In another configuration, the customer may return to the retail store at a second time. By one approach, during the second time, the sensors may capture a plurality of information (e.g., data streams (e.g., video streams and/or any data streams)) while the customer is looking at another product, for example, a slow cooker. By another approach, the system may determine whether the customer may have the same or different intentions during the first time and the second time he was at the retail store based, at least in part, on an amount of time passed, relative to a threshold, between the first time and the second time the customer may have been at the retail store and/or associations and/or relationships between products the customer may have interacted with at the first time and at the second time he was at the retail store, among other ways to determine similarity or sameness of intentions the customer may have while at the retail store at various times.

Continuing from the example described above, by one approach, the coaching system may re-predict the customer's intentions based, at least in part, on the customer looking at the slow cooker during the second time he/she was at the retail store. By another approach, the coaching system may predict that the customer's intention is to purchase a cooking appliance that is versatile based on previous predictions, products associated with the previous predictions, products the customer interacted with previously, the re-predicted intention, and/or the customer's interaction with a new product at the second time.

In such approach, during the first time, the customer may have interacted with a dutch oven, a twelve-piece cooking ware set, an oven range, a portable mini-grill, and/or a multi-purpose skillet. During the first time, the system may have predicted that the customer's intention was to buy a set of cooking ware. However, at the second time, the system may revise its previous prediction of the customer's intention. By one approach, the system may re-predict that the customer's intention is to buy a versatile cooking appliance based, at least in part, on the slow cooker and the previous products the customer may have interacted with at the first time. Consequently, the coaching system may determine a product, for example a portable induction oven, based, at least in part, on the re-predicted intentions. Thus, the coaching system may re-predict the customer's intention based on the products the customer interacted with during the first and second times. Moreover, the coaching system may provide a how-to-use data to the customer regarding usage of the determined product, for example, the portable induction oven, based, at least in part, on the re-predicted customer's intention.

Furthermore, in one configuration, the library associated with the customer may be updated by the coaching system by associating the library with the determined and/or recommended product, for example, the portable induction oven, and the how-to-use data. As such, by one approach, the system may predict intentions of a customer for a second time based, at least in part, on previous predictions, products associated with the previous predictions, products the customer interacted with previously while at one or more retail stores, the re-predicted intentions, and/or the customer's interaction with a new product at the second time. Moreover, based on the re-predicted intentions of the customer during the second time, the coaching system may determine one or more products associated with the re-predicted intentions and/or provide one or more how-to-use data based, at least in part, on these products.

In another configuration, the coaching system may determine one or more intentions of a customer based on partiality vectors associated with a customer profile of the customer in a customer profile database. For example, the customer profile database may store a plurality of customer profiles having a plurality of customer partiality vectors associated with each customer. By one approach, each of the plurality of customer partiality vectors may have a magnitude that corresponds to a determined magnitude of a strength of a belief by a customer in an amount of good that comes from an amount of order imposed upon material space time by a corresponding particular partiality.

In an illustrative non-limiting example, partiality vectors associated with a customer may include high affinity for outdoor activities, such as hiking, travelling, and camping. As such, by one approach, the coaching system having access to a customer profile database that includes a customer profile of the customer may predict that the customer's intention is to buy items for a backpacking trip in Europe. The system may base its prediction, at least in part, on sensor data captured by one or more sensors indicating that the customer is at an area in the retail store where luggage and travelling accessories are located. By one approach, the sensors in the retail store may have captured the customer flipping through a European travel guide. As such, the customer's interaction with the European travel guide, stopping at the luggage area of the retail store, and/or the customer's affinity for outdoor activities may be used by the system to predict that the customer's intention is to buy items for a backpacking trip in Europe. Further details regarding the partiality vectors are described below.

By yet another approach these teachings will accommodate being leveraged to facilitate the provision of assistance to in-store shoppers.

In particular, these teachings can be leveraged to provide customer service to shoppers in a retail facility via crowd-sourced experts (who are potentially remote from the retail facility) based on similarities between a customer profile of a particular in-store shopper and an expert profile of a particular crowd-sourced expert, needs of the particular in-store shopper, location of the in-store shopper as compared to the area of expertise of the crowd-sourced experts, and/or ratings of the crowd-source expert. Further, the customer service may be prompted by the particular customer's in-store behavior, such as, for example, the customer's route through the store (e.g., the customer is re-visiting areas of the store previously visited during this trip), items in the customer's cart, location within the retail facility and/or dwell time at a particular location, among other behaviors. The particular customer's behavior also may be compared to their typical behavior as captured in the customer profile such that any deviation from the customer's typical routine at the retail facility also may prompt an offering of customer service.

In some embodiments, a shopping system includes a user interface configured to operate on an electronic user device associated with a particular user in a physical retail facility, a customer database of customer profiles with customer value vectors associated therewith and historical shopping behaviors, an expert database of crowd-sourced experts having expert value vectors associated therewith, and a control circuit in communication with the user interface and the databases. By one approach, the control circuit (along with one or more sensors) is configured to monitor customer behavior including the location of customers as they shop in the physical retail facility, determine whether the behavior of a particular user indicates a customer service need, and upon a determination that the particular user has a customer service need, match a crowd-sourced expert to the particular user in need of the customer service based on customer value vectors, expert value vectors of a particular crowd-sourced expert, and a location of the particular user in the physical retail facility. Then, the control circuit and the electronic user device are configured to present a crowd-sourced customer support service or customer service opportunity to the particular user based on the customer behavior. By presenting the particular user a customer service opportunity, the control circuit present an opportunity to receive customer support, service, or assistance, such as, for example, via the electronic user device of the particular user.

In one illustrative embodiment, the control circuit of the shopping system is configured to obtain a first set of rules that indicate a customer service need as a function of customer behavior, identify a particular customer service need of the particular user in the physical retail facility based on particular customer behavior of the particular user sensed via store sensors, obtain a second set of rules that identify a crowd-sourced expert as a function of correspondence between customer value vectors of the particular user, stored in the customer database, and expert value vectors of crowd-sourced experts, stored in the expert database, identify a particular crowd-sourced expert for the particular user based on the second set of rules and a location of the particular user in the physical retail facility, and present a crowd-sourced customer support service to the particular user based on the particular customer behavior and the location of the particular user in the physical retail facility by facilitating interaction between the particular user and the particular crowd-sourced expert identified.

As noted above, by one approach, the customer service is generally offered to the in-store shopper without the individual needing to request such help. Instead, the system is designed to identify those in-store shoppers likely in need to assistance by sensing the customer's behavior and/or location in the store. This is generally in contrast to typical customer service, which is generally supplied in response to a customer inquiry. In operation, to prompt or suggest customer service offerings to the in-store shoppers likely in need of assistance or amenable to receiving assistance, one or more sensors, which are in communication with the control circuit, are configured to monitor aspects of customer behavior. For example, the system may include one or more motion sensors, one or more sound sensors, one or more optical sensors, and/or one or more location sensors. These sensors, individually or working together, may be configured to sense customer routes and locations within the physical retail facility. In some configurations, the information from the sensor(s) may be sufficient to identify customer for which assistance is offered. For example, if the sensor(s) indicate that a particular customer has been located in a single store aisle for at least ten minutes, the control circuit may identify that particular customer as potentially needing support or assistance. In yet other configurations, information from the sensor(s) may be compared to historical information about particular customers as found in the associated customer profile in the customer database.

Accordingly, the control circuit is further configured to receive data from the motion sensors, sound sensors, optical sensors, and/or location sensors and monitor the customer behavior. To that end, in some configurations, the control circuit, together with the sensors, determines a customer route through the physical retail facility, determines a dwell time for the particular user at a particular location, determines whether the particular user has deviated from previous routes taken through the physical retail facility, and/or analyzes customer sounds, among other customer behavior analysis. In operation, determining whether the customer behavior of the particular user or customer indicates a customer service need may include identifying non-standard shopping behavior for the particular user by comparing the received data and the monitored customer behavior with the historical shopping behaviors in the customer database.

Once the in-store shopper (likely) needing assistance has been identified by the control circuit, the customer support service may be offered and then interaction between the in-store shopper and the expert providing the assistance is facilitated, upon identification of a suitable crowd-sourced expert. By one approach, the user interface helps facilitate interaction between the particular user or in-store shopper and the crowd-sourced expert by prompting the particular user regarding the availability of the customer support service via the user interface. In some embodiments, the crowd-sourced customer support or service is offered or presented proactively (i.e., offered without requiring receipt of a customer request or inquiry) such that the crowd-sourced expert provides a customer support service, such as, for example, a product suggestion, product advice, and/or product information to the particular user, via the user interface. For example, the in-store shopper may receive a notification on their electronic user device that a crowd-sourced expert is available to provide them customer service or support. Further, the customer service or support offering may include information about the available crowd-sourced expert or the type of customer support available, such as product suggestions, product advice, and/or product information. In another configuration, the user interface of the electronic user device may have a chat feature where a crowd-sourced expert may offer or ask if the in-store shopper would like assistance or help. Accordingly, the customer or in-store shopper does not need to ask for help, but instead, the system can prompt the shopper by offering help in the form of customer support (and may even provide suggestions and/or information, if the offer is accepted). The customer service or support (e.g., help, suggestions, information, and/or any other assistance) may be provided, in part, based on the particular customer's behavior, the customer's area of store, and/or the items presently in the customer's cart, among other factors. As outlined below, the customer service or support provided also is based upon the particular customer by matching the in-store shopper (according to their profile) to a suitable crowd-sourced expert with value vectors similar to the in-store shopper. Further, in some configurations, information from the customer profile may be shared with the crowd-sourced expert for the provision of customer service or support.

As noted above, the systems, methods, and apparatus described herein are configured to identify customers likely in need of customer service or support by sensing and monitoring customer behavior. In one illustrative approach, the customer behavior includes identifying the retail items placed into the shopping cart of the particular in-store shoppers or customer. To that end, the shopping carts may include sensors, such as, for example, an optical cart sensor or an RFID sensor incorporated therein. By one approach, these sensors are configured to identify one or more retail products in a customer shopping cart or monitor the items and identify these items as they are placed into the cart. In operation, the cart sensors are configured to communicate with the control circuit, such that the control circuit is notified of the retail products identified in the shopping cart, such that the control circuit receives an updated inventory or list of the items in the shopping cart of the in-store shopper or customer.

In addition to using the cart inventory to help identify in-store shoppers that likely need assistance, in one configuration, this information is provided to the crowd-sourced expert, i.e., the assigned crowd-sourced expert receives a shopping cart inventory for the particular user. Accordingly, this cart inventory can be used in assisting the particular user. Other information provided to the assigned crowd-sourced expert that is matched to the in-store shopper or user may include information from the customer profile in the customer database. In one illustrative approach, the assigned crowd-sourced expert receives at least a portion of the customer profile associated with the particular user for reference during the facilitated interaction between the assigned crowd-sourced expert and the particular user.

To facilitate the provision of customer service or support between the particular user and the assigned crowd-sourced expert, the system also generally includes an expert user interface configured to operate on an electronic user interface of a particular crowd-sourced expert. Similar to the user interface of the particular user or in-store shopper, the expert user interface may be provided to the electronic user devices by the control circuit. In another configuration, the user interface and/or the expert user interface are configured to be executed by the electronic user devices when in communication with the control circuit.

To ensure the quality of the customer service and to provide in-store shoppers an opportunity to express their concerns or appreciation, in some embodiments, the system includes an expert rating tool configured to permit the particular user to rate aspects of the interaction with the crowd-sourced expert assigned to them. This information may be used by the retail facility to evaluate experts and provide incentives or remuneration thereto. Further, by one approach, the user interface displays an expert rating for a particular crowd-sourced expert when presenting the crowd-sourced customer service or support opportunity to the particular user. The crowd-sourced expert also may have an opportunity to record notes or update the customer profile to ensure that future customer service proactively offered via the user interface better meets the customer's needs.

To provide quality customer support, a particular in-store shopper or user is matched with a crowd-sourced expert based on factors, such as, for example, the area of the store in which the in-store shopper is presently shopping (e.g., offering a chef or cooking expert when the customer is shopping in the pots and pans aisle), expert rating, and/or similarities between profiles of the in-store shopper and crowd-sourced expert, among others. In some embodiments, the system includes customer and expert databases with profiles therein that include a variety of information about the customer and expert, respectively, which may include, for example, the value vectors as described below. Accordingly, such information may be analyzed in a vector-based approach to facilitate matching a particular in-store shopper or user with a crowd-sourced expert having a similar value vector profile.

Generally speaking, people tend to be partial to ordering various aspects of their lives, which is to say, people are partial to having things well arranged per their own personal view of how things should be. As a result, anything that contributes to the proper ordering of things regarding which a person has partialities represents value to that person. Quite literally, improving order reduces entropy for the corresponding person (i.e., a reduction in the measure of disorder present in that particular aspect of that person's life) and that improvement in order/reduction in disorder is typically viewed with favor by the affected person.

Generally speaking a value proposition must be coherent (logically sound) and have “force.” Here, force takes the form of an imperative. When the parties to the imperative have a reputation of being trustworthy and the value proposition is perceived to yield a good outcome, then the imperative becomes anchored in the center of a belief that “this is something that I must do because the results will be good for me.” With the imperative so anchored, the corresponding material space can be viewed as conforming to the order specified in the proposition that will result in the good outcome.

Pursuant to these teachings a belief in the good that comes from imposing a certain order takes the form of a value proposition. It is a set of coherent logical propositions by a trusted source that, when taken together, coalesce to form an imperative that a person has a personal obligation to order their lives because it will return a good outcome which improves their quality of life. This imperative is a value force that exerts the physical force (effort) to impose the desired order. The inertial effects come from the strength of the belief. The strength of the belief comes from the force of the value argument (proposition). And the force of the value proposition is a function of the perceived good and trust in the source that convinced the person's belief system to order material space accordingly. A belief remains constant until acted upon by a new force of a trusted value argument. This is at least a significant reason why the routine in people's lives remains relatively constant.

Newton's three laws of motion have a very strong bearing on the present teachings. Stated summarily, Newton's first law holds that an object either remains at rest or continues to move at a constant velocity unless acted upon by a force, the second law holds that the vector sum of the forces F on an object equal the mass m of that object multiplied by the acceleration a of the object (i.e., F=ma), and the third law holds that when one body exerts a force on a second body, the second body simultaneously exerts a force equal in magnitude and opposite in direction on the first body.

Relevant to both the present teachings and Newton's first law, beliefs can be viewed as having inertia. In particular, once a person believes that a particular order is good, they tend to persist in maintaining that belief and resist moving away from that belief. The stronger that belief the more force an argument and/or fact will need to move that person away from that belief to a new belief.

Relevant to both the present teachings and Newton's second law, the “force” of a coherent argument can be viewed as equaling the “mass” which is the perceived Newtonian effort to impose the order that achieves the aforementioned belief in the good which an imposed order brings multiplied by the change in the belief of the good which comes from the imposition of that order. Consider that when a change in the value of a particular order is observed then there must have been a compelling value claim influencing that change. There is a proportionality in that the greater the change the stronger the value argument. If a person values a particular activity and is very diligent to do that activity even when facing great opposition, we say they are dedicated, passionate, and so forth. If they stop doing the activity, it begs the question, what made them stop? The answer to that question needs to carry enough force to account for the change.

And relevant to both the present teachings and Newton's third law, for every effort to impose good order there is an equal and opposite good reaction.

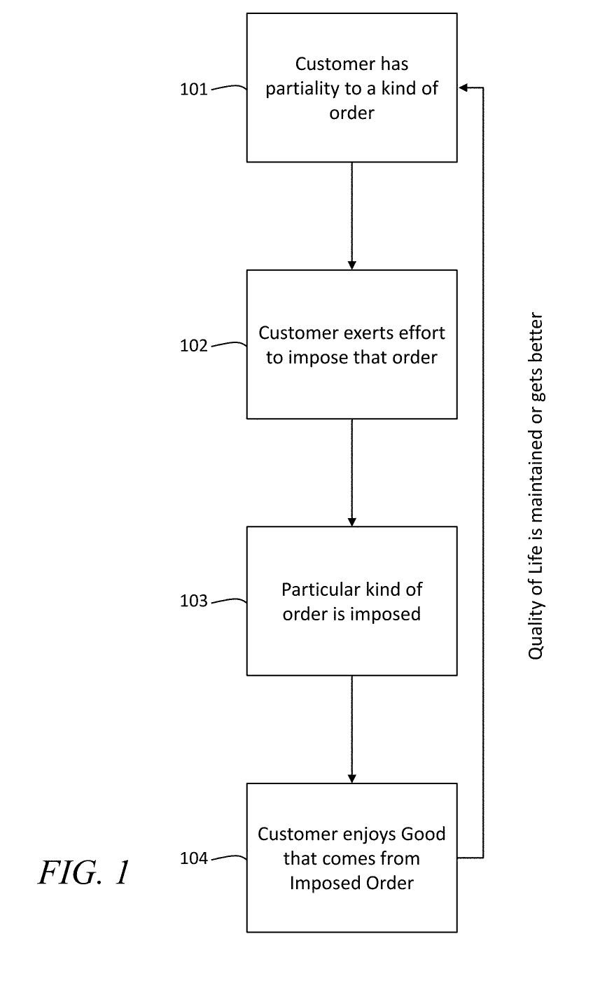

FIG. 1 provides a simple illustrative example in these regards. At block 101 it is understood that a particular person has a partiality (to a greater or lesser extent) to a particular kind of order. At block 102 that person willingly exerts effort to impose that order to thereby, at block 103, achieve an arrangement to which they are partial. And at block 104, this person appreciates the “good” that comes from successfully imposing the order to which they are partial, in effect establishing a positive feedback loop.

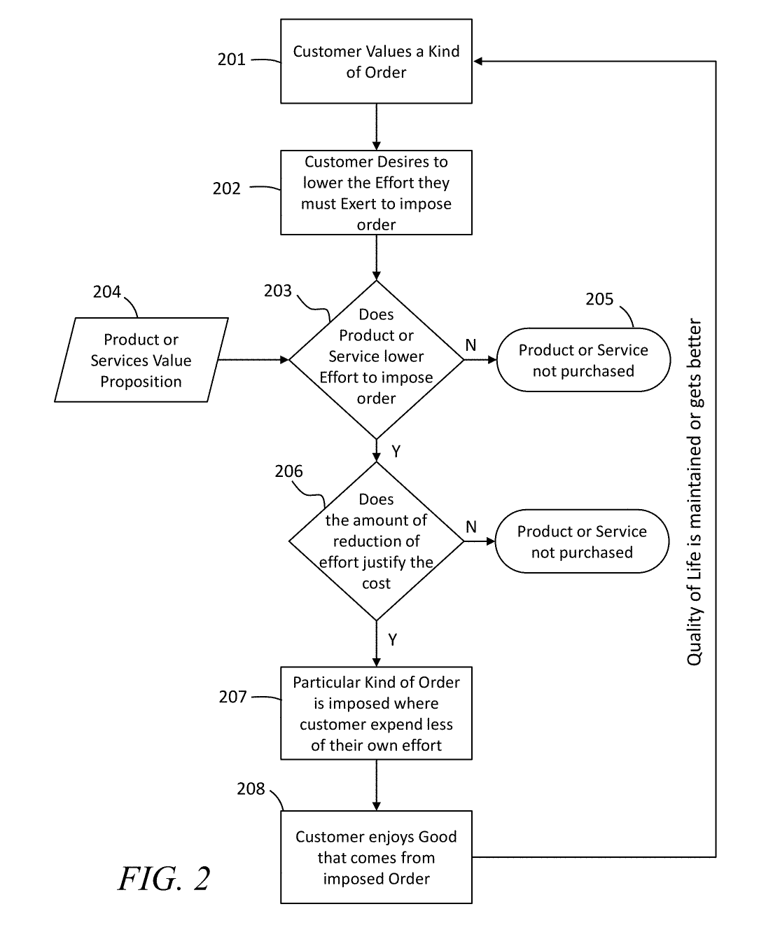

Understanding these partialities to particular kinds of order can be helpful to understanding how receptive a particular person may be to purchasing a given product or service. FIG. 2 provides a simple illustrative example in these regards. At block 201 it is understood that a particular person values a particular kind of order. At block 202 it is understood (or at least presumed) that this person wishes to lower the effort (or is at least receptive to lowering the effort) that they must personally exert to impose that order. At decision block 203 (and with access to information 204 regarding relevant products and or services) a determination can be made whether a particular product or service lowers the effort required by this person to impose the desired order. When such is not the case, it can be concluded that the person will not likely purchase such a product/service 205 (presuming better choices are available).

When the product or service does lower the effort required to impose the desired order, however, at block 206 a determination can be made as to whether the amount of the reduction of effort justifies the cost of purchasing and/or using the proffered product/service. If the cost does not justify the reduction of effort, it can again be concluded that the person will not likely purchase such a product/service 205. When the reduction of effort does justify the cost, however, this person may be presumed to want to purchase the product/service and thereby achieve the desired order (or at least an improvement with respect to that order) with less expenditure of their own personal effort (block 207) and thereby achieve, at block 208, corresponding enjoyment or appreciation of that result.

To facilitate such an analysis, the applicant has determined that factors pertaining to a person's partialities can be quantified and otherwise represented as corresponding vectors (where “vector” will be understood to refer to a geometric object/quantity having both an angle and a length/magnitude). These teachings will accommodate a variety of differing bases for such partialities including, for example, a person's values, affinities, aspirations, preferences, and/or their propensity to behave as a first adopter.

A value is a person's principle or standard of behavior, their judgment of what is important in life. A person's values represent their ethics, moral code, or morals and not a mere unprincipled liking or disliking of something. A person's value might be a belief in kind treatment of animals, a belief in cleanliness, a belief in the importance of personal care, and so forth.

An affinity is an attraction (or even a feeling of kinship) to a particular thing or activity. Examples including such a feeling towards a participatory sport such as golf or a spectator sport (including perhaps especially a particular team such as a particular professional or college football team), a hobby (such as quilting, model railroading, and so forth), one or more components of popular culture (such as a particular movie or television series, a genre of music or a particular musical performance group, or a given celebrity, for example), and so forth.

“Aspirations” refer to longer-range goals that require months or even years to reasonably achieve. As used herein “aspirations” does not include mere short term goals (such as making a particular meal tonight or driving to the store and back without a vehicular incident). The aspired-to goals, in turn, are goals pertaining to a marked elevation in one's core competencies (such as an aspiration to master a particular game such as chess, to achieve a particular articulated and recognized level of martial arts proficiency, or to attain a particular articulated and recognized level of cooking proficiency), professional status (such as an aspiration to receive a particular advanced education degree, to pass a professional examination such as a state Bar examination of a Certified Public Accountants examination, or to become Board certified in a particular area of medical practice), or life experience milestone (such as an aspiration to climb Mount Everest, to visit every state capital, or to attend a game at every major league baseball park in the United States). It will further be understood that the goal(s) of an aspiration is not something that can likely merely simply happen of its own accord; achieving an aspiration requires an intelligent effort to order one's life in a way that increases the likelihood of actually achieving the corresponding goal or goals to which that person aspires. One aspires to one day run their own business as versus, for example, merely hoping to one day win the state lottery.

A preference is a greater liking for one alternative over another or others. A person can prefer, for example, that their steak is cooked “medium” rather than other alternatives such as “rare” or “well done” or a person can prefer to play golf in the morning rather than in the afternoon or evening. Preferences can and do come into play when a given person makes purchasing decisions at a retail shopping facility. Preferences in these regards can take the form of a preference for a particular brand over other available brands or a preference for economy-sized packaging as versus, say, individual serving-sized packaging.

These teachings will also accommodate accounting for whether a particular person has a propensity to behave as a so-called first adopter. Early adopters have a passion for product innovation that most consumers cannot relate to. The early adopter often looks at new products and thinks to themselves how the product can be incorporated into their daily needs (rather than merely relying upon a product manufacturer's suggestions in such regards). They often quickly recognize and comprehend the potential value and benefit of the product and how its functionality relates to their needs of usability and sociability. Curious and stimulated by the “what if” and the adoption challenges of a new product release, early adopters are often much more willing to take a risk with a new product so that they can be associated with the cutting edge technology. Some research suggests that upwards of fifteen percent of the purchasing public can be characterized as first adopters for at least one product type or product/technology category.

A person's “propensity” to behave as a first adopter refers in part to their purchasing behavior or other related behaviors (such as leasing, borrowing, or otherwise adopting) with respect to newly available products and/or services. While there is no conceptual requirement that a person be the literal “first” person to purchase or otherwise acquire a particular product or service, it will generally be the case that such a person will adopt the newly-available product/service within some relatively short period of time (and especially when such behavior is evinced in a repeated manner with different products/services).

The particular period of time that can serve as a useful measure in these regards may vary with respect to the product/service category and/or genre. For example, a digital product (such as a new smartphone app or a new music recording) may have a “first adopter” window of, say, three hours or three days while a new item of personal electronics may have a “first adopter” window of, say, one day or one week as desired. With that in mind, these teachings will accommodate using a rule that categorizes a particular purchase by a particular person as being first adopter behavior when a particular purchase or other acquisition occurs within the previously-determined first-adopter window of time. Similarly, a corresponding rule can categorize a particular purchase as not being first adopter behavior when that purchase occurs outside that first-adopter window of time.

While behaving in a manner that manifests the person's desire to be amongst the first persons who adopt some new technology or product by being amongst the first persons who acquire that new technology/product, there are other attributes that typically further enrich or inform what it is to be a first adopter. Such persons are usually less concerned with price and risk and more concerned with the opportunity to try new things. Accordingly, such persons are more willing than the average person to accept underdeveloped (or possibly even error/problem-prone) or pricey products in exchange for early access to what may be a more advanced product. Early adopters not only purchase early, they also often share both the fact of their acquisition as well as their objective and subjective observations and thoughts regarding such acquisitions (via, for example, word of mouth, blogging, social media, and so forth).

Accordingly, the aforementioned rules can further require, in addition to a history of making early acquisitions of certain products or product categories, a history of paying a premium in such cases and/or a history of sharing as regards such acquisitions. Such rules can be relatively simple (i.e., a count of at least a predetermined number of such sharing events in conjunction with corresponding early acquisitions) or more complex (where, for example, automated semantic analysis serves to assess the nature of such sharing events to assess whether the sharing events are more trivial in nature (by, for example, simply stating the fact of a particular acquisition) or are more substantive and/or reviewer-like in nature (where, for example, the sharing event includes details not only regarding the technical features of the acquired product but the person's own observations, experiences, and/or recommendations regarding such features).

Yet another way to help identify a particular person as being a first adopter (and/or to assess the relative strength of that propensity) is to consider whether and how often the person makes an early acquisition notwithstanding that they already have a serviceable (and possibly recently acquired) product of the same kind/type. The more often a person purchases a newly available product notwithstanding that they do not apparently have a need for the new product absent the early adopter propensity, the more likely it is that the person is, in fact, an early adopter. Accordingly, the aforementioned rules can also, in lieu of the foregoing or in combination therewith, determined early adopter status as a function of one or more historical instances of a person making an early acquisition for something that they would already seem to have reasonably covered by way of one or more previous purchases (and especially where one or more of those previous purchases were themselves early acquisitions).

Frequency of purchase is another metric by which a person may signal their propensity to be an early adopter. Especially in a market segment where next-generation products are released fairly regularly, the fact that a particular person makes frequent purchases of such products over time can be a helpful (though not necessarily dispositive) indicator of first adopter behavior, especially when viewed in conjunction with one or more of the behaviors/metrics described above.

As suggested above, these teachings will accommodate determining and maintaining records regarding a first adopter characterization for each of a plurality of product categories (and/or, if desired, a particular person's propensity to behave as a late adopter where, if desired, a “late adopter” can be anyone who makes purchase outside the aforementioned early adopter window of time or, if desired, beyond some separate measure of time (such as, for example, one or two years beyond when a particular product/service first becomes available for purchase or other acquisition)). Accordingly, these teachings will accommodate, by way of example, a first partiality vector that characterizes a particular person as being a first adopter for a first category of products (for example, high-technology personal electronics) and as being a late adopter (or at least not a first adopter) for a second category of products (for example, automobiles, food products, or clothing).

Values, affinities, aspirations, preferences, and propensities with respect to being a first adopter are not necessarily wholly unrelated. It is possible for a person's values, affinities, aspirations, or first adopter propensities to influence or even dictate their preferences in specific regards. For example, a person's moral code that values non-exploitive treatment of animals may lead them to prefer foods that include no animal-based ingredients and hence to prefer fruits and vegetables over beef and chicken offerings. As another example, a person's affinity for a particular musical group may lead them to prefer clothing that directly or indirectly references or otherwise represents their affinity for that group. As yet another example, a person's aspirations to become a Certified Public Accountant may lead them to prefer business-related media content. And as yet another example, a person's propensity for first adopter behaviors as regards high-tech personal electronics may influence them to prefer a particular company that has an established reputation for releasing products that are at the cutting edge of their respective technology area.

While a value, affinity, aspiration, or first adopter propensity may give rise to or otherwise influence one or more corresponding preferences, however, is not to say that these things are all one and the same; they are not. For example, a preference may represent either a principled or an unprincipled liking for one thing over another, while a value is the principle itself. Accordingly, as used herein it will be understood that a partiality can include, in context, any one or more of a value-based, affinity-based, aspiration-based, and/or preference-based partiality unless one or more such features is specifically excluded per the needs of a given application setting.

Information regarding a given person's partialities can be acquired using any one or more of a variety of information-gathering and/or analytical approaches. By one simple approach, a person may voluntarily disclose information regarding their partialities (for example, in response to an online questionnaire or survey or as part of their social media presence). By another approach, the purchasing history for a given person for specific products (and the time when such products were so purchased as compared to information regarding when those products were first available to the public for purchase) can be analyzed to intuit the partialities (including the likely presence or absence of first adopter propensities) that led to at least some of those purchases. By yet another approach demographic information regarding a particular person can serve as yet another source that sheds light on their partialities. Other ways that people reveal how they order their lives include but are not limited to various items of objective or subjective information such as: (1) their social networking profiles and behaviors (such as the things they “like” via Facebook, the images they post via Pinterest, informal and formal comments they initiate or otherwise provide in response to third-party postings including statements regarding their own personal long-term goals, the persons/topics they follow via Twitter, the photographs they publish via Picasso, and so forth); (2) their Internet surfing history; (3) their on-line or otherwise-published affinity-based memberships; (4) real-time (or delayed) information (such as steps walked, calories burned, geographic location, activities experienced, and so forth) from any of a variety of personal sensors (such as smart phones, tablet/pad-styled computers, fitness wearables, Global Positioning System devices, and so forth) and the so-called Internet of Things (such as smart refrigerators and pantries, entertainment and information platforms, exercise and sporting equipment, and so forth); (5) instructions, selections, and other inputs (including inputs that occur within augmented-reality user environments) made by a person via any of a variety of interactive interfaces (such as keyboards and cursor control devices, voice recognition, gesture-based controls, and eye tracking-based controls), and so forth.

The present teachings employ a vector-based approach to facilitate characterizing, representing, understanding, and leveraging such partialities to thereby identify products (and/or services) that will, for a particular corresponding consumer, provide for an improved or at least a favorable corresponding ordering for that consumer. Vectors are directed quantities that each have both a magnitude and a direction. Per the applicant's approach these vectors have a real, as versus a metaphorical, meaning in the sense of Newtonian physics. Generally speaking, each vector represents order imposed upon material space-time by a particular partiality.

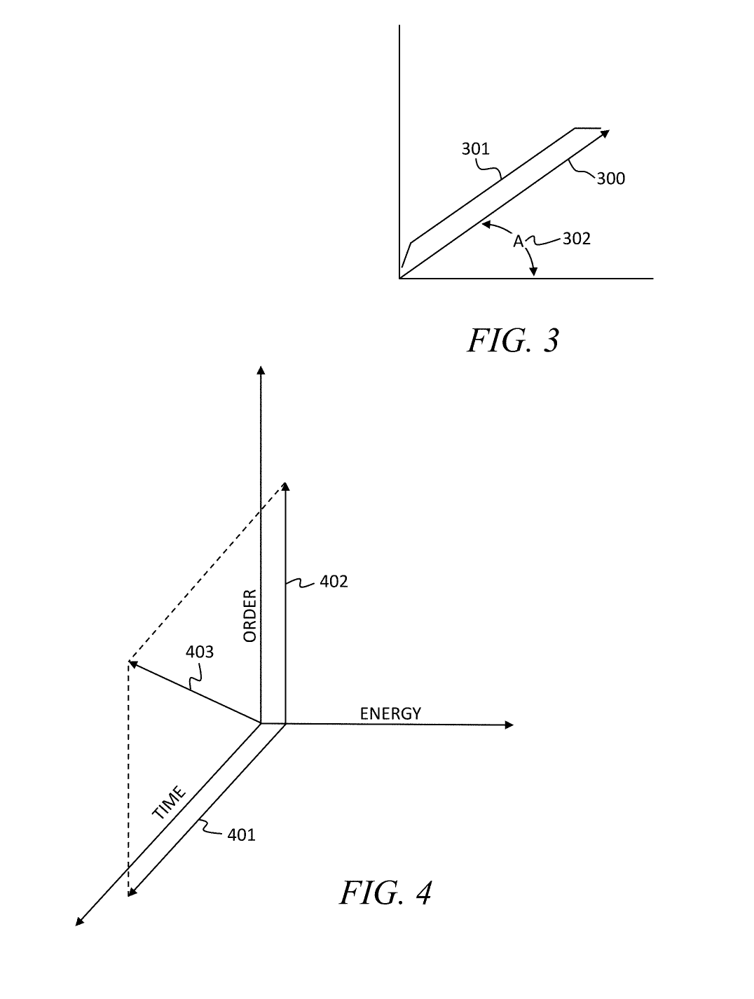

FIG. 3 provides some illustrative examples in these regards. By one approach the vector 300 has a corresponding magnitude 301 (i.e., length) that represents the magnitude of the strength of the belief in the good that comes from that imposed order (which belief, in turn, can be a function, relatively speaking, of the extent to which the order for this particular partiality is enabled and/or achieved). In this case, the greater the magnitude 301, the greater the strength of that belief and vice versa. Per another example, the vector 300 has a corresponding angle A 302 that instead represents the foregoing magnitude of the strength of the belief (and where, for example, an angle of 0° represents no such belief and an angle of 90° represents a highest magnitude in these regards, with other ranges being possible as desired).

Accordingly, a vector serving as a partiality vector can have at least one of a magnitude and an angle that corresponds to a magnitude of a particular person's belief in an amount of good that comes from an order associated with a particular partiality. By way of example, partiality space comprises an N-dimensional space and the aforementioned propensity for early adopter behavior can constitute at least one of those N dimensions as desired. More particularly, the corresponding partiality vector can point in a direction that corresponds to a belief that “It is good to experience and employ products early as they become available.” The magnitude of that vector for any particular person represents that person's perception of achieving an amount of good from observation of this partiality where the literal measure of their belief in that perception is evidenced by the effort they expend to, in fact, make early purchases of newly-available products.

Applying force to displace an object with mass in the direction of a certain partiality-based order creates worth for a person who has that partiality. The resultant work (i.e., that force multiplied by the distance the object moves) can be viewed as a worth vector having a magnitude equal to the accomplished work and having a direction that represents the corresponding imposed order. If the resultant displacement results in more order of the kind that the person is partial to then the net result is a notion of “good.” This “good” is a real quantity that exists in meta-physical space much like work is a real quantity in material space. The link between the “good” in meta-physical space and the work in material space is that it takes work to impose order that has value.

In the context of a person, this effort can represent, quite literally, the effort that the person is willing to exert to be compliant with (or to otherwise serve) this particular partiality. For example, a person who values animal rights would have a large magnitude worth vector for this value if they exerted considerable physical effort towards this cause by, for example, volunteering at animal shelters or by attending protests of animal cruelty.

While these teachings will readily employ a direct measurement of effort such as work done or time spent, these teachings will also accommodate using an indirect measurement of effort such as expense; in particular, money. In many cases people trade their direct labor for payment. The labor may be manual or intellectual. While salaries and payments can vary significantly from one person to another, a same sense of effort applies at least in a relative sense.

As a very specific example in these regards, there are wristwatches that require a skilled craftsman over a year to make. The actual aggregated amount of force applied to displace the small components that comprise the wristwatch would be relatively very small. That said, the skilled craftsman acquired the necessary skill to so assemble the wristwatch over many years of applying force to displace thousands of little parts when assembly previous wristwatches. That experience, based upon a much larger aggregation of previously-exerted effort, represents a genuine part of the “effort” to make this particular wristwatch and hence is fairly considered as part of the wristwatch's worth.

The conventional forces working in each person's mind are typically more-or-less constantly evaluating the value propositions that correspond to a path of least effort to thereby order their lives towards the things they value. A key reason that happens is because the actual ordering occurs in material space and people must exert real energy in pursuit of their desired ordering. People therefore naturally try to find the path with the least real energy expended that still moves them to the valued order. Accordingly, a trusted value proposition that offers a reduction of real energy will be embraced as being “good” because people will tend to be partial to anything that lowers the real energy they are required to exert while remaining consistent with their partialities.

FIG. 4 presents a space graph that illustrates many of the foregoing points. A first vector 401 represents the time required to make such a wristwatch while a second vector 402 represents the order associated with such a device (in this case, that order essentially represents the skill of the craftsman). These two vectors 401 and 402 in turn sum to form a third vector 403 that constitutes a value vector for this wristwatch. This value vector 403, in turn, is offset with respect to energy (i.e., the energy associated with manufacturing the wristwatch).

A person partial to precision and/or to physically presenting an appearance of success and status (and who presumably has the wherewithal) may, in turn, be willing to spend $100,000 for such a wristwatch. A person able to afford such a price, of course, may themselves be skilled at imposing a certain kind of order that other persons are partial to such that the amount of physical work represented by each spent dollar is small relative to an amount of dollars they receive when exercising their skill(s). (Viewed another way, wearing an expensive wristwatch may lower the effort required for such a person to communicate that their own personal success comes from being highly skilled in a certain order of high worth.)

Generally speaking, all worth comes from imposing order on the material space-time. The worth of a particular order generally increases as the skill required to impose the order increases. Accordingly, unskilled labor may exchange $10 for every hour worked where the work has a high content of unskilled physical labor while a highly-skilled data scientist may exchange $75 for every hour worked with very little accompanying physical effort.

Consider a simple example where both of these laborers are partial to a well-ordered lawn and both have a corresponding partiality vector in those regards with a same magnitude. To observe that partiality the unskilled laborer may own an inexpensive push power lawn mower that this person utilizes for an hour to mow their lawn. The data scientist, on the other hand, pays someone else $75 in this example to mow their lawn. In both cases these two individuals traded one hour of worth creation to gain the same worth (to them) in the form of a well-ordered lawn; the unskilled laborer in the form of direct physical labor and the data scientist in the form of money that required one hour of their specialized effort to earn.

This same vector-based approach can also represent various products and services. This is because products and services have worth (or not) because they can remove effort (or fail to remove effort) out of the customer's life in the direction of the order to which the customer is partial. In particular, a product has a perceived effort embedded into each dollar of cost in the same way that the customer has an amount of perceived effort embedded into each dollar earned. A customer has an increased likelihood of responding to an exchange of value if the vectors for the product and the customer's partiality are directionally aligned and where the magnitude of the vector as represented in monetary cost is somewhat greater than the worth embedded in the customer's dollar.

Put simply, the magnitude (and/or angle) of a partiality vector for a person can represent, directly or indirectly, a corresponding effort the person is willing to exert to pursue that partiality. There are various ways by which that value can be determined. As but one non-limiting example in these regards, the magnitude/angle V of a particular partiality vector can be expressed as:

$$V = [ \begin{matrix}{X}_{1} \\ ⋮ \\ {X}_{n}\end{matrix} ] [ {W}_{1} … {W}_{n} ]$$

where X refers to any of a variety of inputs (such as those described above) that can impact the characterization of a particular partiality (and where these teachings will accommodate either or both subjective and objective inputs as desired) and W refers to weighting factors that are appropriately applied the foregoing input values (and where, for example, these weighting factors can have values that themselves reflect a particular person's consumer personality or otherwise as desired and can be static or dynamically valued in practice as desired).

In the context of a product (or service) the magnitude/angle of the corresponding vector can represent the reduction of effort that must be exerted when making use of this product to pursue that partiality, the effort that was expended in order to create the product/service, the effort that the person perceives can be personally saved while nevertheless promoting the desired order, and/or some other corresponding effort. Taken as a whole the sum of all the vectors must be perceived to increase the overall order to be considered a good product/service.

It may be noted that while reducing effort provides a very useful metric in these regards, it does not necessarily follow that a given person will always gravitate to that which most reduces effort in their life. This is at least because a given person's values (for example) will establish a baseline against which a person may eschew some goods/services that might in fact lead to a greater overall reduction of effort but which would conflict, perhaps fundamentally, with their values. As a simple illustrative example, a given person might value physical activity. Such a person could experience reduced effort (including effort represented via monetary costs) by simply sitting on their couch, but instead will pursue activities that involve that valued physical activity. That said, however, the goods and services that such a person might acquire in support of their physical activities are still likely to represent increased order in the form of reduced effort where that makes sense. For example, a person who favors rock climbing might also favor rock climbing clothing and supplies that render that activity safer to thereby reduce the effort required to prevent disorder as a consequence of a fall (and consequently increasing the good outcome of the rock climber's quality experience).

By forming reliable partiality vectors for various individuals and corresponding product characterization vectors for a variety of products and/or services, these teachings provide a useful and reliable way to identify products/services that accord with a given person's own partialities (whether those partialities are based on their values, their affinities, their preferences, or otherwise).

It is of course possible that partiality vectors may not be available yet for a given person due to a lack of sufficient specific source information from or regarding that person. In this case it may nevertheless be possible to use one or more partiality vector templates that generally represent certain groups of people that fairly include this particular person. For example, if the person's gender, age, academic status/achievements, and/or postal code are known it may be useful to utilize a template that includes one or more partiality vectors that represent some statistical average or norm of other persons matching those same characterizing parameters. (Of course, while it may be useful to at least begin to employ these teachings with certain individuals by using one or more such templates, these teachings will also accommodate modifying (perhaps significantly and perhaps quickly) such a starting point over time as part of developing a more personal set of partiality vectors that are specific to the individual.) A variety of templates could be developed based, for example, on professions, academic pursuits and achievements, nationalities and/or ethnicities, characterizing hobbies, and the like.

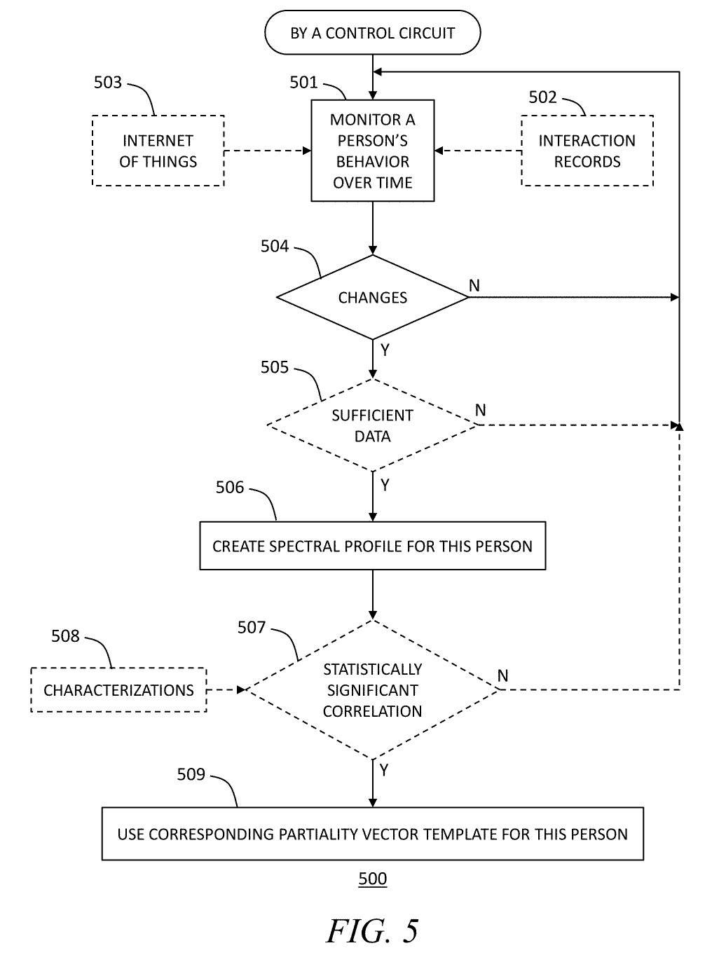

FIG. 5 presents a process 500 that illustrates yet another approach in these regards. For the sake of an illustrative example it will be presumed here that a control circuit of choice (with useful examples in these regards being presented further below) carries out one or more of the described steps/actions.

At block 501 the control circuit monitors a person's behavior over time. The range of monitored behaviors can vary with the individual and the application setting. By one approach, only behaviors that the person has specifically approved for monitoring are so monitored.

As one example in these regards, this monitoring can be based, in whole or in part, upon interaction records 502 that reflect or otherwise track, for example, the monitored person's purchases (including, if desired, the date/time of such purchases). This can include specific items purchased by the person, from whom the items were purchased, where the items were purchased, how the items were purchased (for example, at a bricks-and-mortar physical retail shopping facility or via an on-line shopping opportunity), the price paid for the items, and/or which items were returned and when), and so forth.

As another example in these regards the interaction records 502 can pertain to the social networking behaviors of the monitored person including such things as their “likes,” their posted comments, images, and tweets, affinity group affiliations, their on-line profiles, their playlists and other indicated “favorites,” and so forth. Such information can sometimes comprise a direct indication of a particular partiality or, in other cases, can indirectly point towards a particular partiality and/or indicate a relative strength of the person's partiality.

Other interaction records of potential interest include but are not limited to registered political affiliations and activities, credit reports, military-service history, educational and employment history, and so forth.

As another example, in lieu of the foregoing or in combination therewith, this monitoring can be based, in whole or in part, upon sensor inputs from the Internet of Things (TOT) 503. The Internet of Things refers to the Internet-based inter-working of a wide variety of physical devices including but not limited to wearable or carriable devices, vehicles, buildings, and other items that are embedded with electronics, software, sensors, network connectivity, and sometimes actuators that enable these objects to collect and exchange data via the Internet. In particular, the Internet of Things allows people and objects pertaining to people to be sensed and corresponding information to be transferred to remote locations via intervening network infrastructure. Some experts estimate that the Internet of Things will consist of almost 50 billion such objects by 2020. (Further description in these regards appears further herein.)

Depending upon what sensors a person encounters, information can be available regarding a person's travels, lifestyle, calorie expenditure over time, diet, habits, interests and affinities, choices and assumed risks, and so forth. This process 500 will accommodate either or both real-time or non-real time access to such information as well as either or both push and pull-based paradigms.

By monitoring a person's behavior over time a general sense of that person's daily routine can be established (sometimes referred to herein as a routine experiential base state). As a very simple illustrative example, a routine experiential base state can include a typical daily event timeline for the person that represents typical locations that the person visits and/or typical activities in which the person engages. The timeline can indicate those activities that tend to be scheduled (such as the person's time at their place of employment or their time spent at their child's sports practices) as well as visits/activities that are normal for the person though not necessarily undertaken with strict observance to a corresponding schedule (such as visits to local stores, movie theaters, and the homes of nearby friends and relatives).

At block 504 this process 500 provides for detecting changes to that established routine. These teachings are highly flexible in these regards and will accommodate a wide variety of “changes.” Some illustrative examples include but are not limited to changes with respect to a person's travel schedule, destinations visited or time spent at a particular destination, the purchase and/or use of new and/or different products or services, a subscription to a new magazine, a new Rich Site Summary (RSS) feed or a subscription to a new blog, a new “friend” or “connection” on a social networking site, a new person, entity, or cause to follow on a Twitter-like social networking service, enrollment in an academic program, and so forth.

Upon detecting a change, at optional block 505 this process 500 will accommodate assessing whether the detected change constitutes a sufficient amount of data to warrant proceeding further with the process. This assessment can comprise, for example, assessing whether a sufficient number (i.e., a predetermined number) of instances of this particular detected change have occurred over some predetermined period of time. As another example, this assessment can comprise assessing whether the specific details of the detected change are sufficient in quantity and/or quality to warrant further processing. For example, merely detecting that the person has not arrived at their usual 6 PM-Wednesday dance class may not be enough information, in and of itself, to warrant further processing, in which case the information regarding the detected change may be discarded or, in the alternative, cached for further consideration and use in conjunction or aggregation with other, later-detected changes.

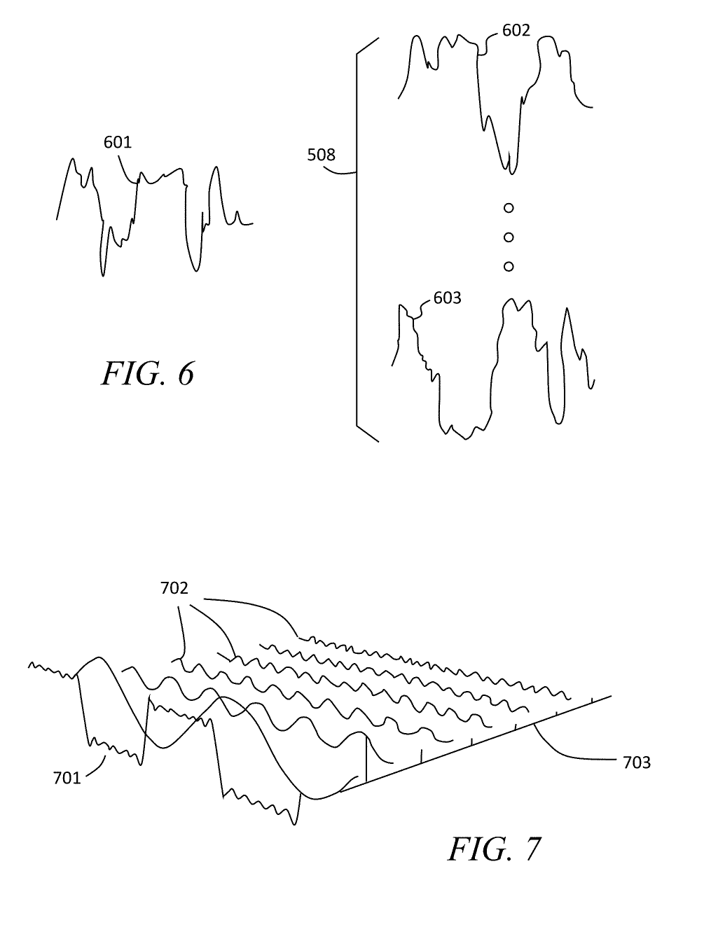

At block 507 this process 500 uses these detected changes to create a spectral profile for the monitored person. FIG. 6 provides an illustrative example in these regards with the spectral profile denoted by reference numeral 601. In this illustrative example the spectral profile 601 represents changes to the person's behavior over a given period of time (such as an hour, a day, a week, or some other temporal window of choice). Such a spectral profile can be as multidimensional as may suit the needs of a given application setting.

At optional block 507 this process 500 then provides for determining whether there is a statistically significant correlation between the aforementioned spectral profile and any of a plurality of like characterizations 508. The like characterizations 508 can comprise, for example, spectral profiles that represent an average of groupings of people who share many of the same (or all of the same) identified partialities. As a very simple illustrative example in these regards, a first such characterization 602 might represent a composite view of a first group of people who have three similar partialities but a dissimilar fourth partiality while another of the characterizations 603 might represent a composite view of a different group of people who share all four partialities.

The aforementioned “statistically significant” standard can be selected and/or adjusted to suit the needs of a given application setting. The scale or units by which this measurement can be assessed can be any known, relevant scale/unit including, but not limited to, scales such as standard deviations, cumulative percentages, percentile equivalents, Z-scores, T-scores, standard nines, and percentages in standard nines. Similarly, the threshold by which the level of statistical significance is measured/assessed can be set and selected as desired. By one approach the threshold is static such that the same threshold is employed regardless of the circumstances. By another approach the threshold is dynamic and can vary with such things as the relative size of the population of people upon which each of the characterizations 508 are based and/or the amount of data and/or the duration of time over which data is available for the monitored person.

Referring now to FIG. 7, by one approach the selected characterization (denoted by reference numeral 701 in this figure) comprises an activity profile over time of one or more human behaviors. Examples of behaviors include but are not limited to such things as repeated purchases over time of particular commodities, repeated visits over time to particular locales such as certain restaurants, retail outlets, athletic or entertainment facilities, and so forth, and repeated activities over time such as floor cleaning, dish washing, car cleaning, cooking, volunteering, and so forth. Those skilled in the art will understand and appreciate, however, that the selected characterization is not, in and of itself, demographic data (as described elsewhere herein).

More particularly, the characterization 701 can represent (in this example, for a plurality of different behaviors) each instance over the monitored/sampled period of time when the monitored/represented person engages in a particular represented behavior (such as visiting a neighborhood gym, purchasing a particular product (such as a consumable perishable or a cleaning product), interacts with a particular affinity group via social networking, and so forth). The relevant overall time frame can be chosen as desired and can range in a typical application setting from a few hours or one day to many days, weeks, or even months or years. (It will be understood by those skilled in the art that the particular characterization shown in FIG. 7 is intended to serve an illustrative purpose and does not necessarily represent or mimic any particular behavior or set of behaviors).

Generally speaking it is anticipated that many behaviors of interest will occur at regular or somewhat regular intervals and hence will have a corresponding frequency or periodicity of occurrence. For some behaviors that frequency of occurrence may be relatively often (for example, oral hygiene events that occur at least once, and often multiple times each day) while other behaviors (such as the preparation of a holiday meal) may occur much less frequently (such as only once, or only a few times, each year). For at least some behaviors of interest that general (or specific) frequency of occurrence can serve as a significant indication of a person's corresponding partialities.

By one approach, these teachings will accommodate detecting and timestamping each and every event/activity/behavior or interest as it happens. Such an approach can be memory intensive and require considerable supporting infrastructure.

The present teachings will also accommodate, however, using any of a variety of sampling periods in these regards. In some cases, for example, the sampling period per se may be one week in duration. In that case, it may be sufficient to know that the monitored person engaged in a particular activity (such as cleaning their car) a certain number of times during that week without known precisely when, during that week, the activity occurred. In other cases it may be appropriate or even desirable, to provide greater granularity in these regards. For example, it may be better to know which days the person engaged in the particular activity or even the particular hour of the day. Depending upon the selected granularity/resolution, selecting an appropriate sampling window can help reduce data storage requirements (and/or corresponding analysis/processing overhead requirements).

Although a given person's behaviors may not, strictly speaking, be continuous waves (as shown in FIG. 7) in the same sense as, for example, a radio or acoustic wave, it will nevertheless be understood that such a behavioral characterization 701 can itself be broken down into a plurality of sub-waves 702 that, when summed together, equal or at least approximate to some satisfactory degree the behavioral characterization 701 itself (The more-discrete and sometimes less-rigidly periodic nature of the monitored behaviors may introduce a certain amount of error into the corresponding sub-waves. There are various mathematically satisfactory ways by which such error can be accommodated including by use of weighting factors and/or expressed tolerances that correspond to the resultant sub-waves.)

It should also be understood that each such sub-wave can often itself be associated with one or more corresponding discrete partialities. For example, a partiality reflecting concern for the environment may, in turn, influence many of the included behavioral events (whether they are similar or dissimilar behaviors or not) and accordingly may, as a sub-wave, comprise a relatively significant contributing factor to the overall set of behaviors as monitored over time. These sub-waves (partialities) can in turn be clearly revealed and presented by employing a transform (such as a Fourier transform) of choice to yield a spectral profile 703 wherein the X axis represents frequency and the Y axis represents the magnitude of the response of the monitored person at each frequency/sub-wave of interest.

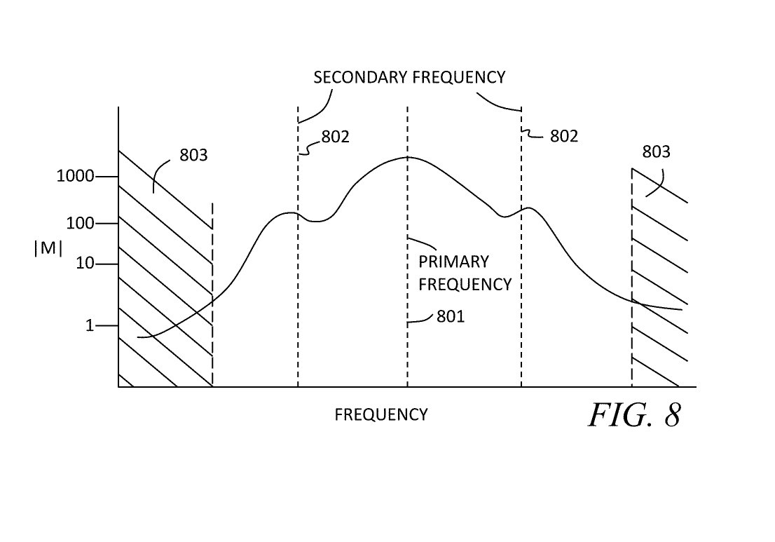

This spectral response of a given individual—which is generated from a time series of events that reflect/track that person's behavior—yields frequency response characteristics for that person that are analogous to the frequency response characteristics of physical systems such as, for example, an analog or digital filter or a second order electrical or mechanical system. Referring to FIG. 8, for many people the spectral profile of the individual person will exhibit a primary frequency 801 for which the greatest response (perhaps many orders of magnitude greater than other evident frequencies) to life is exhibited and apparent. In addition, the spectral profile may also possibly identify one or more secondary frequencies 802 above and/or below that primary frequency 801. (It may be useful in many application settings to filter out more distant frequencies 803 having considerably lower magnitudes because of a reduced likelihood of relevance and/or because of a possibility of error in those regards; in effect, these lower-magnitude signals constitute noise that such filtering can remove from consideration.)

As noted above, the present teachings will accommodate using sampling windows of varying size. By one approach the frequency of events that correspond to a particular partiality can serve as a basis for selecting a particular sampling rate to use when monitoring for such events. For example, Nyquist-based sampling rules (which dictate sampling at a rate at least twice that of the frequency of the signal of interest) can lead one to choose a particular sampling rate (and the resultant corresponding sampling window size).

As a simple illustration, if the activity of interest occurs only once a week, then using a sampling of half-a-week and sampling twice during the course of a given week will adequately capture the monitored event. If the monitored person's behavior should change, a corresponding change can be automatically made. For example, if the person in the foregoing example begins to engage in the specified activity three times a week, the sampling rate can be switched to six times per week (in conjunction with a sampling window that is resized accordingly).

By one approach, the sampling rate can be selected and used on a partiality-by-partiality basis. This approach can be especially useful when different monitoring modalities are employed to monitor events that correspond to different partialities. If desired, however, a single sampling rate can be employed and used for a plurality (or even all) partialities/behaviors. In that case, it can be useful to identify the behavior that is exemplified most often (i.e., that behavior which has the highest frequency) and then select a sampling rate that is at least twice that rate of behavioral realization, as that sampling rate will serve well and suffice for both that highest-frequency behavior and all lower-frequency behaviors as well.

It can be useful in many application settings to assume that the foregoing spectral profile of a given person is an inherent and inertial characteristic of that person and that this spectral profile, in essence, provides a personality profile of that person that reflects not only how but why this person responds to a variety of life experiences. More importantly, the partialities expressed by the spectral profile for a given person will tend to persist going forward and will not typically change significantly in the absence of some powerful external influence (including but not limited to significant life events such as, for example, marriage, children, loss of job, promotion, and so forth).

In any event, by knowing a priori the particular partialities (and corresponding strengths) that underlie the particular characterization 701, those partialities can be used as an initial template for a person whose own behaviors permit the selection of that particular characterization 701. In particular, those particularities can be used, at least initially, for a person for whom an amount of data is not otherwise available to construct a similarly rich set of partiality information.

As a very specific and non-limiting example, per these teachings the choice to make a particular product can include consideration of one or more value systems of potential customers. When considering persons who value animal rights, a product conceived to cater to that value proposition may require a corresponding exertion of additional effort to order material space-time such that the product is made in a way that (A) does not harm animals and/or (even better) (B) improves life for animals (for example, eggs obtained from free range chickens). The reason a person exerts effort to order material space-time is because they believe it is good to do and/or not good to not do so. When a person exerts effort to do good (per their personal standard of “good”) and if that person believes that a particular order in material space-time (that includes the purchase of a particular product) is good to achieve, then that person will also believe that it is good to buy as much of that particular product (in order to achieve that good order) as their finances and needs reasonably permit (all other things being equal).

The aforementioned additional effort to provide such a product can (typically) convert to a premium that adds to the price of that product. A customer who puts out extra effort in their life to value animal rights will typically be willing to pay that extra premium to cover that additional effort exerted by the company. By one approach a magnitude that corresponds to the additional effort exerted by the company can be added to the person's corresponding value vector because a product or service has worth to the extent that the product/service allows a person to order material space-time in accordance with their own personal value system while allowing that person to exert less of their own effort in direct support of that value (since money is a scalar form of effort).

By one approach there can be hundreds or even thousands of identified partialities. In this case, if desired, each product/service of interest can be assessed with respect to each and every one of these partialities and a corresponding partiality vector formed to thereby build a collection of partiality vectors that collectively characterize the product/service. As a very simple example in these regards, a given laundry detergent might have a cleanliness partiality vector with a relatively high magnitude (representing the effectiveness of the detergent), a ecology partiality vector that might be relatively low or possibly even having a negative magnitude (representing an ecologically disadvantageous effect of the detergent post usage due to increased disorder in the environment), and a simple-life partiality vector with only a modest magnitude (representing the relative ease of use of the detergent but also that the detergent presupposes that the user has a modern washing machine). Other partiality vectors for this detergent, representing such things as nutrition or mental acuity, might have magnitudes of zero.

As mentioned above, these teachings can accommodate partiality vectors having a negative magnitude. Consider, for example, a partiality vector representing a desire to order things to reduce one's so-called carbon footprint. A magnitude of zero for this vector would indicate a completely neutral effect with respect to carbon emissions while any positive-valued magnitudes would represent a net reduction in the amount of carbon in the atmosphere, hence increasing the ability of the environment to be ordered. Negative magnitudes would represent the introduction of carbon emissions that increases disorder of the environment (for example, as a result of manufacturing the product, transporting the product, and/or using the product)

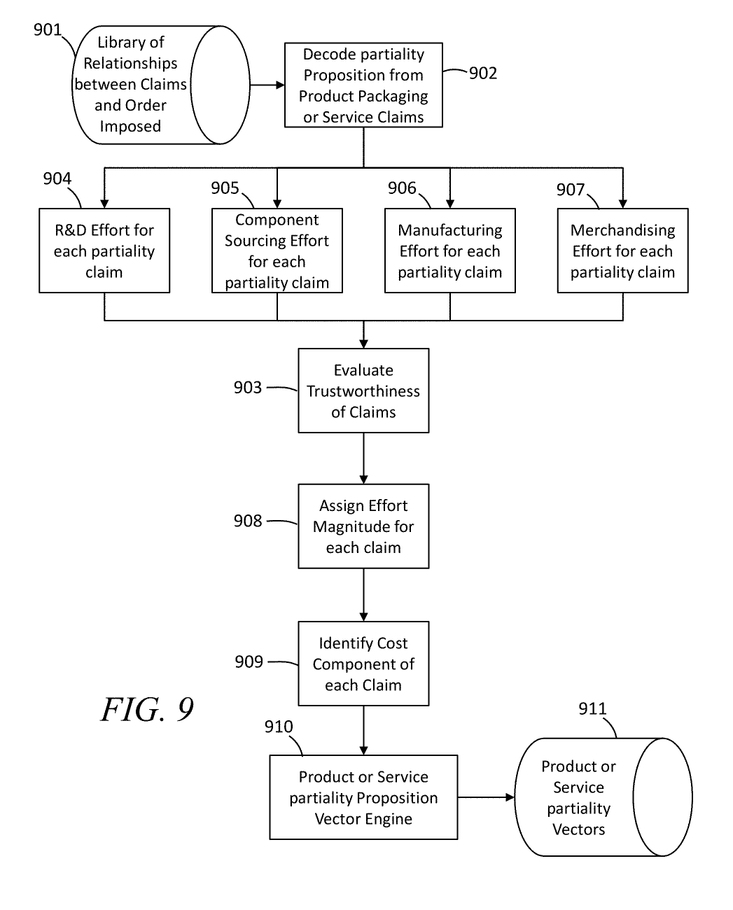

FIG. 9 presents one non-limiting illustrative example in these regards. The illustrated process presumes the availability of a library 901 of correlated relationships between product/service claims and particular imposed orders. Examples of product/service claims include such things as claims that a particular product results in cleaner laundry or household surfaces, or that a particular product is made in a particular political region (such as a particular state or country), or that a particular product is better for the environment, and so forth. The imposed orders to which such claims are correlated can reflect orders as described above that pertain to corresponding partialities.

At block 902 this process provides for decoding one or more partiality propositions from specific product packaging (or service claims). For example, the particular textual/graphics-based claims presented on the packaging of a given product can be used to access the aforementioned library 901 to identify one or more corresponding imposed orders from which one or more corresponding partialities can then be identified.

At block 903 this process provides for evaluating the trustworthiness of the aforementioned claims. This evaluation can be based upon any one or more of a variety of data points as desired. FIG. 9 illustrates four significant possibilities in these regards. For example, at block 904 an actual or estimated research and development effort can be quantified for each claim pertaining to a partiality. At block 905 an actual or estimated component sourcing effort for the product in question can be quantified for each claim pertaining to a partiality. At block 906 an actual or estimated manufacturing effort for the product in question can be quantified for each claim pertaining to a partiality. And at block 907 an actual or estimated merchandising effort for the product in question can be quantified for each claim pertaining to a partiality.

If desired, a product claim lacking sufficient trustworthiness may simply be excluded from further consideration. By another approach the product claim can remain in play but a lack of trustworthiness can be reflected, for example, in a corresponding partiality vector direction or magnitude for this particular product.

At block 908 this process provides for assigning an effort magnitude for each evaluated product/service claim. That effort can constitute a one-dimensional effort (reflecting, for example, only the manufacturing effort) or can constitute a multidimensional effort that reflects, for example, various categories of effort such as the aforementioned research and development effort, component sourcing effort, manufacturing effort, and so forth.

At block 909 this process provides for identifying a cost component of each claim, this cost component representing a monetary value. At block 910 this process can use the foregoing information with a product/service partiality propositions vector engine to generate a library 911 of one or more corresponding partiality vectors for the processed products/services. Such a library can then be used as described herein in conjunction with partiality vector information for various persons to identify, for example, products/services that are well aligned with the partialities of specific individuals.

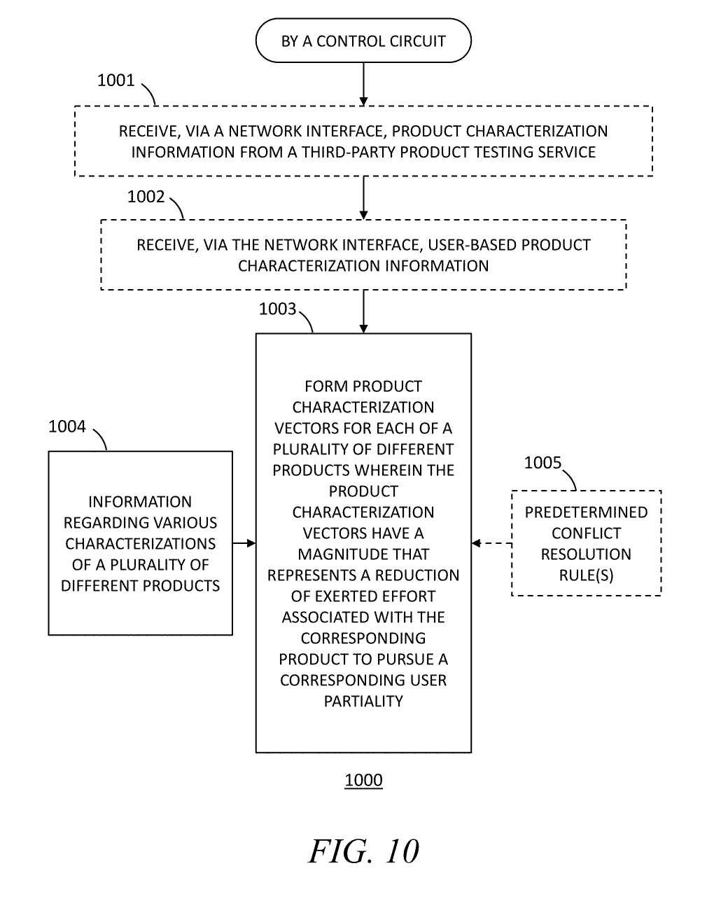

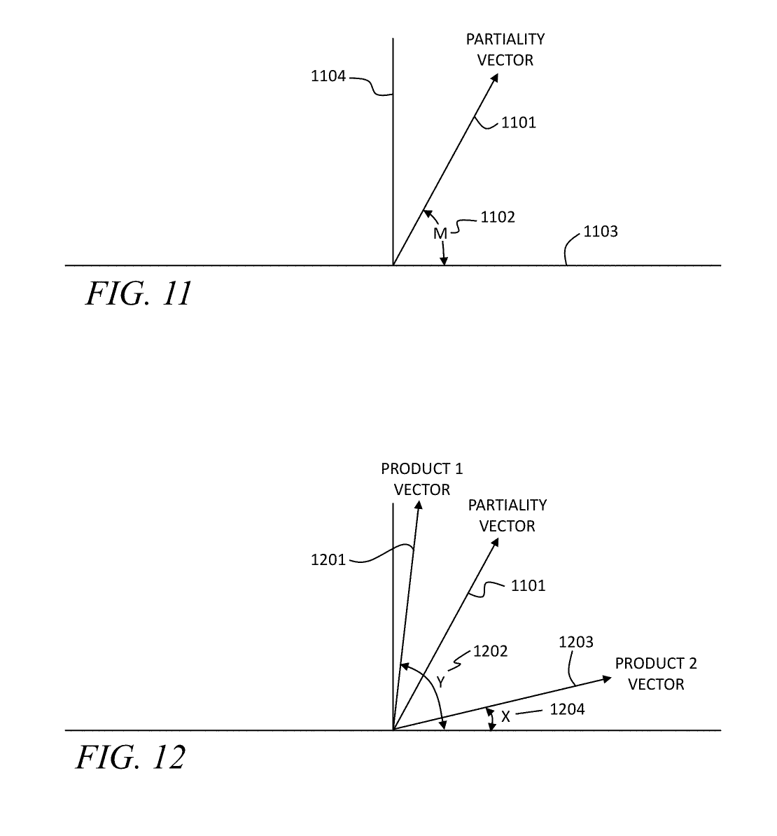

FIG. 10 provides another illustrative example in these same regards and may be employed in lieu of the foregoing or in total or partial combination therewith. Generally speaking, this process 1000 serves to facilitate the formation of product characterization vectors for each of a plurality of different products where the magnitude of the vector length (and/or the vector angle) has a magnitude that represents a reduction of exerted effort associated with the corresponding product to pursue a corresponding user partiality.

By one approach, and as illustrated in FIG. 10, this process 1000 can be carried out by a control circuit of choice. Specific examples of control circuits are provided elsewhere herein.

As described further herein in detail, this process 1000 makes use of information regarding various characterizations of a plurality of different products. These teachings are highly flexible in practice and will accommodate a wide variety of possible information sources and types of information. By one optional approach, and as shown at optional block 1001, the control circuit can receive (for example, via a corresponding network interface of choice) product characterization information from a third-party product testing service. The magazine/web resource Consumers Report provides one useful example in these regards. Such a resource provides objective content based upon testing, evaluation, and comparisons (and sometimes also provides subjective content regarding such things as aesthetics, ease of use, and so forth) and this content, provided as-is or pre-processed as desired, can readily serve as useful third-party product testing service product characterization information.

As another example, any of a variety of product-testing blogs that are published on the Internet can be similarly accessed and the product characterization information available at such resources harvested and received by the control circuit. (The expression “third party” will be understood to refer to an entity other than the entity that operates/controls the control circuit and other than the entity that provides the corresponding product itself.)

As another example, and as illustrated at optional block 1002, the control circuit can receive (again, for example, via a network interface of choice) user-based product characterization information. Examples in these regards include but are not limited to user reviews provided on-line at various retail sites for products offered for sale at such sites. The reviews can comprise metricized content (for example, a rating expressed as a certain number of stars out of a total available number of stars, such as 3 stars out of 5 possible stars) and/or text where the reviewers can enter their objective and subjective information regarding their observations and experiences with the reviewed products. In this case, “user-based” will be understood to refer to users who are not necessarily professional reviewers (though it is possible that content from such persons may be included with the information provided at such a resource) but who presumably purchased the product being reviewed and who have personal experience with that product that forms the basis of their review. By one approach the resource that offers such content may constitute a third party as defined above, but these teachings will also accommodate obtaining such content from a resource operated or sponsored by the enterprise that controls/operates this control circuit.

In any event, this process 1000 provides for accessing (see block 1004) information regarding various characterizations of each of a plurality of different products. This information 1004 can be gleaned as described above and/or can be obtained and/or developed using other resources as desired. As one illustrative example in these regards, the manufacturer and/or distributor of certain products may source useful content in these regards.

These teachings will accommodate a wide variety of information sources and types including both objective characterizing and/or subjective characterizing information for the aforementioned products.

Examples of objective characterizing information include, but are not limited to, ingredients information (i.e., specific components/materials from which the product is made), manufacturing locale information (such as country of origin, state of origin, municipality of origin, region of origin, and so forth), efficacy information (such as metrics regarding the relative effectiveness of the product to achieve a particular end-use result), cost information (such as per product, per ounce, per application or use, and so forth), availability information (such as present in-store availability, on-hand inventory availability at a relevant distribution center, likely or estimated shipping date, and so forth), environmental impact information (regarding, for example, the materials from which the product is made, one or more manufacturing processes by which the product is made, environmental impact associated with use of the product, and so forth), and so forth.

Examples of subjective characterizing information include but are not limited to user sensory perception information (regarding, for example, heaviness or lightness, speed of use, effort associated with use, smell, and so forth), aesthetics information (regarding, for example, how attractive or unattractive the product is in appearance, how well the product matches or accords with a particular design paradigm or theme, and so forth), trustworthiness information (regarding, for example, user perceptions regarding how likely the product is perceived to accomplish a particular purpose or to avoid causing a particular collateral harm), trendiness information, and so forth.

This information 1004 can be curated (or not), filtered, sorted, weighted (in accordance with a relative degree of trust, for example, accorded to a particular source of particular information), and otherwise categorized and utilized as desired. As one simple example in these regards, for some products it may be desirable to only use relatively fresh information (i.e., information not older than some specific cut-off date) while for other products it may be acceptable (or even desirable) to use, in lieu of fresh information or in combination therewith, relatively older information. As another simple example, it may be useful to use only information from one particular geographic region to characterize a particular product and to therefore not use information from other geographic regions.

At block 1003 the control circuit uses the foregoing information 1004 to form product characterization vectors for each of the plurality of different products. By one approach these product characterization vectors have a magnitude (for the length of the vector and/or the angle of the vector) that represents a reduction of exerted effort associated with the corresponding product to pursue a corresponding user partiality (as is otherwise discussed herein).

It is possible that a conflict will become evident as between various ones of the aforementioned items of information 1004. In particular, the available characterizations for a given product may not all be the same or otherwise in accord with one another. In some cases it may be appropriate to literally or effectively calculate and use an average to accommodate such a conflict. In other cases it may be useful to use one or more other predetermined conflict resolution rules 1005 to automatically resolve such conflicts when forming the aforementioned product characterization vectors.

These teachings will accommodate any of a variety of rules in these regards. By one approach, for example, the rule can be based upon the age of the information (where, for example the older (or newer, if desired) data is preferred or weighted more heavily than the newer (or older, if desired) data. By another approach, the rule can be based upon a number of user reviews upon which the user-based product characterization information is based (where, for example, the rule specifies that whichever user-based product characterization information is based upon a larger number of user reviews will prevail in the event of a conflict). By another approach, the rule can be based upon information regarding historical accuracy of information from a particular information source (where, for example, the rule specifies that information from a source with a better historical record of accuracy shall prevail over information from a source with a poorer historical record of accuracy in the event of a conflict).

By yet another approach, the rule can be based upon social media. For example, social media-posted reviews may be used as a tie-breaker in the event of a conflict between other more-favored sources. By another approach, the rule can be based upon a trending analysis. And by yet another approach the rule can be based upon the relative strength of brand awareness for the product at issue (where, for example, the rule specifies resolving a conflict in favor of a more favorable characterization when dealing with a product from a strong brand that evidences considerable consumer goodwill and trust).

It will be understood that the foregoing examples are intended to serve an illustrative purpose and are not offered as an exhaustive listing in these regards. It will also be understood that any two or more of the foregoing rules can be used in combination with one another to resolve the aforementioned conflicts.

By one approach the aforementioned product characterization vectors are formed to serve as a universal characterization of a given product. By another approach, however, the aforementioned information 1004 can be used to form product characterization vectors for a same characterization factor for a same product to thereby correspond to different usage circumstances of that same product. Those different usage circumstances might comprise, for example, different geographic regions of usage, different levels of user expertise (where, for example, a skilled, professional user might have different needs and expectations for the product than a casual, lay user), different levels of expected use, and so forth. In particular, the different vectorized results for a same characterization factor for a same product may have differing magnitudes from one another to correspond to different amounts of reduction of the exerted effort associated with that product under the different usage circumstances.

As noted above, the magnitude corresponding to a particular partiality vector for a particular person can be expressed by the angle of that partiality vector. FIG. 11 provides an illustrative example in these regards. In this example the partiality vector 1101 has an angle M 1102 (and where the range of available positive magnitudes range from a minimal magnitude represented by 0° (as denoted by reference numeral 1103) to a maximum magnitude represented by 90° (as denoted by reference numeral 1104)). Accordingly, the person to whom this partiality vector 1001 pertains has a relatively strong (but not absolute) belief in an amount of good that comes from an order associated with that partiality.

FIG. 12, in turn, presents that partiality vector 1101 in context with the product characterization vectors 1201 and 1203 for a first product and a second product, respectively. In this example the product characterization vector 1201 for the first product has an angle Y 1202 that is greater than the angle M 1102 for the aforementioned partiality vector 1101 by a relatively small amount while the product characterization vector 1203 for the second product has an angle X 1204 that is considerably smaller than the angle M 1102 for the partiality vector 1101.

Since, in this example, the angles of the various vectors represent the magnitude of the person's specified partiality or the extent to which the product aligns with that partiality, respectively, vector dot product calculations can serve to help identify which product best aligns with this partiality. Such an approach can be particularly useful when the lengths of the vectors are allowed to vary as a function of one or more parameters of interest. As those skilled in the art will understand, a vector dot product is an algebraic operation that takes two equal-length sequences of numbers (in this case, coordinate vectors) and returns a single number.

This operation can be defined either algebraically or geometrically. Algebraically, it is the sum of the products of the corresponding entries of the two sequences of numbers. Geometrically, it is the product of the Euclidean magnitudes of the two vectors and the cosine of the angle between them. The result is a scalar rather than a vector. As regards the present illustrative example, the resultant scaler value for the vector dot product of the product 1 vector 1201 with the partiality vector 1101 will be larger than the resultant scaler value for the vector dot product of the product 2 vector 1203 with the partiality vector 1101. Accordingly, when using vector angles to impart this magnitude information, the vector dot product operation provides a simple and convenient way to determine proximity between a particular partiality and the performance/properties of a particular product to thereby greatly facilitate identifying a best product amongst a plurality of candidate products.

By way of further illustration, consider an example where a particular consumer as a strong partiality for organic produce and is financially able to afford to pay to observe that partiality. A dot product result for that person with respect to a product characterization vector(s) for organic apples that represent a cost of $10 on a weekly basis (i.e., Cv·P1v) might equal (1,1), hence yielding a scalar result of ∥1∥ (where Cv refers to the corresponding partiality vector for this person and Ply represents the corresponding product characterization vector for these organic apples). Conversely, a dot product result for this same person with respect to a product characterization vector(s) for non-organic apples that represent a cost of $5 on a weekly basis (i.e., Cv·P2v) might instead equal (1,0), hence yielding a scalar result of ∥½∥. Accordingly, although the organic apples cost more than the non-organic apples, the dot product result for the organic apples exceeds the dot product result for the non-organic apples and therefore identifies the more expensive organic apples as being the best choice for this person.

To continue with the foregoing example, consider now what happens when this person subsequently experiences some financial misfortune (for example, they lose their job and have not yet found substitute employment). Such an event can present the “force” necessary to alter the previously-established “inertia” of this person's steady-state partialities; in particular, these negatively-changed financial circumstances (in this example) alter this person's budget sensitivities (though not, of course their partiality for organic produce as compared to non-organic produce). The scalar result of the dot product for the $5/week non-organic apples may remain the same (i.e., in this example, ∥½∥), but the dot product for the $10/week organic apples may now drop (for example, to ∥½∥ as well). Dropping the quantity of organic apples purchased, however, to reflect the tightened financial circumstances for this person may yield a better dot product result. For example, purchasing only $5 (per week) of organic apples may produce a dot product result of ∥1∥. The best result for this person, then, under these circumstances, is a lesser quantity of organic apples rather than a larger quantity of non-organic apples.

In a typical application setting, it is possible that this person's loss of employment is not, in fact, known to the system. Instead, however, this person's change of behavior (i.e., reducing the quantity of the organic apples that are purchased each week) might well be tracked and processed to adjust one or more partialities (either through an addition or deletion of one or more partialities and/or by adjusting the corresponding partiality magnitude) to thereby yield this new result as a preferred result.

The foregoing simple examples clearly illustrate that vector dot product approaches can be a simple yet powerful way to quickly eliminate some product options while simultaneously quickly highlighting one or more product options as being especially suitable for a given person.

Such vector dot product calculations and results, in turn, help illustrate another point as well. As noted above, sine waves can serve as a potentially useful way to characterize and view partiality information for both people and products/services. In those regards, it is worth noting that a vector dot product result can be a positive, zero, or even negative value. That, in turn, suggests representing a particular solution as a normalization of the dot product value relative to the maximum possible value of the dot product. Approached this way, the maximum amplitude of a particular sine wave will typically represent a best solution.

Taking this approach further, by one approach the frequency (or, if desired, phase) of the sine wave solution can provide an indication of the sensitivity of the person to product choices (for example, a higher frequency can indicate a relatively highly reactive sensitivity while a lower frequency can indicate the opposite). A highly sensitive person is likely to be less receptive to solutions that are less than fully optimum and hence can help to narrow the field of candidate products while, conversely, a less sensitive person is likely to be more receptive to solutions that are less than fully optimum and can help to expand the field of candidate products.

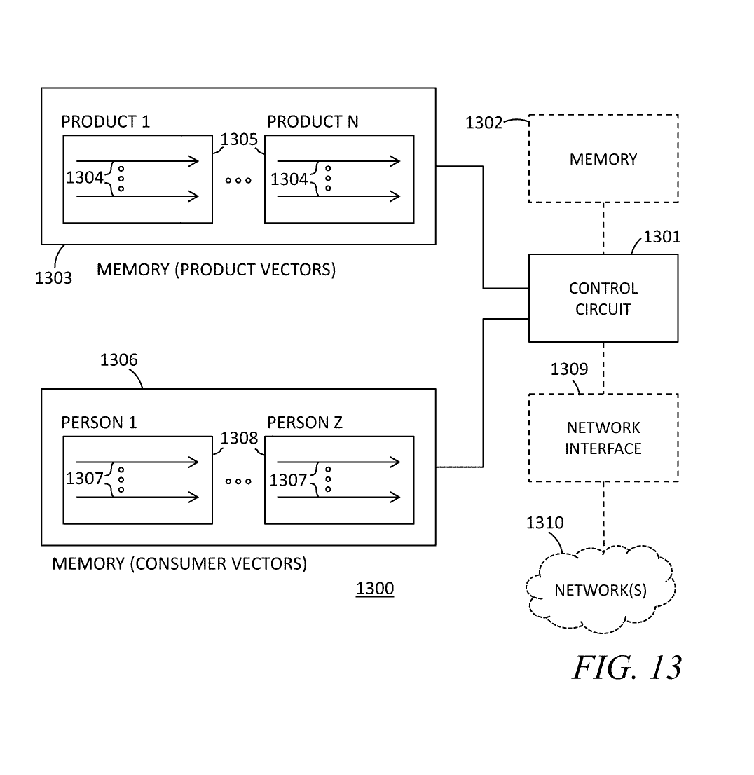

FIG. 13 presents an illustrative apparatus 1300 for conducting, containing, and utilizing the foregoing content and capabilities. In this particular example, the enabling apparatus 1300 includes a control circuit 1301. Being a “circuit,” the control circuit 1301 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 1301 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 1301 is configured (for example, by using corresponding programming as will be well understood by those skilled in the art) to carry out one or more of the steps, actions, and/or functions described herein.

By one optional approach the control circuit 1301 operably couples to a memory 1302. This memory 1302 may be integral to the control circuit 1301 or can be physically discrete (in whole or in part) from the control circuit 1301 as desired. This memory 1302 can also be local with respect to the control circuit 1301 (where, for example, both share a common circuit board, chassis, power supply, and/or housing) or can be partially or wholly remote with respect to the control circuit 1301 (where, for example, the memory 1302 is physically located in another facility, metropolitan area, or even country as compared to the control circuit 1301).

This memory 1302 can serve, for example, to non-transitorily store the computer instructions that, when executed by the control circuit 1301, cause the control circuit 1301 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

Either stored in this memory 1302 or, as illustrated, in a separate memory 1303 are the vectorized characterizations 1304 for each of a plurality of products 1305 (represented here by a first product through an Nth product where “N” is an integer greater than “1”). In addition, and again either stored in this memory 1302 or, as illustrated, in a separate memory 1306 are the vectorized characterizations 1307 for each of a plurality of individual persons 1308 (represented here by a first person through a Zth person wherein “Z” is also an integer greater than “1”).

In this example the control circuit 1301 also operably couples to a network interface 1309. So configured the control circuit 1301 can communicate with other elements (both within the apparatus 1300 and external thereto) via the network interface 1309. Network interfaces, including both wireless and non-wireless platforms, are well understood in the art and require no particular elaboration here. This network interface 1309 can compatibly communicate via whatever network or networks 1310 may be appropriate to suit the particular needs of a given application setting. Both communication networks and network interfaces are well understood areas of prior art endeavor and therefore no further elaboration will be provided here in those regards for the sake of brevity.

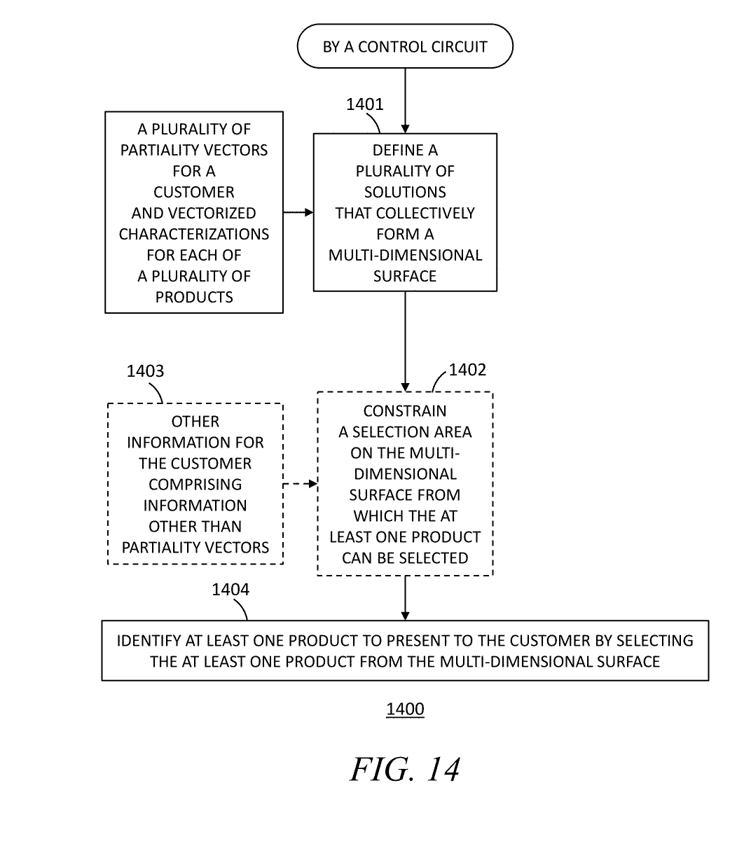

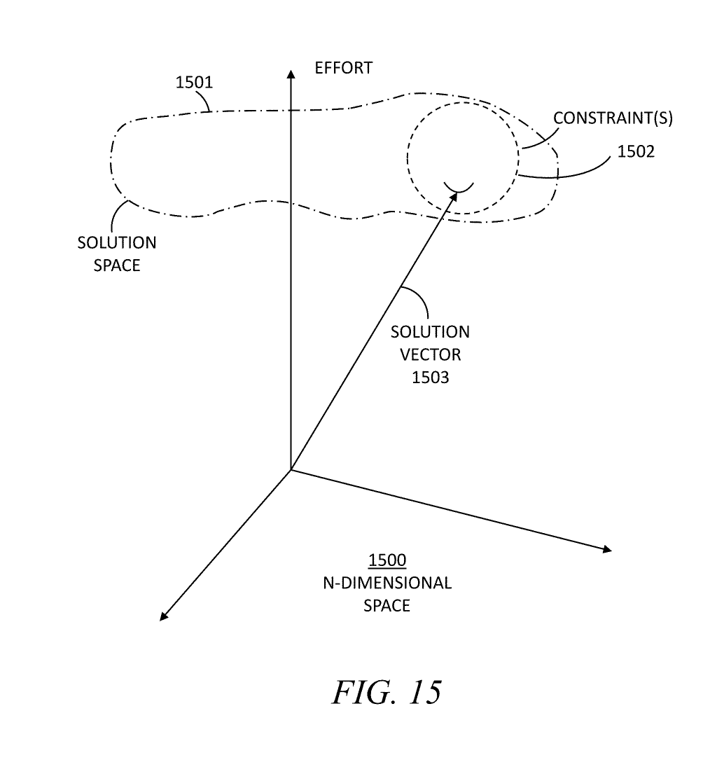

By one approach, and referring now to FIG. 14, the control circuit 1301 is configured to use the aforementioned partiality vectors 1307 and the vectorized product characterizations 1304 to define a plurality of solutions that collectively form a multidimensional surface (per block 1401). FIG. 15 provides an illustrative example in these regards. FIG. 15 represents an N-dimensional space 1500 and where the aforementioned information for a particular customer yielded a multi-dimensional surface denoted by reference numeral 1501. (The relevant value space is an N-dimensional space where the belief in the value of a particular ordering of one's life only acts on value propositions in that space as a function of a least-effort functional relationship.)

Generally speaking, this surface 1501 represents all possible solutions based upon the foregoing information. Accordingly, in a typical application setting this surface 1501 will contain/represent a plurality of discrete solutions. That said, and also in a typical application setting, not all of those solutions will be similarly preferable. Instead, one or more of those solutions may be particularly useful/appropriate at a given time, in a given place, for a given customer.

With continued reference to FIGS. 14 and 15, at optional block 1402 the control circuit 1301 can be configured to use information for the customer 1403 (other than the aforementioned partiality vectors 1307) to constrain a selection area 1502 on the multi-dimensional surface 1501 from which at least one product can be selected for this particular customer. By one approach, for example, the constraints can be selected such that the resultant selection area 1502 represents the best 95th percentile of the solution space. Other target sizes for the selection area 1502 are of course possible and may be useful in a given application setting.

The aforementioned other information 1403 can comprise any of a variety of information types. By one approach, for example, this other information comprises objective information. (As used herein, “objective information” will be understood to constitute information that is not influenced by personal feelings or opinions and hence constitutes unbiased, neutral facts.)

One particularly useful category of objective information comprises objective information regarding the customer. Examples in these regards include, but are not limited to, location information regarding a past, present, or planned/scheduled future location of the customer, budget information for the customer or regarding which the customer must strive to adhere (such that, by way of example, a particular product/solution area may align extremely well with the customer's partialities but is well beyond that which the customer can afford and hence can be reasonably excluded from the selection area 1502), age information for the customer, and gender information for the customer. Another example in these regards is information comprising objective logistical information regarding providing particular products to the customer. Examples in these regards include but are not limited to current or predicted product availability, shipping limitations (such as restrictions or other conditions that pertain to shipping a particular product to this particular customer at a particular location), and other applicable legal limitations (pertaining, for example, to the legality of a customer possessing or using a particular product at a particular location).

At block 1404 the control circuit 1301 can then identify at least one product to present to the customer by selecting that product from the multi-dimensional surface 1501. In the example of FIG. 15, where constraints have been used to define a reduced selection area 1502, the control circuit 1301 is constrained to select that product from within that selection area 1502. For example, and in accordance with the description provided herein, the control circuit 1301 can select that product via solution vector 1503 by identifying a particular product that requires a minimal expenditure of customer effort while also remaining compliant with one or more of the applied objective constraints based, for example, upon objective information regarding the customer and/or objective logistical information regarding providing particular products to the customer.

So configured, and as a simple example, the control circuit 1301 may respond per these teachings to learning that the customer is planning a party that will include seven other invited individuals. The control circuit 1301 may therefore be looking to identify one or more particular beverages to present to the customer for consideration in those regards. The aforementioned partiality vectors 1307 and vectorized product characterizations 1304 can serve to define a corresponding multi-dimensional surface 1501 that identifies various beverages that might be suitable to consider in these regards.

Objective information regarding the customer and/or the other invited persons, however, might indicate that all or most of the participants are not of legal drinking age. In that case, that objective information may be utilized to constrain the available selection area 1502 to beverages that contain no alcohol. As another example in these regards, the control circuit 1301 may have objective information that the party is to be held in a state park that prohibits alcohol and may therefore similarly constrain the available selection area 1502 to beverages that contain no alcohol.

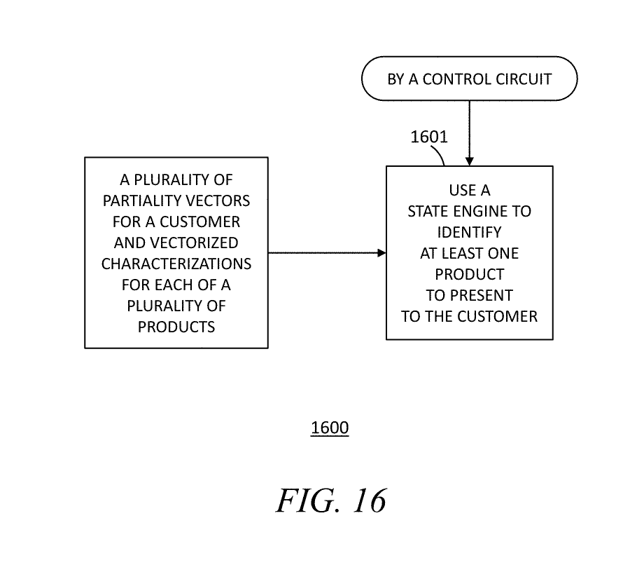

As described above, the aforementioned control circuit 1301 can utilize information including a plurality of partiality vectors for a particular customer along with vectorized product characterizations for each of a plurality of products to identify at least one product to present to a customer. By one approach 1600, and referring to FIG. 16, the control circuit 1301 can be configured as (or to use) a state engine to identify such a product (as indicated at block 1601). As used herein, the expression “state engine” will be understood to refer to a finite-state machine, also sometimes known as a finite-state automaton or simply as a state machine.

Generally speaking, a state engine is a basic approach to designing both computer programs and sequential logic circuits. A state engine has only a finite number of states and can only be in one state at a time. A state engine can change from one state to another when initiated by a triggering event or condition often referred to as a transition. Accordingly, a particular state engine is defined by a list of its states, its initial state, and the triggering condition for each transition.

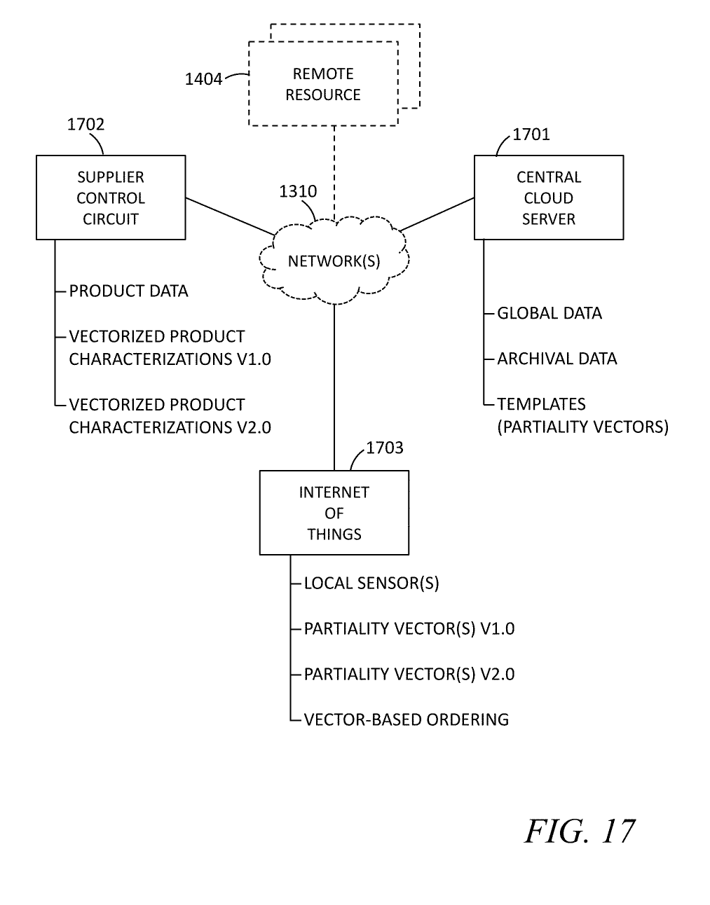

It will be appreciated that the apparatus 1300 described above can be viewed as a literal physical architecture or, if desired, as a logical construct. For example, these teachings can be enabled and operated in a highly centralized manner (as might be suggested when viewing that apparatus 1300 as a physical construct) or, conversely, can be enabled and operated in a highly decentralized manner. FIG. 17 provides an example as regards the latter.

In this illustrative example a central cloud server 1701, a supplier control circuit 1702, and the aforementioned Internet of Things 1703 communicate via the aforementioned network 1310.

The central cloud server 1701 can receive, store, and/or provide various kinds of global data (including, for example, general demographic information regarding people and places, profile information for individuals, product descriptions and reviews, and so forth), various kinds of archival data (including, for example, historical information regarding the aforementioned demographic and profile information and/or product descriptions and reviews), and partiality vector templates as described herein that can serve as starting point general characterizations for particular individuals as regards their partialities. Such information may constitute a public resource and/or a privately-curated and accessed resource as desired. (It will also be understood that there may be more than one such central cloud server 1701 that store identical, overlapping, or wholly distinct content.)

The supplier control circuit 1702 can comprise a resource that is owned and/or operated on behalf of the suppliers of one or more products (including but not limited to manufacturers, wholesalers, retailers, and even resellers of previously-owned products). This resource can receive, process and/or analyze, store, and/or provide various kinds of information. Examples include but are not limited to product data such as marketing and packaging content (including textual materials, still images, and audio-video content), operators and installers manuals, recall information, professional and non-professional reviews, and so forth.

Another example comprises vectorized product characterizations as described herein. More particularly, the stored and/or available information can include both prior vectorized product characterizations (denoted in FIG. 17 by the expression “vectorized product characterizations V1.0”) for a given product as well as subsequent, updated vectorized product characterizations (denoted in FIG. 17 by the expression “vectorized product characterizations V2.0”) for the same product. Such modifications may have been made by the supplier control circuit 1702 itself or may have been made in conjunction with or wholly by an external resource as desired.

The Internet of Things 1703 can comprise any of a variety of devices and components that may include local sensors that can provide information regarding a corresponding user's circumstances, behaviors, and reactions back to, for example, the aforementioned central cloud server 1701 and the supplier control circuit 1702 to facilitate the development of corresponding partiality vectors for that corresponding user. Again, however, these teachings will also support a decentralized approach. In many cases devices that are fairly considered to be members of the Internet of Things 1703 constitute network edge elements (i.e., network elements deployed at the edge of a network). In some case the network edge element is configured to be personally carried by the person when operating in a deployed state. Examples include but are not limited to so-called smart phones, smart watches, fitness monitors that are worn on the body, and so forth. In other cases, the network edge element may be configured to not be personally carried by the person when operating in a deployed state. This can occur when, for example, the network edge element is too large and/or too heavy to be reasonably carried by an ordinary average person. This can also occur when, for example, the network edge element has operating requirements ill-suited to the mobile environment that typifies the average person.

For example, a so-called smart phone can itself include a suite of partiality vectors for a corresponding user (i.e., a person that is associated with the smart phone which itself serves as a network edge element) and employ those partiality vectors to facilitate vector-based ordering (either automated or to supplement the ordering being undertaken by the user) as is otherwise described herein. In that case, the smart phone can obtain corresponding vectorized product characterizations from a remote resource such as, for example, the aforementioned supplier control circuit 1702 and use that information in conjunction with local partiality vector information to facilitate the vector-based ordering.

Also, if desired, the smart phone in this example can itself modify and update partiality vectors for the corresponding user. To illustrate this idea in FIG. 17, this device can utilize, for example, information gained at least in part from local sensors to update a locally-stored partiality vector (represented in FIG. 17 by the expression “partiality vector V1.0”) to obtain an updated locally-stored partiality vector (represented in FIG. 17 by the expression “partiality vector V2.0”). Using this approach, a user's partiality vectors can be locally stored and utilized. Such an approach may better comport with a particular user's privacy concerns.

It will be understood that the smart phone employed in the immediate example is intended to serve in an illustrative capacity and is not intended to suggest any particular limitations in these regards. In fact, any of a wide variety of Internet of Things devices/components could be readily configured in the same regards. As one simple example in these regards, a computationally-capable networked refrigerator could be configured to order appropriate perishable items for a corresponding user as a function of that user's partialities.

Presuming a decentralized approach, these teachings will accommodate any of a variety of other remote resources 1704. These remote resources 1704 can, in turn, provide static or dynamic information and/or interaction opportunities or analytical capabilities that can be called upon by any of the above-described network elements. Examples include but are not limited to voice recognition, pattern and image recognition, facial recognition, statistical analysis, computational resources, encryption and decryption services, fraud and misrepresentation detection and prevention services, digital currency support, and so forth.

As already suggested above, these approaches provide powerful ways for identifying products and/or services that a given person, or a given group of persons, may likely wish to buy to the exclusion of other options. When the magnitude and direction of the relevant/required meta-force vector that comes from the perceived effort to impose order is known, these teachings will facilitate, for example, engineering a product or service containing potential energy in the precise ordering direction to provide a total reduction of effort. Since people generally take the path of least effort (consistent with their partialities) they will typically accept such a solution.

As one simple illustrative example, a person who exhibits a partiality for food products that emphasize health, natural ingredients, and a concern to minimize sugars and fats may be presumed to have a similar partiality for pet foods because such partialities may be based on a value system that extends beyond themselves to other living creatures within their sphere of concern. If other data is available to indicate that this person in fact has, for example, two pet dogs, these partialities can be used to identify dog food products having well-aligned vectors in these same regards. This person could then be solicited to purchase such dog food products using any of a variety of solicitation approaches (including but not limited to general informational advertisements, discount coupons or rebate offers, sales calls, free samples, and so forth).

As another simple example, the approaches described herein can be used to filter out products/services that are not likely to accord well with a given person's partiality vectors. In particular, rather than emphasizing one particular product over another, a given person can be presented with a group of products that are available to purchase where all of the vectors for the presented products align to at least some predetermined degree of alignment/accord and where products that do not meet this criterion are simply not presented.

And as yet another simple example, a particular person may have a strong partiality towards both cleanliness and orderliness. The strength of this partiality might be measured in part, for example, by the physical effort they exert by consistently and promptly cleaning their kitchen following meal preparation activities. If this person were looking for lawn care services, their partiality vector(s) in these regards could be used to identify lawn care services who make representations and/or who have a trustworthy reputation or record for doing a good job of cleaning up the debris that results when mowing a lawn. This person, in turn, will likely appreciate the reduced effort on their part required to locate such a service that can meaningfully contribute to their desired order.

These teachings can be leveraged in any number of other useful ways. As one example in these regards, various sensors and other inputs can serve to provide automatic updates regarding the events of a given person's day. By one approach, at least some of this information can serve to help inform the development of the aforementioned partiality vectors for such a person. At the same time, such information can help to build a view of a normal day for this particular person. That baseline information can then help detect when this person's day is going experientially awry (i.e., when their desired “order” is off track). Upon detecting such circumstances these teachings will accommodate employing the partiality and product vectors for such a person to help make suggestions (for example, for particular products or services) to help correct the day's order and/or to even effect automatically-engaged actions to correct the person's experienced order.

When this person's partiality (or relevant partialities) are based upon a particular aspiration, restoring (or otherwise contributing to) order to their situation could include, for example, identifying the order that would be needed for this person to achieve that aspiration. Upon detecting, (for example, based upon purchases, social media, or other relevant inputs) that this person is aspirating to be a gourmet chef, these teachings can provide for plotting a solution that would begin providing/offering additional products/services that would help this person move along a path of increasing how they order their lives towards being a gourmet chef.

By one approach, these teachings will accommodate presenting the consumer with choices that correspond to solutions that are intended and serve to test the true conviction of the consumer as to a particular aspiration. The reaction of the consumer to such test solutions can then further inform the system as to the confidence level that this consumer holds a particular aspiration with some genuine conviction. In particular, and as one example, that confidence can in turn influence the degree and/or direction of the consumer value vector(s) in the direction of that confirmed aspiration.

All the above approaches are informed by the constraints the value space places on individuals so that they follow the path of least perceived effort to order their lives to accord with their values which results in partialities. People generally order their lives consistently unless and until their belief system is acted upon by the force of a new trusted value proposition. The present teachings are uniquely able to identify, quantify, and leverage the many aspects that collectively inform and define such belief systems.

A person's preferences can emerge from a perception that a product or service removes effort to order their lives according to their values. The present teachings acknowledge and even leverage that it is possible to have a preference for a product or service that a person has never heard of before in that, as soon as the person perceives how it will make their lives easier they will prefer it. Most predictive analytics that use preferences are trying to predict a decision the customer is likely to make. The present teachings are directed to calculating a reduced effort solution that can/will inherently and innately be something to which the person is partial.

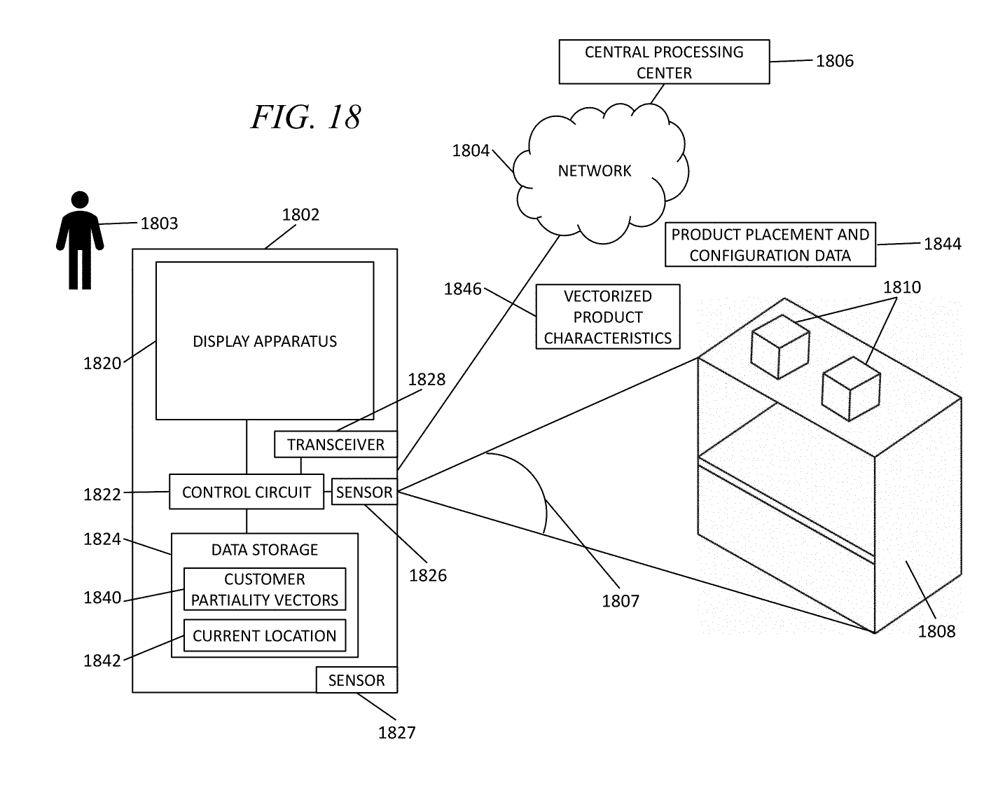

FIGS. 18 through 24 present some further teachings in the foregoing regards wherein at least some, but not necessarily all, of the above-described considerations are further leveraged.

In examples, a “consumer personality” for a consumer (or potentially a group of customers) is determined and then, based on that personality—as quantified by the customer's partiality vectors—a match is made between the customer and products/services that most closely align with the customer's personality. In other words, a determination is made as to why a customer prefers a product (e.g., a healthy dog food) as opposed to another product (e.g., any other dog food). Previous preferential-based systems can only observe a customer's choices and conclude that that the customer prefers to make these choices. Why the customer makes these choices is not considered by these previous approaches.

In others of these embodiments, a mobile electronic device is configured to render augmented reality (AR) images to a retail store customer in real-time. The mobile electronic device includes a first sensor, a display apparatus, a transceiver circuit, a data storage device, and a control circuit. The first sensor obtains an image of a portion of a current field of view of a customer as the customer moves through a retail store.

The transceiver circuit is configured to receive product placement and configuration data associated with products at the retail store. The transceiver circuit is also configured to receive product characteristics (e.g., vectorized product characteristics). Each of the product characteristics comprises an ability of a product to enable past, present, and future order associated with a product at the retail store. If vectorized product characteristics are used, each of the vectorized product characteristics are programmatically linked to a strength of the product characteristic.

The data storage device stores a customer profile (e.g., implemented as customer partiality vectors) and indicates customer preferences. If customer partiality vectors are used, each of the customer partiality vectors comprises a customer preference that is programmatically linked to a strength of the customer preference. The customer preference is associated with a value of the customer, and the value of the customer comprises a belief or perception of the customer in a good or an advantage which results from supporting the order. The data storage device also stores a current location of the customer within the retail store. In other examples, the customer profile may include the purchase history of the customer. Other examples of customer profiles are possible.

The control circuit is coupled to the display apparatus, the transceiver circuit, the first sensor, and the data storage device. The control circuit is configured to store the received product placement and configuration data, and the product characteristics in the data storage device. The control circuit is further configured to obtain the current image from the first sensor, and identify products in the current image based at least in part upon the current location of the customer and the product placement and configuration data, and subsequently obtain the product characteristics of the identified products.

Based upon a comparison between the customer profile (e.g., selected ones of the customer partiality vectors) and the product characteristics (e.g., vectorized product characteristics) of the identified products, the control circuit is configured to select one or more visualization elements to overlay onto the current image of the field of view. The control circuit is configured to create a modified image by incorporating the selected one or more visualization elements into the image, and render the modified image onto the display apparatus for viewing by the customer.

In other aspects, a second sensor is coupled to the control circuit. The second sensor senses data indicates a customer action. The control circuit is configured to selectively make an adjustment to the customer profile (e.g., one or more of the customer partiality vectors) upon detection by the control circuit of the customer action in the data from the second sensor. The adjustment is effective to change at least one of the visualization elements being rendered to the customer. In examples, the second sensor is a camera, an RFID reader, or a scanner. Other examples are possible. In still other aspects and when vectors are used, the adjustment is to increase the strength of a customer partiality vector or to decrease the strength of a customer partiality vector.

In some examples, the first sensor and the second sensor are the same device. The device may be a smartphone, a tablet, a laptop, or headgear. Other examples are possible.

Various types of visualization elements are possible. For example, the visualization element may be one or more of a chart, an icon, a graphical element, a textual element, an animated element, or a color highlight.

In some examples and when vectors are used, the comparison indicates at least one match between the customer partiality vectors and at least one vectorized product characteristic of the identified products. In other examples, the comparison indicates that no match exists between a customer partiality vector for a selected product and the vectorized product characteristic of the selected product. Visualizations of the selected product are removed from the modified image prior to render the modified image to the customer.

In still other examples, the product placement data is included in a planogram, or is sensed information obtained by the first sensor. Other examples are possible.

In other aspects, the current location of the customer is determined by the electronic device from sensed inputs. In other examples, the current location of the customer is received from a central location via the transceiver circuit.

In others of these embodiments, a first sensor obtains an image of a portion of a current field of view of a customer as the customer moves through a retail store. A transceiver circuit receives product placement and configuration data associated with products at the retail store. The transceiver circuit also receives product characteristics (e.g., vectorized product characteristics). Each product characteristic comprises an ability of a product to enable past, present, and future order associated with a product at the retail store. When vectorized product characteristics are used, each of the vectorized product characteristics is programmatically linked to a strength of the product characteristic.

A customer profile (e.g., customer partiality vectors) is stored in a data storage device and indicates customer preferences. If customer partiality vectors are used, each of the customer partiality vectors comprises a customer preference that is programmatically linked to a strength of the customer preference. The customer preference is associated with a value of the customer, and the value of the customer comprises a belief or perception of the customer in a good or an advantage which results from supporting the order. The data storage device also stores a current location of the customer within the retail store.

The control circuit stores the received product placement and configuration data, and the product characteristics (e.g., vectorized product characteristics) in the data storage device and obtains the current image from the first sensor. At the control circuit, products in the current image are identified based at least in part upon the current location of the customer and the product placement and configuration data, and the product characteristics (e.g., vectorized product characteristics) of the identified products are obtained from the data storage device.

Based upon a comparison between the customer profile (e.g., selected ones of the customer partiality vectors) and the product characteristics (e.g., vectorized product characteristics) of the identified products, the control circuit selects one or more visualization elements to overlay onto the current image of the field of view. The control circuit creates a modified image by incorporating the selected one or more visualization elements into the image, and renders the modified image onto the display apparatus for viewing by the customer.

In other aspects, a portable electronic device is carried or used by a customer as they move through a retail store. The customer is at a known location. A sensor on the device obtains an image of a portion of the current field of view of the customer. Product placement data (e.g., a planogram) showing how products in the store are arranged is received at the mobile device. Vectorized product characteristics associated with the products in the store are also received. Products in the field of view are identified based upon the current location of the customer and the product placement data. The identified products are linked to or associated with their corresponding product vectors. Then, based upon a comparison between the vectorized product characteristics of the identified products and a customer's partiality vectors, different overlays (e.g., icons or charts) are identified or created. The current image is modified to include these overlays and this is modified image is rendered to the customer

Customer actions such as picking up a product, viewing a product, or returning a product modify the customer partiality vectors. Additionally, the vectorized product characteristics of selected products (e.g., the characteristics of products left on the shelf when another product is selected by the customer) may also be modified by the actions of a customer. Consequently, the images rendered to customers are dynamic and change with time based upon the actions of the customer.

It will be appreciated that many of the approaches described below in FIGS. 18-24 utilize customer partiality vectors and vectorized product characteristics. However, it will be appreciated that more generally, a customer profile or customer profile information (such as customer purchases over time, or other indications of customer preference) can be used instead of customer partiality vectors. It will also be understood that more generally product characteristics (represented in forms or formats not necessarily as vectors) may be used in place of vectorized product characteristic.

Referring now to FIG. 18, one example of a system 1800 that provide an augmented reality display is described. In aspects, augmented reality provides a view of real world elements augmented by other visualizations (or possibly other inputs such as sounds) that takes into account the context of the current environment of a customer. It will be appreciated that these approaches allow customers to quickly and easily determine products of interest in a crowded retails space. Augmenting images in real time allows the customer to have an enhanced shopping experience and allows them to quickly locate and ultimately purchase these products.

The system 1800 includes a mobile electronic device 1802, a network 1804 (coupled to a central processing center 1806). A customer 1803 uses the mobile electronic device 1802. The network 1804 is any type of electronic communications network (e.g., the cloud, the internet, or cellular communication network) or combination of networks.

The customer 1803 traverses a retail store. The mobile electronic device 1802 scans a shelf 1808 with products 1810. The device 1802 may be a smartphone, a tablet, a laptop, or headgear. Other examples are possible. The products 1810 may be any type of products available for customer purchase. Although described herein as being implemented within a retail store, it will be appreciated that the approaches described herein are applicable to other settings such as offices, schools, warehouses, or other locations.

The mobile electronics device 1802 includes a display apparatus 1820, a control circuit 1822, a data storage device 1824, a first sensor 1826, and a transceiver 1828. The display apparatus 1820 is any type of display device such as a screen (e.g., a touch screen or computer display screen to mention a few examples).

The first sensor 1826 is any type of sensor such as a camera, an RFID scanner, a barcode scanner, or combinations of these or other devices. The first sensor 1826 captures, obtains, or senses a field of view 1807 that is a portion of the field of view for the customer 1803.

The transceiver circuit 1828 is any type of electronic device that is configured to transmit and receive different types of information. In examples, the transceiver circuit 1828 includes buffers, transmitters, receivers, or processors. The transceiver circuit 1828 is configured to receive product placement and configuration data 1844 associated with products at the retail store. In some examples, the product placement data is included in a planogram, or is sensed information obtained by the first sensor 1826. Other examples are possible.

The transceiver circuit 1828 is also configured to receive vectorized product characteristics 1846 (or more generally product characteristics that are in any format or configuration). Each of the vectorized product characteristics 1846 comprises an ability of a product to enable past, present, and future order associated with a product at the retail store. Each of the vectorized product characteristics 1846 are programmatically linked to a strength of the product characteristic.

The product placement and configuration data 1844 and vectorized product characteristics 1846 may be stored at and received from the central processing center 1806 via the network 1804. The central processing center 1806 may be located at the retail store or at a central location such as a headquarters or home office.

The data storage device 1824 is any type of electronic memory storage device. The data storage device 1824 is configured to store a plurality of customer partiality vectors (or more generally a customer profile or customer profile information) of a customer. Each of the customer partiality vectors 1840 comprises a customer preference of the customer 1803 that is programmatically linked to a strength of the customer preference. The customer preference is associated with a value of the customer, and the value of the customer comprises a belief or perception of the customer in a good or an advantage which results from supporting the order. The data storage device 1824 also stores a current location 1842 of the customer 1802 within the retail store. The vectors are stored as any appropriate data structure (e.g., tables or linked lists). If a more general customer profile is used, this may include a list of items purchased by the customer or otherwise indicated of being of interest to the customer (e.g., viewed on the internet to mention one example).

The control circuit 1822 is coupled to the display apparatus 1820, data storage device 1824, first sensor 1826, and transceiver 1828. It will be appreciated that as used herein the term “control circuit” refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 1808 may be configured (for example, by using corresponding programming stored in a memory as will be well understood by those skilled in the art) to carry out one or more of the steps, actions, and/or functions described herein.

In one example of the operation of the system of FIG. 18, the device 1802 is operated by the customer 1803 in a retail store. The control circuit 1822 of the device 1802 is configured to store the vectorized product placement and configuration data 1844, and the vectorized product characteristics 1846 received via the transceiver circuit 1828 in the data storage device 1824. The control circuit 1822 is further configured to obtain the current image from the first sensor 1826, and identify products 1810 in the current image based at least in part upon the current location 1842 of the customer 1803 and the product placement and configuration data 1846, and subsequently obtain the vectorized product characteristics of the identified products 1810.

Based upon a comparison between selected ones of the customer partiality vectors and the vectorized product characteristics of the identified products 1810, the control circuit 1822 is configured to select one or more visualization elements to overlay onto the current image of the field of view. The control circuit 1822 is configured to create a modified image by incorporating the selected one or more visualization elements into the image, and render the modified image onto the display apparatus 1820 for viewing by the customer 1803. It will be appreciated that the image of field of view 1807 is continuously updated in real-real time as time progresses and/or as the device 1802 move through the store. Additionally, all information rendered at the display apparatus 1820 is also updated in real-time. The updating may be at predetermined or random intervals. Consequently, the image rendered at the display apparatus 1820 is up-to-date and reflects a portion of the field of view 1807 of the customer 1802. Updates may also be received that adjust the current location 1842 of the customer 1803 as the customer 1803 moves through the store.

In other aspects, a second sensor 1827 is coupled to the control circuit 1822. The second sensor senses data indicates a customer action. The control circuit 1822 is configured to selectively make an adjustment to one or more of the customer partiality vectors 1840 upon detection by the control circuit of the customer action in the data from the second sensor. The adjustment is effective to change at least one of the visualization elements being rendered to the customer. In examples, the second sensor is a camera, an RFID reader, or a scanner. Other examples are possible. In still other aspects, the adjustment is to increase the strength of a customer partiality vector or to decrease the strength of a customer partiality vector.

In some examples, the first sensor 1826 and the second sensor 1827 are the same device (e.g., the same camera). In the example of FIG. 18, they are shown as being different devices. One or both of the first sensor 1826 or second sensor 1827 may be deployed on a shopping cart 1850 (or some other apparatus or device). Additionally, some or all of the other components shown in the device 1802 can be deployed at the shopping cart 1850. Further, the device 1802 may itself be secured to the shopping cart 1850.

Various types of visualization elements are possible. For example, the visualization element may be one or more of a chart, an icon, a graphical element, a textual element, an animated element, or a color highlight. Other examples are possible.

In some examples the comparison made by the control circuit 1822 indicates at least one match between the customer partiality vectors 1840 and at least one vectorized product characteristic of the identified products 1810. In other examples, the comparison indicates that no match exists between a customer partiality vector 1840 for a selected product and the vectorized product characteristic of the selected product. Visualizations of the selected product are removed from the modified image prior to rendering the modified image to the customer 1803 on the display apparatus 1820.

In other aspects, the current location 1842 of the customer 1803 is determined by the electronic device 1802 from sensed inputs (e.g., from images from the first sensor 1826). In other examples, the current location 1842 of the customer 1803 is received from the central processing center 1806 via the transceiver circuit 1828 or from another exterior source (e.g., GPS coordinates from a GPS system).

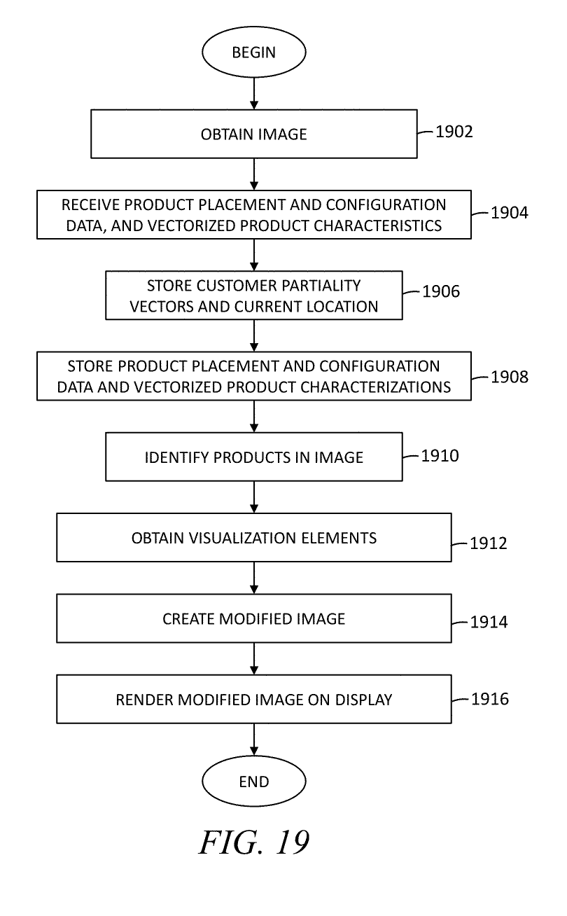

Referring now to FIG. 19, one example of an approach for rendering AR images to a customer is described. At step 1902, a sensor obtains an image of a portion of a current field of view of a customer as the customer moves through a retail store. For example, a camera obtains an image of at least a portion of a field of view being seen by a human customer.

At step 1904, a transceiver circuit receives product placement and configuration data associated with products at the retail store. For example, a planogram may be received. The transceiver circuit also receives vectorized product characteristic. Each of the vectorized product characteristics comprises an ability of a product to enable past, present, and future order associated with a product at the retail store. Each of the vectorized product characteristics is programmatically linked to a strength of the product characteristic.

At step 1906, customer partiality vectors are stored in a data storage device. Each of the customer partiality vectors comprises a customer preference that is programmatically linked to a strength of the customer preference. The customer preference is associated with a value of the customer, and the value of the customer comprises a belief or perception of the customer in a good or an advantage which results from supporting the order. The data storage device also stores a current location of the customer within the retail store. The current location may be obtained by a device such as a camera (which determines location based upon the image data). Alternatively, the current location may be received from an eternal source such as a GPS system.

At step 1908, the control circuit stores the received vectorized product placement and configuration data, and the vectorized product characteristics in the data storage device and obtains the current image from the first sensor.

At step 1910 and at the control circuit, products in the current image are identified based at least in part upon the current location of the customer and the product placement and configuration data, and the vectorized product characteristics of the identified products are obtained from the data storage device. For example, products in the image are compared to where products are shown as being situated in a planogram to identify products in the image. The current location of the customer may be used to correlate which portions of the planogram to examine.

At step 1912, based upon a comparison between selected ones of the customer partiality vectors and the vectorized product characteristics of the identified products, the control circuit selects one or more visualization elements to overlay onto the current image of the field of view. For example, various charts or icons can be created and/or displayed. In other examples, colors and color shadings can be used. For example, the same icon (e.g., a circle or star) can have different colors based upon the affinity between the customer's values and the values offered by the product. A green shading may indicate a high degree of affinity, while a red icon may indicate a lesser degree of affinity. In other examples, a bar graph may have different bars, with each bar representing a different value of the customer with a length or color of the bar indicating the degree of affinity between that value and that value as provided by the product. Other non-visual elements such as sounds may also be used.

At step 1914, the control circuit creates a modified image by incorporating the selected one or more visualization elements into the image. Approaches known to those skilled in the art are used to insert, overlay, or otherwise incorporate the visualizations into the images.

At step 1916, the control circuit renders the modified image onto the display apparatus for viewing by the customer. For example, the modified image is displayed on a screen of a smartphone.

It will be appreciated that all or some of the steps of FIG. 19 can be repeatedly performed (e.g., a predetermined time intervals) so that the modified image being displayed is current and up-to-date as the customer and device move and the field of view for the customer changes.

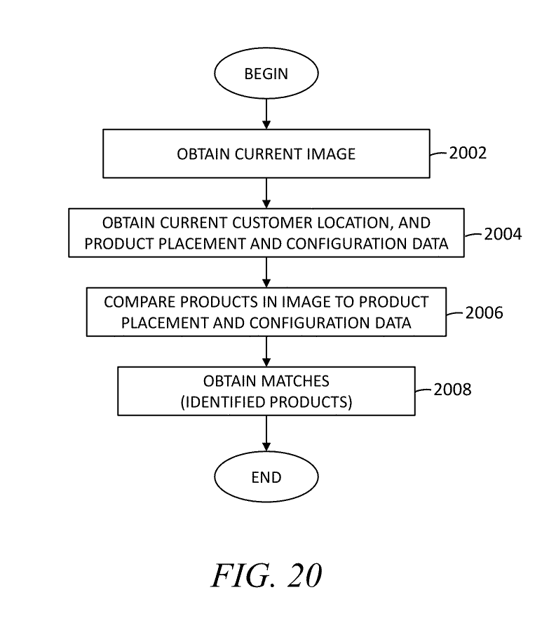

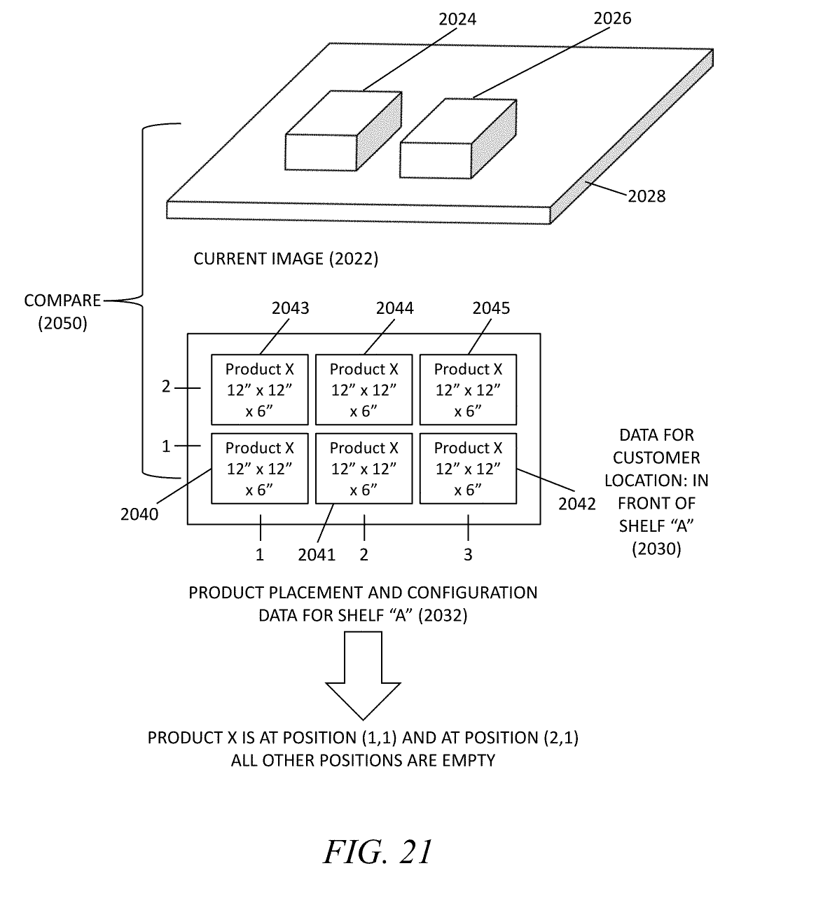

Referring now to FIGS. 20 and 21, one example of an approach that identifies products in an image is described.

At step 2002, the current image 2022 is obtained. In this example, the current image 2022 is a photographic image obtained by a camera showing a first product 2024 and a second product 2026 disposed on a shelf 2028.

At step 2004, the current position 2030 of the customer, and the product placement and configuration data 2032 are obtained. In this example, the current position 2030 indicates that the customer is in front of shelf “A.” This may be known through absolute geographic coordinates (e.g., obtained from a GPS system). Product placement and configuration data 2032 shows a map of shelf “A” with products 2040, 2041, 2042, 2043, 2044, and 2045 disposed at coordinates (1,1), (2,1), (3,1), (1,2), (2,2), and (3,2), respectively. Product placement and configuration data 2032 may be arranged as any appropriate data structure or combinations of data structures such as tables or linked lists.

At step 2006, products in the image are compared to the product placement and configuration data. In these regards, the image 2022 is compared at step 2050 to the product placement and configuration data 2032 for the current position 2030 of the customer.

At step 2008, the comparison at step 2006 identifies product matches as between what exists in the image and what is supposed to exist (from the product placement and configuration data). In this case, a conclusion 2052 indicates that Product X is at position (1,1) and at position (2,1), but not located at the other positions. The approaches may determine that products 2024 and 2026 are at these positions, while the other positions for potential products are empty.

The size, shape, color, or dimensions of the products in the image are analyzed. In this example, the size of Product X is 12 inches by 12 inches by 6 inches per data 2032. The size of products 2024 and 2026 are determined by appropriate image processing software. If these are confirmed to be within a range of Product X, the determination is that Product X is on the shelf at positions (1,1) and (2,1). Thus, vectorized product characteristics for Product X can be obtained.

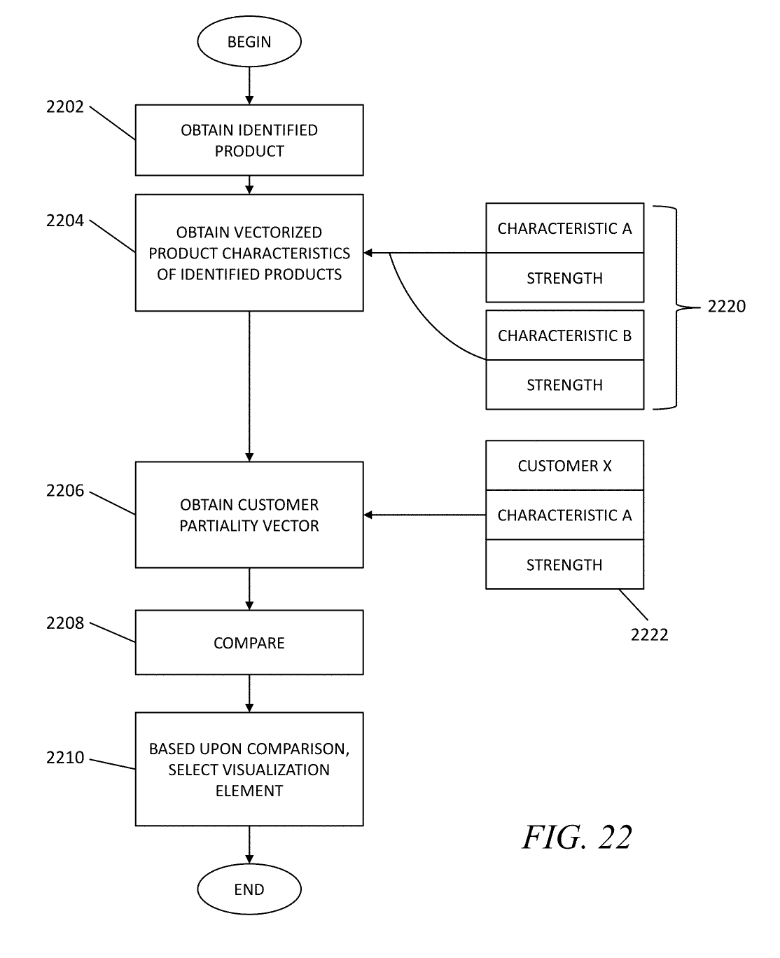

Referring now to FIG. 22, one example of an approach for selecting a visualization element is described. The visualization element may be a graph (or the bars in a graph), an icon (e.g., geometric shape, person, smiley face), color shadings, or combinations of these other elements. The visualization elements may also be animated characters. Non-visual elements such as sounds may also be used.

At step 2202, products that have been identified in a current image (e.g., obtained by the approach described in FIG. 20 and FIG. 21) are obtained.

At step 2204, the vectorized product characteristics (or more general product characteristics) of the identified products are obtained. For example, a product identified as “Product X” may have a set of vectorized product characteristics 2220 stored in memory that can be indexed by the name of the product. Each of these products may include a characteristic (e.g., Characteristic A being an ecologically sound or sourced product) and a strength (e.g., 0-10 on a scale of 0-10).

At step 2206, the customer partiality vectors 2222 for the customer are obtained. These may include the customer name (e.g., Customer X), a characteristic (Characteristic A), and a strength of the characteristic.

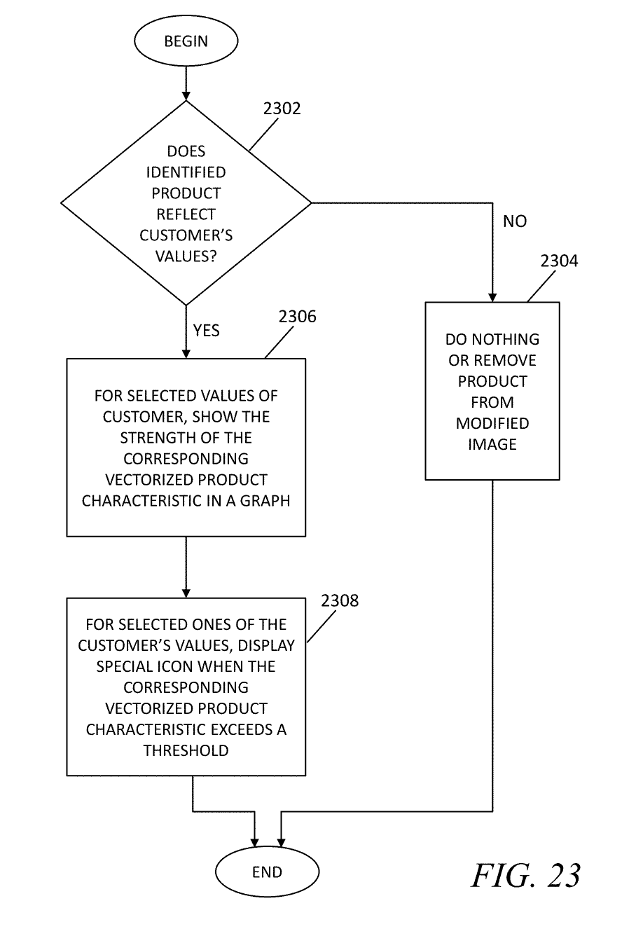

At step 2208, a comparison is made between the customer partiality vectors 2222 and the vectorized product characteristics 2220. The comparison determines values or characteristics that a customer has and a product provides. For example, a customer might value environmental sourcing and the product has a value reflecting its environmental sourcing. If there is sufficient affinity between the two, then one or more visualization elements are selected. One example of this process is described with respect to FIG. 23.

Referring now to FIG. 23, one example of an approach for determining a visualization element is described. It will be appreciated that this is one example of an approach that can be used and that are examples are possible.

At step 2302, it is determined whether the identified produce reflects a customer's values. To take one specific example and using the example of FIG. 22, if the strength of characteristic A of the customer partiality vectors 2222 (or a customer profile) is 10, the strength of Characteristic A in the vectorized product characteristics 2220 (or product characteristic information) is 10, and the tolerance is 2, then an icon is selected to display since the difference (0) is less than the tolerance. In another example, if the strength of characteristic A tin he customer partiality vectors 2222 is 1, the strength of Characteristic A in the vectorized product characteristics 2220 is 10, and the tolerance is 2, then an icon is not selected for display since the difference (9) is more than the tolerance.

If the answer at step 2302 is affirmative, execution continues at step 2306. If the answer at step 2302 is negative, execution continues at step 2304. At step 2304, either no action is taken or the product is removed (or hidden) from the modified image.

At step 2306, for selected one of the value, the strength of the value often corresponding vectorized product characteristic is displayed as a bar in a bar graph.

At step 2308, for selected ones of the customer's values, a selected icon is displayed when the corresponding vectorized product characteristic exceeds a threshold. For example, if a customer values environmental sourcing and the corresponding vectorized product characteristic exceeds a threshold (e.g., 7 on a scale of 0 to 10), then a green tree icon is displayed.

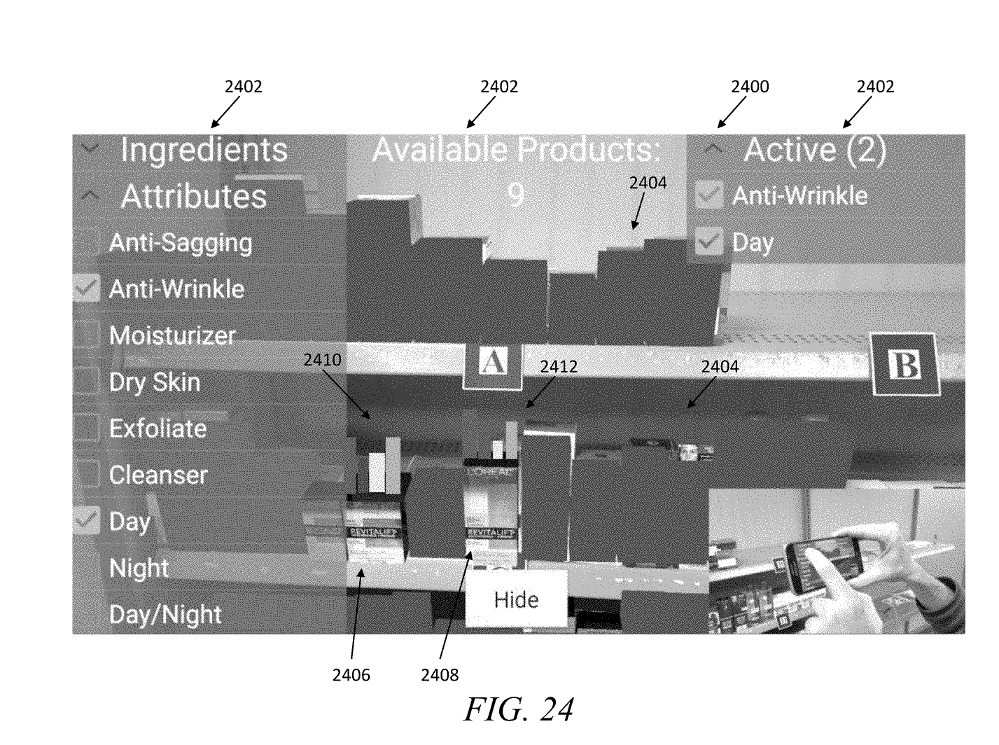

Referring now to FIG. 24, one example of a modified image that is displayed to a customer is described. The image 2400 is overlaid with attributes 2402 including attributes of ingredients in products, number of available products, and product attributes (anti-wrinkle, and day). Various products 2404 are purposely hidden. However, two products 2406 and 2408 are not hidden and have been identified as being of potential interest to the customer. The products 2406 and 2408 have corresponding graphs 2410 and 2412 displayed over the corresponding products.

The graphs 2410 and 2412 each have bars indicating a value and a strength of value provided by the corresponding product 2406 or 2408. For example, one bar may indicate the product's use of safe ingredients, another bar may indicate the price sensitivity of the product, and another bar may indicate a strength of minority-owned sourcing for the product. It will be appreciated that other visualization elements may be used. For example, various icons (e.g., icons of people or geometric shapes to mention two examples) can be displayed with the image. The size, shape, color, or other characteristics of these icons may be changed to reflect the values of the products that are of interest to the customer.

It will also be understood that the image shown in FIG. 24 will change as the view of the customer changes as the customer moves through a retail store. Additionally, the icons themselves will dynamically change in real-time as the customer performs actions. For example, the customer may pick up one of the products 2406 or 2408 and return that product to the shelf indicated no interest in the product and the values that product provides. This action causes the strength of customer partiality vectors (or other information in a customer profile) to decrease. This, in turn, may causes the displays to change as the strengths have decreased and certain products once determined to be of interest to the customer to not be selected for augmentation with the visualization elements.

Customer actions may also cause the product and/or visualization elements to be removed or blocked. For instance, if product 2406 is returned to the shelf, the values reflected by the product change, and the graph 2410 may disappear or the product 2406 may become hidden.

In other examples, an ability to drill down on the graph, icon or other visualization element to see or be provided with further details or information (e.g., such as a farm's certifications of being an organic producer, or the chain of custody to mention two examples). This provides the ability for the customer to reach out and select an augmented image to get further information. This may be accomplished or instigated, in aspects, by touching the icon on a screen. By doing so, the additional information is retrieved.

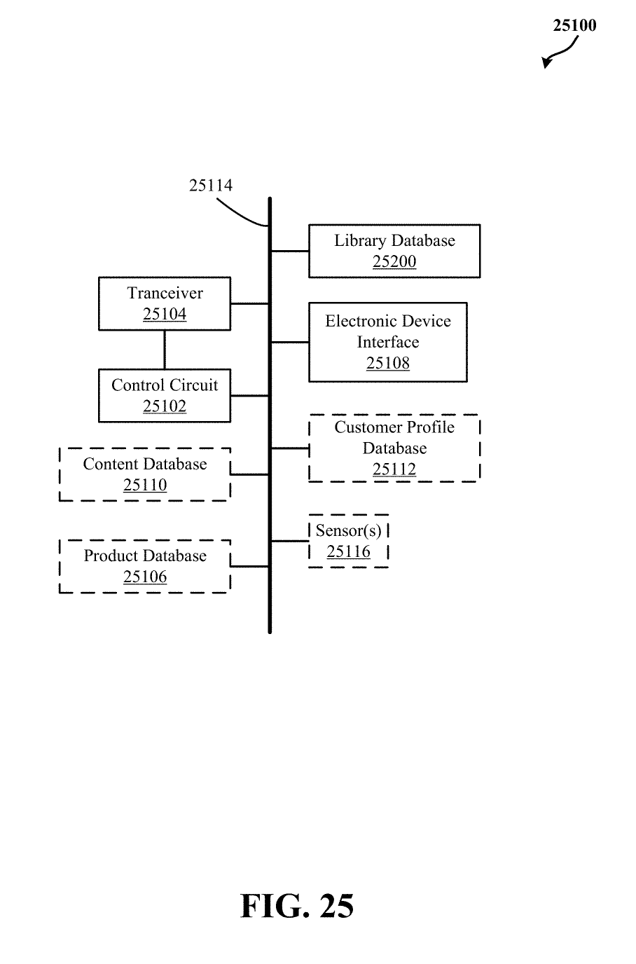

FIGS. 25 through 31 present yet further teachings in the foregoing regards wherein at least some, but not necessarily all, of the above-described considerations are further leveraged with respect to providing coaching services.

In FIG. 25, a block diagram of an exemplary coaching system 25100 that provides virtual coaching to customers on the use of a product is shown. Moreover, one or more items in the system 25100 of FIG. 25 may be further illustrated and/or described by referring to a schematic illustration of a library database 200 as shown in FIG. 2. The system 100 includes the library database 200. The library database 25200 may include libraries of product listings 25206, 25212, 25220. Each of the libraries of product listings 25206, 25212, 25220 may be associated with a particular customer of a plurality of customers 25202, 25218. By one approach, a library of the libraries of product listings 25206, 25212, 25220 may be added to the library database 25200 for each customer that enters a retail store (physical retail store and/or virtual retail store). By another approach, a customer may be identified by a control circuit 25102 based on an association of the customer's electronic device with one or more wireless access points of the retail store. By another approach, the control circuit 25102 may identify the customer based on the customer's debit and/or credit card purchases at the retail store. By yet another approach, the library may be added for each customer associated in a customer profile database 25112. Thus, the customer profile database 25112 may comprise a plurality of customer profiles associated with the plurality of customer 25202, 25218. Each customer profile may include information particular to a customer, for example, a customer's name, accounts, delivery addresses, and/or a plurality of partiality vectors, among other information that are particular to the customer.

In another configuration, the customer profile database 25112 may store the plurality of customer profiles. By one approach, each of the plurality of customer profiles may correspond to one of the plurality of customers. By another approach, each of the plurality of customer profiles may include a plurality of customer partiality vectors that may be associated with the corresponding customer. In another configuration, the control circuit 25102 may predict intentions based, at least in part, on one or more customer partiality vectors associated with a customer. By one approach, each of the plurality of customer partiality vectors may have a magnitude that corresponds to a determined magnitude of a strength of a belief by a corresponding customer in an amount of good that comes from an amount of order imposed upon material space time by a corresponding particular partiality.

In another configuration, a product may be associated with the library based on a customer's interaction with the product. As such, one or more retail products 25208, 25214, 25216, 25222, 25226, 25232 may be associated with each library of the libraries of product listings 25206, 25212, 25220. By one approach, interactions may include touching the product, looking at the product, selecting the product in the virtual retail store, searching online for the product, proximity to the product relative to other products in an area of a retail store, scanning a product identifier of the product, and/or verbal cues or utterance of the product's name and/or particular characteristics of the product, among other type of interactions that a customer may do towards a product.

In another configuration, the system 25100 may include the control circuit 25102. The control circuit 25102 may be communicatively coupled to the library database 25200 and the customer profile database 25112 over one or more communication and/or computer networks 114, which may be implemented through one or more local area networks (LAN), wide area networks (WAN), Internet, cellular, other such networks, or a combination of two or more of such networks. By one approach, the control circuit 25102 may access one or more libraries in the library database 25200. By another approach, the control circuit 25102 may add, create, and/or associate the library to the library database 25200. In one configuration, the control circuit 25102 may predict one or more intentions of the first customer 25202 when the first customer 25202 is at a retail store. The first customer 25202 may have a customer profile in the customer profile database 25112. By one approach, the control circuit 25102 may predict intentions based on the first customer's 25202 interaction with one or more products in the retail store.

In an illustrative, non-limiting example, sensor(s) 25116 may be distributed throughout the retail store to capture one or more of a plurality of different types of information and/or data streams (e.g., video stream, among other possible data streams). The sensor(s) 25116 may comprise cameras, video processing systems, RFID tag readers, optical code scanners, an acoustic sensor, a vibration sensor, a flow sensor, a speed sensor, a pressure sensor, a position sensor, an angle sensor, a displacement sensor, a distance sensor, accelerometer, among other types of sensors that may be implemented to capture various types of data streams. In some instances, a customer's personal mobile electronic device can be utilized as a sensor to provide information to the control circuit 25102 (e.g., image and/or video data streams, text recognition data, acoustic data stream, etc.) By another approach, the control circuit 25102 may determine from a particular plurality of data streams associated with the first customer 26202 that the first customer 26202 placed a voltmeter (e.g., product B 26214) and a power outlet (e.g., product C 26216) in a shopping cart. Based, at least in part, on the particular plurality of data streams, the control circuit 25102 may predict that the first customer 26202 intends to replace a power outlet. By another approach, the prediction of the control circuit 25102 may be based, at least in part, on the voltmeter and the power outlet. Thus, the control circuit 102 may determine a how-to-use data corresponding to replacing a power outlet (e.g., how-to-use data B 26204).

In another configuration, the control circuit 25102 may determine at least one product associated with intentions of the first customer 26202. For example, the control circuit 26102 may determine that wire caps (e.g., product F 26232) are products that the customer may need, have interest in, and/or may be useful to the first customer 26202 while replacing the power outlet. In one scenario, a determination of a product (e.g., product F 26232) may be based, at least in part, on products (e.g., product B 26214 and product C 26216) that were used to determine the first customer's 26202 intention. Moreover, the control circuit 25102 may provide a first how-to-use data (e.g., how-to-use data F 26234) associated with the determined product to the first customer 26202 subsequent to a determination of the product (e.g., product F 26232) by the control circuit 25102. In another configuration, a second how-to-use data may be associated with the determined product. For example, the second how-to-use data may correspond to how-to-use various types and sizes of wire caps. In another configuration, the product B 26214, the product C 26216, and/or the product F 26232 may be associated with the library B 26212. By one approach, the library B 26212 may have been created, added, and/or associated with the first customer 26202 at a time distinct from a time the library A 26206 was created, added, and/or associated with the first customer 26202. By another approach, the first how-to-use data associated with the product may be provided to the first customer 26202 via at least one wired and/or wireless transceiver 25104. In one configuration, the transceiver 25104 may be coupled to the control circuit 25102.

Moreover, the transceiver 25104 may communicatively interface with at least one device associated with the first customer 26202. For example, the device may comprise a computer, a smartphone, a smartwatch, a kiosk of a retail store, and/or a display device, among other systems of displaying, playing back and/or otherwise providing access to a message, how-to-use data, and/or other such information. By one approach, the first how-to-use data may be provided at a time when the first customer 26202 is at the retail store. By another approach, the first how-to-use data may be provided at a time when the first customer 26202 is at another place other than the retail store (e.g., customer's house, work, etc.).

In another configuration, the control circuit 25102 may determine over a period of time one or more second products associated with intentions of a customer while the customer is at a retail store. By one approach, the control circuit 25102 may also re-predict the intentions of the customer based, at least in part, on a recently determined second product and a previously determined first product over the period of time. By another approach, the control circuit 25102 may provide a second how-to-use data based on the re-predicted intentions. The control circuit 25102 may also update the library with a second product identifier of the second product; and associate the second product identifier with the second how-to-use data in the library. For example, as the customer strolls through the retail store, the control circuit 25102 may periodically, at a predetermined interval of time over a period of time, determine another product that may be associated with the predicted intentions of the customer. Further, the control circuit 25102 may also periodically re-predict the customer's intention over the period of time based, at least in part, on the products the control circuit 25102 had determined. By one approach, the control circuit 25102 may attempt to initially re-predict the customer's intention each time the customer enters a retail store. By another approach, when the control circuit 25102 determines that no level of similarities can be determined based on comparison of keywords associated with products associated with previous predictions and with products the customer has currently interacted, the control circuit 25102 may, subsequently, perform an initial prediction of the customer's intention based on the currently interacted products. In another configuration, the control circuit 25102 may provide a how-to-use data based, at least in part, on the re-predicted intentions. Moreover, by one approach, the control circuit 25102 may update the library with product identifiers of the determined products and associate the product identifiers with a link associated with the how-to-use data in the library.

In another configuration, the control circuit 25102 may associate a how-to-use data to each of predicted intended uses of a customer. By one approach, the control circuit 25102 may send a message to a device associated with the customer. The message may include a listing of predicted intended uses and links to corresponding how-to-use data. In one example, the message may correspond to a request for a selection of how-to-use data by the customer. As such, the control circuit 25102 may provide a selected how-to-use data to the device associated with the customer based, at least in part, on the selection of the customer from the listing.

In one configuration, the control circuit 25102 may create a library A 26206 in the library database 25200. The control circuit 25102 may associate the library A 26206 with a product identifier of the product A 26208. In the library A 26206, the product identifier may be associated with how-to-use data A 26210. In one example, the library A 26206 may be associated with the first customer 26202. To illustrate, continuing from the example described above, prior to shopping for the voltmeter and the power outlet, the first customer 26202 may have visited a retail store at a first time. At the first time, the first customer 26202 may have bought a knife sharpener (e.g., product A 26208). In one configuration, upon checking the library database 25200 for a library associated with the first customer 26202, the control circuit 25102 may determine that there is not a library associated with the first customer 26202. As such, the control circuit 25102 may add the library A 26206 to the library database 25200 and associate the knife sharpener (e.g., product A 26208) to the library A 26206.

In another configuration, the control circuit 25102 may determine that the first customer 26202 has a high affinity for buying premium knives based, at least in part, on a plurality of partiality vectors associated with a customer profile of the first customer 26202 in the customer profile database 25112. Thus, based on the determination of the customer's high affinity for premium knives, the control circuit 25102 may predict that the first customer's 26202 intention in visiting the retail store at the first time is to purchase a knife sharpener and/or a premium knife. As such, the control circuit 25102 may access a content database 25110 to determine a how-to-use data that is associated with the customer's high affinity for premium knives and/or the prediction that the customer's intention is to purchase the knife sharpener. In one example, the content database 25110 may include a plurality of different how-to-use data corresponding to numerous different products, with one or more corresponding to one or more knife sharpeners.

In another configuration, a plurality of how-to-use data may be associated with a plurality of products of a product database 25106. By one approach, the plurality of products in the product database 25106 may include products that are associated with a retail store and/or products sold at the retail store. In another configuration, the control circuit 25102 may be operably coupled to the library database 25200, the customer profile database 25112, the content database 25110, and the product database 25106 via a network 25114. In addition, the sensor(s) 25116 may also be operably coupled to the control circuit 25104 via the network 25114. By another approach, the control circuit 25102 may be operably coupled to the network 25114 through the transceiver 25104.

In another illustrative non-limiting example, the library C 26220 of the library database 25200 may be associated with the second customer 26218. In one example, the library C 26220 may be associated with a tomato (e.g., product D 26222), a whole chicken (e.g., product E 26226), and the knife sharpener (e.g., product A 26208). While strolling through the retail store, the second customer 26218 may have uttered chicken and tomatoes while reading a recipe. One of the sensor(s) 25116 may have captured sound produced by the second customer 26218 while uttering the chicken and tomatoes (example of verbal cues). Additionally or alternatively, the customer profile may include the recipe and/or a shopping list, which may be been updated by the customer, accessed by the customer thorough another system associated with the retail store and/or coaching system 25100, or otherwise provided to the coaching system. Based, at least in part, on the captured sound, the control circuit 25102 may predict that the second customer's 26218 intention is to shop for ingredients of a recipe. By another approach, intentions may also be predicted based, at least in part, on a physical movement of a customer while viewing one or more products and/or selecting one or more representations of products on a device, scanning a product identifier of a product. Based, at least in part, on the predicted intentions and/or the captured sound, the control circuit may determine association of and/or associate the whole chicken and the tomato with the library C 26220. By one approach, the control circuit 25102 may provide a first how-to-use data that may correspond to a cooking instruction of a recipe, where at least a whole chicken and a tomato are two of the ingredients in the recipe.

In one configuration, the control circuit 25102 may determine that a knife sharpener (e.g., product A 26208) is tangentially related to the whole chicken (e.g., product E 26226) and the tomato (e.g., product D 26222). By one approach, the control circuit 25102 may determine a second how-to-use data (e.g., how-to-use data E 26230) based, at least in part, on a predicted intended use of the whole chicken, the tomato, and/or the knife sharpener by the second customer 26218. By another approach, the control circuit 25102 may determine a third how-to-use data (e.g., how-to-use data A 26210) based, at least in part, on the knife sharpener. By another approach, the control circuit 25102 may determine a fourth how-to-use data (e.g., how-to-use data C 26224) based, at least in part, on the tomato. In yet another approach, the control circuit 25102 may determine a fifth how-to-use data (e.g., how-to-use data D 26228) based, at least in part, on the whole chicken.

In another configuration, in response to determining the second how-to-use data, the control circuit 25102 may provide the second how-to-use data to the second customer 26218 via the transceiver 25104. In another configuration, the library C 26220 may be updated with a second product identifier of the knife sharpener (e.g., product A 26208). By one approach, the second product identifier of the knife sharpener may be associated with the second how-to-use data (e.g., how-to-use data E 26230) and/or the third how-to-use data (e.g., how-to-use data A 26210).

By another approach, the second how-to-use data may be provided to the second customer 26218 at a time when the second customer 26218 is at the retail store. By another approach, the second customer 26218 may request to the control circuit 25102 through an electronic device interface 25108 to provide the first how-to-use data at a time when the second customer 26218 is no longer at the retail store, for example, when he/she is at home. In response, the control circuit 25102 may access the library C 26220 of the library database 25200 to provide the first how-to-use data to the second customer 26218. By another approach, the second how-to-use data may also be provided to the second customer 26218 at another time the second customer 26218 is no longer at the retail store. By another approach, the second customer 26218 may send first and second requests to the control circuit 25102 through a customer specified setting of the electronic device interface 25108 when the second customer 26218 is at the retail store such that the second customer 26218 indicate via the customer specified setting when to send the first and second request.

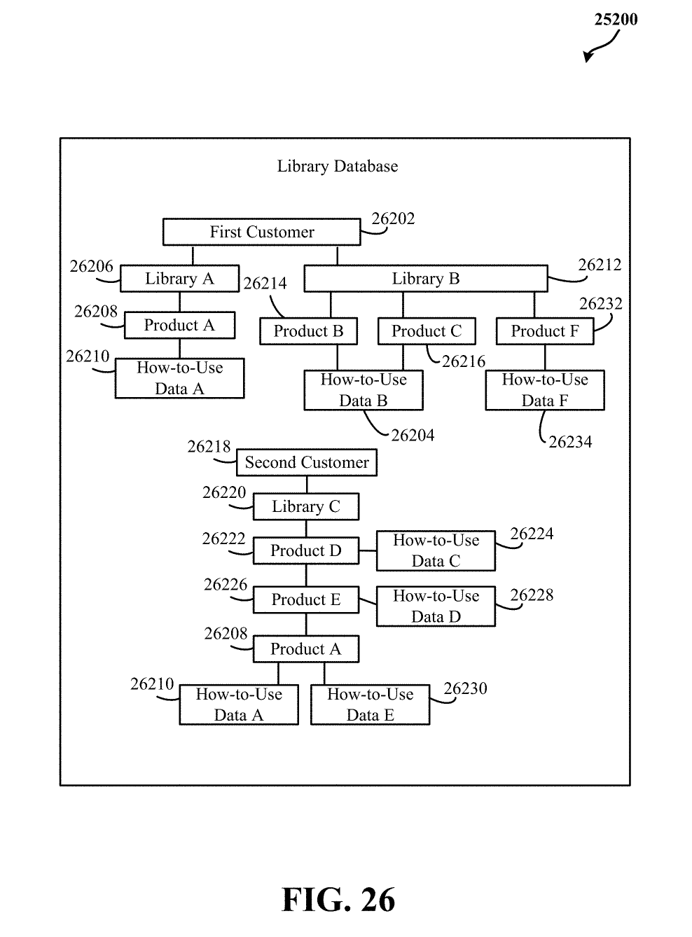

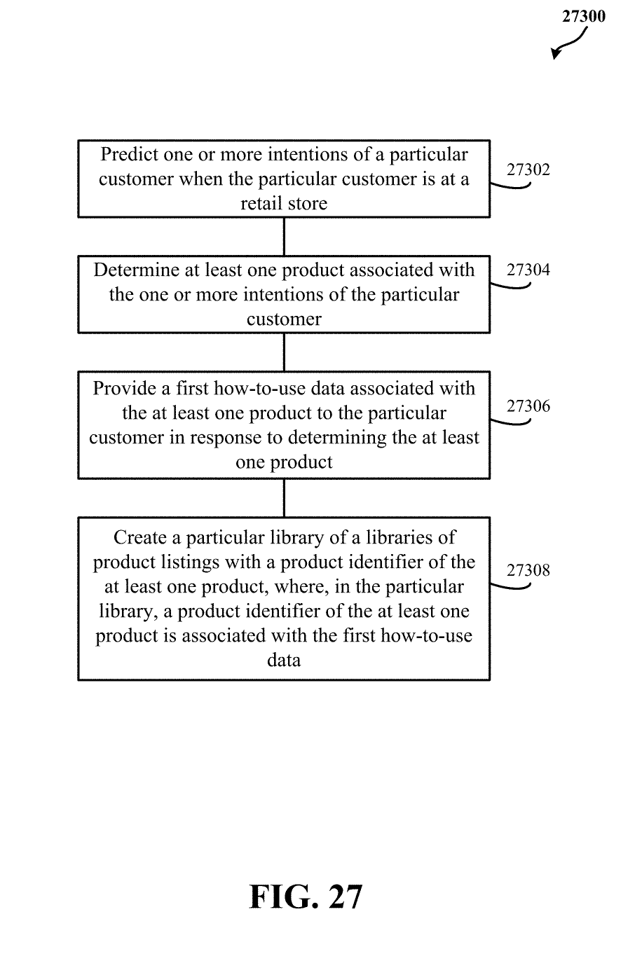

FIG. 27 shows an exemplary flow diagram of a method 27300 for virtual coaching on use of a product. By one approach, the method 27300 may be implemented in the control circuit 25102 of FIG. 25. By another approach, one or more steps in the method 27300 may be implemented in the library database 25200 of FIGS. 25 and 26. The method 27300 includes predicting one or more intentions of a particular customer when the particular customer is at a retail store, at step 27302. The method 27300 may include, at step 27304, determining at least one product associated with the one or more intentions of the particular customer. In one configuration, the method 27300 may include providing a first how-to-use data associated with the at least one product to the particular customer in response to the control circuit 25102 determining the at least one product, at step 27306. By one approach, the first how-to-use data associated with the at least one product may be provided to the particular customer via at least one transceiver at a time when the particular customer is at the retail store. In one example, the at least one transceiver may correspond to the transceiver 25104 of FIG. 25. In another configuration, the method 27300 may include creating a particular library of the libraries of product listings with a product identifier of the at least one product, at step 27308. In the particular library, the product identifier of the at least one product may be associated with the first how-to-use data. By one approach, the particular library may also be associated with the particular customer.

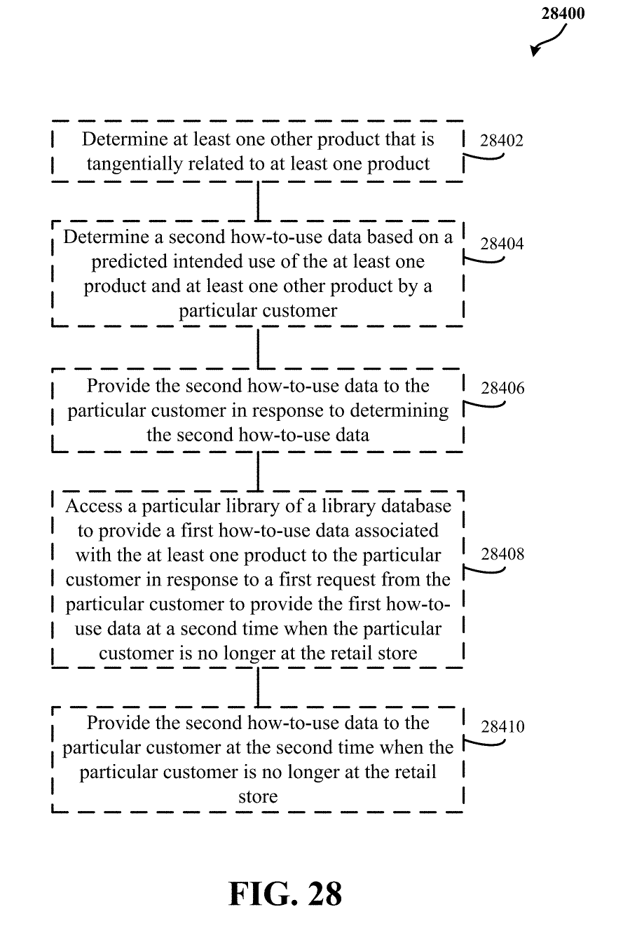

FIG. 28 shows an exemplary flow diagram of a method 28400 for virtual coaching on use of a product. By one approach, the exemplary method 28400 may be implemented in the control circuit 25102 of FIG. 25. By another approach, the method 28400 and/or one or more steps of the method may optionally be included in and/or performed in cooperation with the method 27300 of FIG. 27. The method 28400 may include determining at least one other product that is tangentially related to the at least one product, at step 28402. In one configuration, the method 28400 may include providing the second how-to-use data to the particular customer, at step 28406. By one approach, the second how-to-use data may be provided via at least one transceiver in response to determining the second how-to-use data. By another approach, the second how-to-use data may be provided to the particular customer at the time when the particular customer is at the retail store.

In another configuration, the method 28400 may include accessing the particular library of the library database to provide the first how-to-use data associated with the at least one product to the particular customer in response to a first request from the particular customer to provide the first how-to-use data at a second time when the particular customer is no longer at the retail store, at step 28408. In one example, the library database may correspond to the library database 25200 of FIGS. 25 and 26.

In another configuration, the method 28400 may also include, at step 28410, providing a second how-to-use data to the particular customer at the second time when the particular customer is no longer at the retail store. By one approach, the second how-to-use data may be associated with at least one other product that is tangentially related to the at least one product. By another approach, providing the second how-to-use data may be in response to a second request from the particular customer. In yet another approach, first and second requests may be sent by the particular customer when the particular customer is at the retail store. By one approach, the first and second requests may made through a customer specified setting. In one configuration, one of the customer specified setting may include when to send the first and second request. By another approach, links to first and second how-to-use data may be provided to the particular customer based on the customer specified setting.

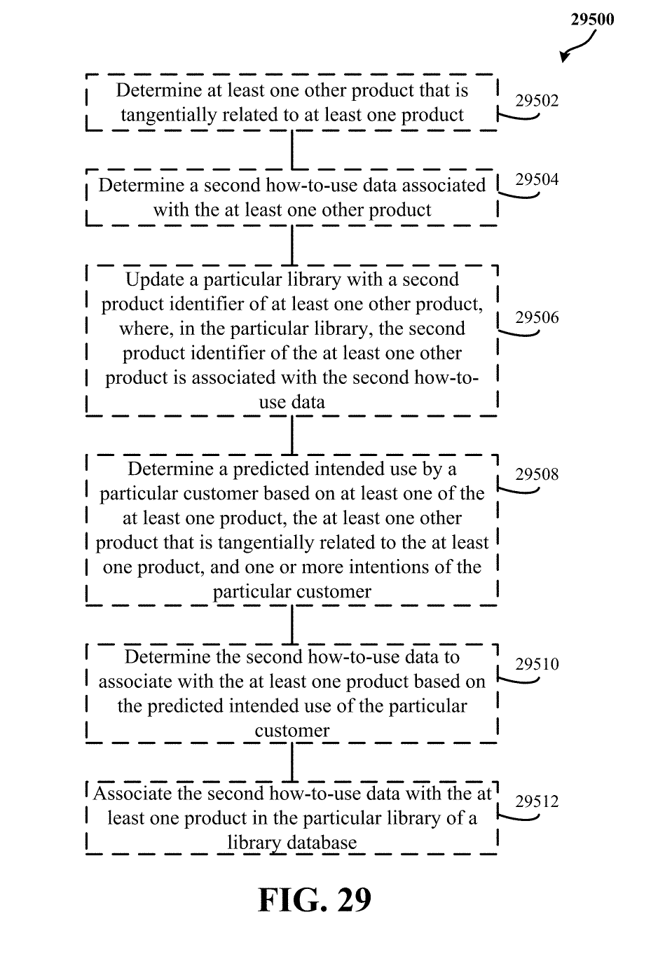

FIG. 29 shows an exemplary flow diagram of a method 29500 for virtual coaching on use of a product. By one approach, the exemplary method 29500 may be implemented in the control circuit 25102 of FIG. 25. By another approach, the method 29500 and/or one or more steps of the method may optionally be included in and/or performed in cooperation with the method 27300 of FIG. 27 and/or the method 28400 of FIG. 28. The method 29500 may include determining at least one other product that is tangentially related to the at least one product, at step 29502. The method 29500 may also include determining a second how-to-use data associated with the at least one other product, at step 29504. By one approach, the method 29500 may include, at step 29506, updating the particular library with a second product identifier of the at least one other product, where, in the particular library, the second product identifier of the at least one other product is associated with the second how-to-use data.

In one configuration, the method 29500 may include determining a predicted intended use by the particular customer based on at least one of the at least one product, at least one other product that is tangentially related to the at least one product, and the one or more intentions of the particular customer, at step 29508. The method 29500 may also include determining a second how-to-use data of a content database to associate with the at least one product based on the predicted intended use of the particular customer, at step 29510. In one example, the content database may correspond to the content database 25110 of FIG. 25. In another configuration, the method 29500 may include associating the second how-to-use data with the at least one product in the particular library of the library database, at step 29512. By one approach, the content database may store a plurality of how-to-use data associated with a plurality of products.

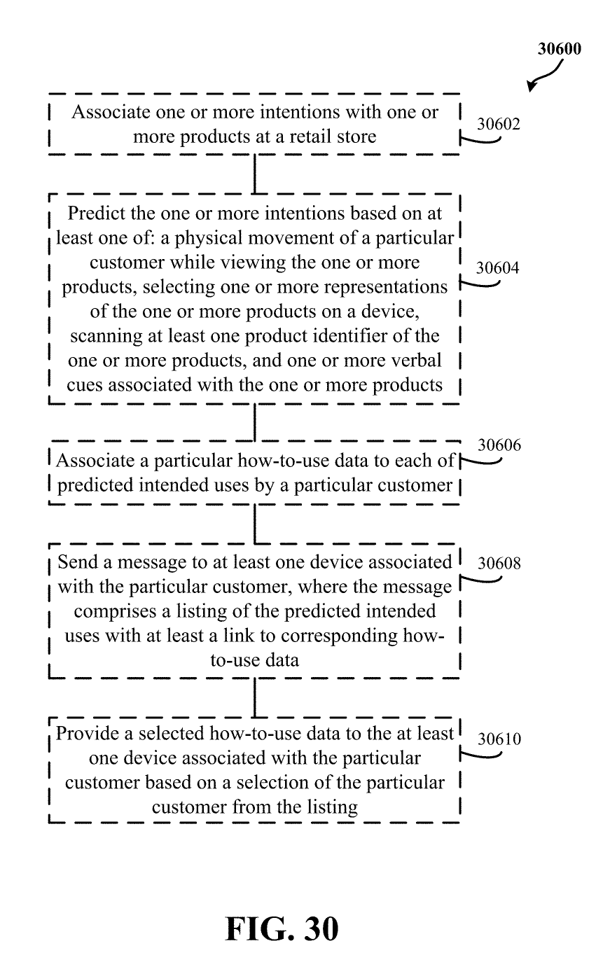

FIG. 30 shows an exemplary flow diagram of a method 30600 for virtual coaching on use of a product. By one approach, the exemplary method 30600 may be implemented in the control circuit 25102 of FIG. 25. By another approach, the method 30600 and/or one or more steps of the method may optionally be included in and/or performed in cooperation with the method 27300 of FIG. 27, the method 28400 of FIG. 28, and/or the method 29500 of FIG. 29. The method 30600 may include, at step 30602, associating the one or more intentions with one or more products at the retail store. The method 600 may also include predicting the one or more intentions based on at least one of: a physical movement of the particular customer while viewing the one or more products, selecting one or more representations of the one or more products on a device, scanning at least one product identifier of the one or more products, and one or more verbal cues associated with the one or more products, at step 30604.

By one approach, the one or more intentions may correspond to predicted intended uses by the particular customer. By another approach, predicting the one or more intentions may further be based on at least customer partiality vectors associated with the particular customer. Each of the customer partiality vectors may have a magnitude that corresponds to a determined magnitude of a strength of a belief by the particular customer in an amount of good that comes from an amount of order imposed upon material space time by a corresponding particular partiality. In another configuration, the method 30600 may include associating a particular how-to-use data to each of the predicted intended uses by the particular customer, at step 30606. In another configuration, the method 30600 may also include sending a message to the at least one device associated with the particular customer, at step 30608. By one approach, the message may include a listing of the predicted intended uses with at least a link to corresponding how-to-use data. In another configuration, the method 30600 may include providing a selected how-to-use data to the at least one device associated with the particular customer based on a selection of the particular customer from the listing, at step 30610.

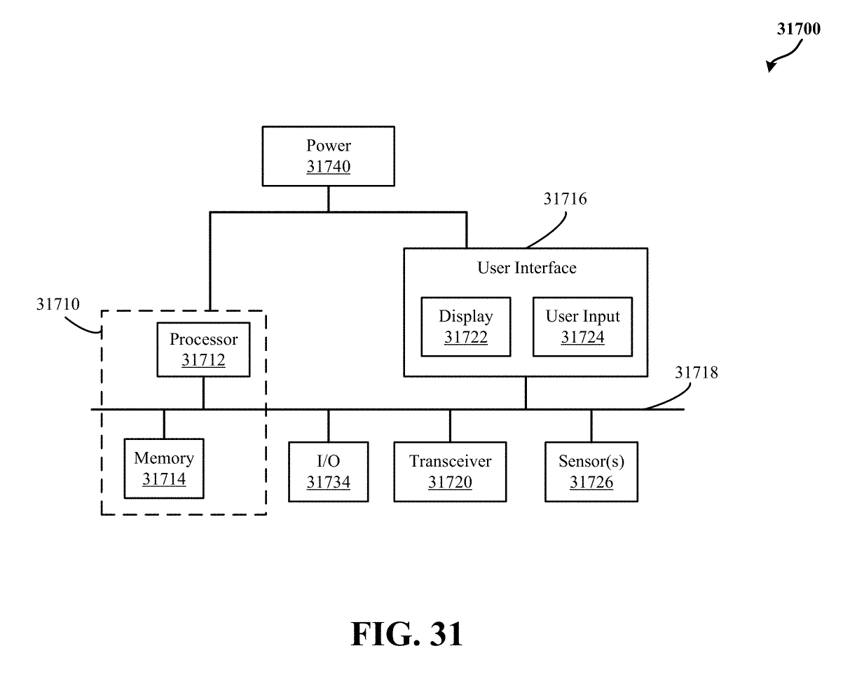

Further, the circuits, circuitry, systems, devices, processes, methods, techniques, functionality, services, servers, sources and the like described herein may be utilized, implemented and/or run on many different types of devices and/or systems. FIG. 31 illustrates an exemplary system 31700 that may be used for implementing any of the components, circuits, circuitry, systems, functionality, apparatuses, processes, or devices of the system 25100 of FIG. 25, the library database 25200 of FIG. 26, the method 27300 of FIG. 27, the method 28400 of FIG. 28, the method 29500 of FIG. 29, the method 30600 of FIG. 30, and/or other above or below mentioned systems or devices, or parts of such circuits, circuitry, functionality, systems, apparatuses, processes, or devices. For example, the system 31700 may be used to implement some or all of the system for virtual coaching on use of a product at system 25100, the control circuit 25102, the library database 252200, the electronic device interface 25108, the content database 25110, the product database 252106, the customer profile database 25112, the transceiver 25104, the sensor(s) 25116, and/or other such components, circuitry, functionality and/or devices. However, the use of the system 31700 or any portion thereof is certainly not required.

By way of example, the system 31700 may comprise a processor module (or a control circuit) 31712, memory 31714, and one or more communication links, paths, buses or the like 31718. Some embodiments may include one or more user interfaces 31716, and/or one or more internal and/or external power sources or supplies 31740. The control circuit 31712 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 31712 can be part of control circuitry and/or a control system 31710, which may be implemented through one or more processors with access to one or more memory 31714 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 31700 may be used to implement one or more of the above or below, or parts of, components, circuits, systems, processes and the like. For example, the system 31700 may implement the system for virtual coaching on use of a product 25100 with the control circuit 25102 being the control circuit 31712.

The user interface 31716 can allow a user to interact with the system 31700 and receive information through the system. In some instances, the user interface 31716 includes a display 31722 and/or one or more user inputs 31724, such as buttons, touch screen, track ball, keyboard, mouse, etc., which can be part of or wired or wirelessly coupled with the system 31700. Typically, the system 31700 further includes one or more communication interfaces, ports, transceivers 31720 and the like allowing the system 31700 to communicate over a communication bus, a distributed computer and/or communication network (e.g., a local area network (LAN), the Internet, wide area network (WAN), etc.), communication link 31718, other networks or communication channels with other devices and/or other such communications or combination of two or more of such communication methods. Further the transceiver 31720 can be configured for wired, wireless, optical, fiber optical cable, satellite, or other such communication configurations or combinations of two or more of such communications. Some embodiments include one or more input/output (I/O) interface 31734 that allow one or more devices to couple with the system 31700. The I/O interface can be substantially any relevant port or combinations of ports, such as but not limited to USB, Ethernet, or other such ports. The I/O interface 31734 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 31726 to provide information to the system and/or sensor information that is communicated to another component, such as the central control system, a portable retail container, a vehicle associated with the portable retail container, etc. The sensors can include substantially any relevant sensor, such as temperature sensors, distance measurement sensors (e.g., optical units, sound/ultrasound units, etc.), optical based scanning sensors to sense and read optical patterns (e.g., bar codes), radio frequency identification (RFID) tag reader sensors capable of reading RFID tags in proximity to the sensor, and other such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 31700 comprises an example of a control and/or processor-based system with the control circuit 712. Again, the control circuit 31712 can be implemented through one or more processors, controllers, central processing units, logic, software and the like. Further, in some implementations the control circuit 31712 may provide multiprocessor functionality.

The memory 31714, which can be accessed by the control circuit 31712, typically includes one or more processor readable and/or computer readable media accessed by at least the control circuit 31712, and can include volatile and/or nonvolatile media, such as RAM, ROM, EEPROM, flash memory and/or other memory technology. Further, the memory 31714 is shown as internal to the control system 31710; however, the memory 31714 can be internal, external or a combination of internal and external memory. Similarly, some or all of the memory 31714 can be internal, external or a combination of internal and external memory of the control circuit 31712. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network. The memory 31714 can store code, software, executables, scripts, data, content, lists, programming, programs, log or history data, user information, customer information, product information, and the like. While FIG. 31 illustrates the various components being coupled together via a bus, it is understood that the various components may actually be coupled to the control circuit and/or one or more other components directly.

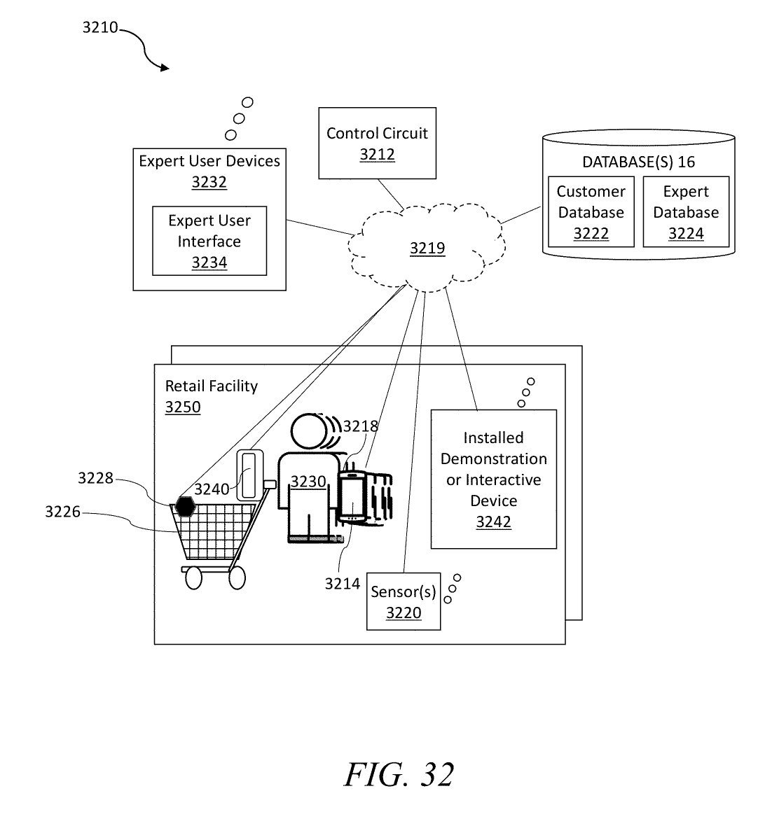

FIGS. 32 through 35 present yet further teachings in the foregoing regards wherein at least some, but not necessarily all, of the above-described considerations are further leveraged with respect to facilitating the provision of assistance to in-store shoppers.

As noted above, these teachings can be used to facilitate the provision of customer service or support to in-store shoppers (with personal electronic user devices or store electronic user devices, such as shopping cart-mounted electronic devices) by crowd-sourced experts. As noted above, the system identifies in-store shopper or customers likely in need of support or service to proactively offer such assistance. To that end, customer behavior may be monitored or sensed by a variety of hardware, such as, for example, the electronic device of the in-store shopper, sensor(s) disposed around the retail facility, and/or the shopping cart. To ensure quality service or support and/or a good fit between the in-store shopper and a particular crowd-sourced expert matched with or chosen to assist the in-store shopper, the system may evaluate, for example, the retail facility location where the support or assistance appears needed, the type of behavior indicating a customer service need or assistance, expert ratings, and/or similarities between the in-store shopper and the expert, such as the value vectors, affinities, preferences, and the like discussed above. For example, by one approach, the partiality vectors contained in a customer profile of an in-store shopper may be analyzed and compared to the partiality vectors contained in an expert profile of a crowd-sourced expert to locate or match the in-store shopper with a crowd-sourced expert having aligned (at least to some degree) partiality vectors. The selection of an appropriate crowd-sourced expert may be facilitated in a manner similar to the selection of products with product characterization vectors and particular customers described above. For example, the control circuit may analyze expert characterization vector(s) and compare them with partiality vector(s) of the customer to determine how well aligned the two individuals are, which may help ensure that the advice given to the in-store shopper will be useful and well received. In some configurations, if a crowd-sourced expert having well aligned value or partiality vectors is not available to provide customer service, the control circuit may focus the search for a suitable crowd-sourced expert based on, for example, the location of the in-store shopper within the retail facility or the items in the shopper's cart.

In one illustrative approach, FIG. 32 illustrates a shopping system 3210 facilitating customer service or support via crowd-sourced experts that includes a control circuit 3212, electronic user device(s) 3218 for users 3230 or in-store shoppers having a user interface 3214 operating thereon through which the system 3210 presents crowd-sourced customer support, and one or more databases 3216, such as a customer database 3222 and an expert database 3224. By one approach, the customer database 3222 includes customer profiles with customer value vectors associated therewith and historical shopping behaviors, and other information regarding the customer as discussed herein. In another aspect, the expert database 3224 of crowd-sourced experts includes profiles of experts with expert value vectors associated therewith (similar to the customer information discussed above that is tracked and quantified). Indeed, some crowd-sourced experts may be previous customers and their expert profile may be similar to that of the customer profiles.

As shown in FIG. 32, the control circuit is in communication with the databases 3216, the electronic user devices 3218, and one or more sensors 3220 (as described below), either through the network 3219 or directly. By one approach, the control circuit 3212 (along with devices, such as the sensor(s) 3220 or electronic user devices 3218, in the retail facility 3250) is configured to monitor customer behavior including customer location of the in-store shopper or user 3230 during the customer's shopping trip through the retail facility, determine whether the customer behavior of the particular user 3230 indicates a customer service need, (after determining such a custom service need exists) match a crowd-sourced expert to the particular user 3230 in need of the customer service based, in part, on the customer value vectors, the expert value vectors of particular crowd-sourced experts, and a location of the particular user in the physical retail facility, and present a crowd-sourced customer service or support opportunity to the particular user 3230 based on the customer behavior (and the matched expert).

By one approach, the system 3210 includes one or more sensors 3220 that sense customer activities or monitor customer behaviors, such as, for example, location, dwell time, pathway through the store etc. The sensors may include, for example, motion sensors, sound sensors, optical sensors, location sensors, in communication with the control circuit 3212. In one illustrative approach, the sensors 3220 include sound sensors that can pick up the sound in aisles of the retail facility such that the sound sensors or microphones can detect a customer speaking, sighing or other sounds of trouble. Further, this may be correlated with information from other sensors to match the sighing customer with their location and customer profile so that the control circuit 3212 may match and assign a crowd-sourced expert to assist them with their shopping. As used herein, the in-store sensors 3220 can include shopper specific sensors such as the sensors associated with the cart 3226 or electronic user devices 3218 that help monitor shopper location and installed sensors (such as those laid out in a grid) to monitor sections of the store.

As suggested above, matching a crowd-sourced expert with an in-store shopper or particular user 3230 in need of assistance may include comparing the customer profile of the particular user 3230 in the customer database 3222 with one or more expert profiles in the expert database 3224. This can be facilitate using the value vector analysis described above. Further, before matching a crowd-sourced expert, the control circuit 3212 also may review expert availability, areas or topics of expertise, expert ratings, and/or communication methods available to the expert (i.e., if a customer prefers verbal communication, then the expert matched with the particular customer should have audio capabilities associated with the expert user device 3232), among other factors.

The control circuit 3212, in some configurations, multi-casts the customer service need, customer profile information, and/or a portion thereof to available crowd-sourced experts to provide them an opportunity to provide the support services. Before multi-casting the expert support opportunity, the control circuit 3212 may match the in-store shopper or user 3230 with crowd-sourced experts having a certain profile alignment, affinity and/or expertise in an area needed by the user 3230. For example, the control circuit 3212 may identify ten crowd-sourced experts having a profile well aligned or well matched with the in-store shopper or user 30 (i.e., the profiles have similar value vector profiles), the control circuit 3212 may determine if these ten crowd-sourced experts have expertise in the area in which the in-store shopper is shopping. If eight of the ten well-aligned crowd-sourced experts have expertise in the area of interest, these eight experts may be sent an opportunity to provide help to the in-store shopper, such as, for example, via a multi-cast arrangement. At that time, the crowd-sourced experts may have the opportunity to accept or be assigned the task of assisting the in-store shopper or user 30 in need of customer support or assistance.

Once a crowd-sourced expert has been matched with the in-store shopper or user 3230 and been assigned the task of assisting the in-store shopper or user 3230, the system 3212 facilitates the interaction between the individuals. By one approach, the user interface 3214 on the electronic user device 3218 of the electronic device facilitates the interaction, such as, for example, by presenting an opportunity to receive customer service or support (though as described below, at least some of the customer service may be provided by other devices at the retail facility 3250 besides the electronic user devices that are mobile). The interaction is further facilitated via an expert user interface 3234 configured to operate on the expert user device 3232. As used herein, one or both of the in-store shopper user interface 3214 or the expert user interface 3234 may be provided to the electronic user devices 3218, 3232 by the control circuit 3212 or may be configured to be executed by the electronic user devices 3218, 3232 when in communication with the control circuit 3212.

In some embodiments, this facilitated interaction generally occurs by having the system 3210 prompt the in-store shopper or user 3230 regarding the availability of the customer support service via the user interface 3214 on the electronic user device 3218 of the particular user. In this manner, the crowd-sourced customer support service is presented proactively or offered to the in-store shopper or user 3230 without requiring inquiry from the individual shopper. The expert typically provides the assistance, in part, via the expert user interface 3234 on their associated expert user device 3232. The customer service or support may include a product suggestion, product advice, and/or product information, among other details. For example, the crowd-sourced expert may provide assistance with the customer's shopping decisions or needs in real-time while the in-store shopper is in the store by providing information, such as, for example, product reviews, capabilities, recommendations (such as the suggestion to choose one brand over another), suitability, other product information, and/or product availability, among other information. Further, this assistance is tailored to the particular in-store shopper such that, for example, the crowd-sourced expert may recommend one brand or product over another if the in-store shopper is concerned about a particular issue, such as, for example, product ingredients or sustainability. By way of a simple example, if an in-store shopper is pregnant and wishes to avoid personal care products with certain ingredients, the well-aligned crowd-sourced expert, being familiar with such products, may be able to quickly identify products of interest to the in-store shopper without the shopper needing to examine ingredients lists for numerous products in the store aisle. Further, this information is typically provided in real-time, while the customer is in the store aisle.

In some configurations, the system 3210 also may sense the products or items placed into the in-store shopper or user's shopping cart 26. Accordingly, the shopping cart 3226, by one approach, includes a sensor 3228, such as an optical cart sensor or an RFID cart sensor or reader configured to identify retail products placed into a shopping cart 3226. This information may then be communicated to the control circuit 3212 and to the customer profile in the database 3222. As noted below, this information may be provided to the crowd-sourced expert providing the customer service for use in assisting the in-store shopper or user 3230.

By monitoring the retail items in the cart, via the shopping cart sensor(s) 3228, the control circuit 3212 may decide whether to proactively offer customer support, in part, based on the items in the shopping cart 3226 and/or suggest a crowd-source expert based, in part, on the items in the shopping cart 3226. In this manner, if there are unusual items in the cart, an unusual combination of items in the cart, and/or items that are not typically found in a particular in-store shoppers or user's cart, then the control circuit 3212 can use that information to match a crowd-sourced expert having the appropriate expertise to the in-store shopper. For example, if the in-store shopper or user has curry, dried coconut, and chutney in their shopping cart 3226 when they haven't purchased these items before (accordingly to their customer profile in the customer database), then the control circuit 3212 may match the in-store shopper or user 3230 with a crowd-sourced expert having an expertise in cooking, or even better experience or expertise cooking with these ingredients.

In some configurations, the electronic user device 3218 includes a personal mobile device, (e.g., smart phones, phablets, tablets, and similar devices), a wearable device, an electronic device mounted onto a shopping cart 3226, and/or another mobile device provided by the retail facility 3250, among others. Generally, the electronic user devices 3218 can each include one or more input/output devices that facilitate user interaction with the device (e.g., displays, speakers, microphones, keyboards, mice, touch screens, joysticks, dongles, pointing devices, game pads, cameras, gesture-based input devices, and similar I/O devices). As illustrated the shopping user interface 3214, which may be operated at one or more electronic user devices 3218, may be communicatively coupled over one or more distributed communication networks such as network 3219. The electronic user device 3218 also may include devices associated with smart carts or shopping carts with electronic devices mounted therein that are connected to the control circuit 3212 or scan-and-go mobile devices that in-store shoppers may checkout from the retail facility 3250, in addition to the in-store shopper or user's personal mobile device upon which a mobile app may be downloaded.

Further, while there are many options for receiving online customer support when shopping via a website, the crowd-sourced expertise provided herein occurs while the customer is shopping in the retail facility 3250. Thus, the crowd-sourced customer support, services, or advice are provided, for example, via the electronic user device 3218 of the user, a cart mounted device 3240, an in-store mobile device provided by the retail facility 3250, or interactive interfaces or demonstration devices 3242 installed at the retail facility 3250 that may provide a manner of communicating between the in-store shopper and the expert. In addition to this manner of communication, the interaction may be supplemented by the provision of testers, demonstration products, product installations, kiosks, and similar demonstration tools at the retail facility 3250. Indeed, in many approaches, the provision of customer service, support, or advice may occur via multiple pathways, e.g., audio communication over a mobile device, such as the electronic user device 3218 or cart mounted device 3240, associated with the in-store shopper and visual communication occurring via installed optical sensors or cameras and installed demonstration products. In this manner, if the in-store shopper is interested in learning how to use a sports product or improve their performance while using the product, the control circuit 3212, for example, may offer the advice of a matched crowd-sourced expert via the electronic user device 3218 carried by the shopper and then may proceed to establish a communication link between the in-store shopper and the matched crowd-sourced expert via the electronic user device or any of the other devices (mobile or installed) at the retail facility 3250. In such a configuration, the retail facility 3250 may have an area that permits the in-store shopper to handle or otherwise use the sports product or a similar demonstration product before purchase. This area may have cameras and speakers that capture video, which may be provided to the crowd-sourced expert for provision of the customer service. Though the in-store shopper or user 3230 may receive the communications in a variety of different manners, the electronic user device 3232 and associated interface 3234 are typically employed for communication purposes by the crowd-sourced experts. In short, the form of the customer support can occur in a number of manners (though it is typically offered initially via the user interface 3214), depending on the installations or available equipment at the retail facility 3250.

Though the system 3210 typically tracks customer behavior and prompts those customers likely in need of assistance about the availability of the crowd-sourced experts, the user interface 3214 also may permit a customer to request assistance. This can be particularly helpful if a customer is approaching a retail facility 3250 and the customer wants to begin receiving assistance right away, e.g., before the in-store sensor(s) 3220 have sensed significant customer behavior.

By one approach, an electronic user device 3218 may be associated with a shopping cart 3226, such as, for example, the electronic device 3240 mounted onto the shopping cart 3226 illustrated in FIG. 32. The shopping cart mounted electronic device 3240 also may assist consumers with other aspects of their shopping, such as, for example, by providing a shopping list, store directory, and/or pricing information, among other information and services.

Whether the electronic user device 3218 of the user includes a personal handheld mobile device (such as a smart phone), a mobile device issued by the retail (such as a scan-an-go device), or an electronic device mounted onto a store cart or basket, the electronic user device 3218 is in communication with and interacts with the control circuit 3212. The electronic user devices 3218 also may help sense or monitor the location of the in-store shopper by transmitting information such as its location within a store and/or duration or loitering at a particular area (dwell time), among other information. In one illustrative approach, the electronic user device 3218 can offer the in-store shopper help once they move into an area that they do not typically visit by comparing the pathway tracked and the typical routes taken by the shopper according to their customer profile in the database 3222. Even if the in-store shopper is entering an area they typically frequent in the retail facility, the electronic device 3218 may prompt them within new information regarding this area of the store.

As noted above, the presentation of the crowd-sourced customer support service is based on the particular user's customer behavior in the retail facility. Further, this customer service is generally presented to the particular user 3230 without inquiry or request by the customer. Accordingly, the user interface 3214, operating on the electronic user device 3218 (such as a personal mobile device of the in-store shopper or a store issued device such as a cart mounted electronic user device 3240) may provide the customer service or support by asking the customer whether additional information or help would be appreciated. In addition, as suggested above, offering support services may include the provision of a variety of information, such as, for example, what product to purchase, how to use a product, what product would work for me or for these particular circumstances, among other information.

The control circuit 3212 is in communication with the databases 3216 and the retail facility 3250, as noted above. As illustrated in FIG. 32, the various devices of system 3210 may communicate directly or indirectly, such as over one or more distributed communication networks, such as network 3219, which may include, for example, LAN, WAN, Internet, cellular, Wi-Fi, and other such communication networks or combinations of two or more of such networks.

The network 3219 helps facilitate the provision of quality customer service by rendering customer information available to the crowd-sourced experts that are matched with a shopper and tasked with providing the assistance. In some configurations, the crowd-sourced expert matched to a particular user 3230 is configured to receive at least a portion of the customer profile associated with the particular user 3230, via the expert user interface 3234, for reference during the interaction between the expert and in-store shopper or user 3230.

Though the crowd-sourced support or help is typically offered proactively (based on monitored behavior of the in-store shopper or particular user) sometimes the help provided may change in light of the communication or interaction between the in-store shopper and the expert. For example, if an expert offers to help provide product recommendations, but the in-store shopper already knows they want to purchase option A, the crowd-sourced expert may proactively offer suggestions regarding setup, use, and/or maintenance of option A or the in-store shopper may nonetheless ask the expert for advice regarding using option A that they intend to purchase. In this manner, the in-store shopper may request specific information. As noted, above, the system 3210 monitors customer behavior to identify customers likely needing assistance. In addition to using the customer behavior to identify those who need assistance, this cart inventory information may be used by the matched expert to help provide the customer service or support. For example, if the in-store shopper has visited certain aisles in the grocery department and then visits the home goods department and stops at an aisle with pots and pans, the information may be provided to the expert providing the customer service. In some configurations, as noted above, the sensors 3228 may track the items in the in-store shopper's cart (this information may be included in the customer profile in the customer database 3222) and this information may be provided to the expert to help them provide customer assistance. If the shopping cart includes certain food items and the customer is asking about cooking utensils, the expert may use the information about the items in the cart to help provide the customer assistance.

By having the system 3210 monitor the customer to see if they exhibit any behaviors indicative of a customer service need (i.e., dwelling in a particular aisle location for over a certain period of time, such as several minutes, visiting an area of the retail facility not typically or previously visited by that customer, taking an unusual route through the retail facility, retracing steps or revisiting areas in the retail facility, or deviating from typical routes taken by the particular customer, among others), the system 3210, in one approach, can offer the in-store customer or user crowd-sourced expert advice particular to that area of the retail facility where the in-store shopper or user is dwelling, which can be particularly effective for the in-store shopper if they are visiting an area of the retail facility that is new to them. Further, the match between the in-store shopper and the crowd-sourced expert can be improved by analyzing the customer's value vectors and a profile of the expert and ensuring a level of correlation or alignment between the two, as discussed above.

To monitor and improve the quality of the customer service, in some embodiments, the system 3210 facilitates vetting and/or rating of the crowd-sourced experts. Ratings may be received, for example, on various aspects of the customer support, and the system 3210 can use this information to reward or remunerate the crowd-sourced experts, to conduct a more well-aligned match between the in-store shopper and the crowd-sourced expert, and/or to provide suggestion or guidance to other crowd-sourced experts providing assistance.

By one approach, the user interface 3214 provides an expert rating tool configured to permit the user 3230 to rate aspects of their interaction with the crowd-sourced expert. In this manner, the user 3230 may rate, for example, the quality of the information, the speed and ease of the interaction, and/or the friendliness of the expert, among other aspects. In one illustrative approach, an expert rating (based on the ratings or feedback received) may be presented to other in-store shoppers presented with an opportunity to receive crowd-sourced customer service from that particular expert. In such a configuration, this information may help the in-store shoppers determine whether to accept the offer of assistance. The rating tool also may be available for use shortly after the interaction or support, such as at the conclusion of the interaction, and/or may be available later, such as after the in-store shopper or user has had an opportunity to evaluate a recommended product. For example, the user interface 14 may prompt the user to subsequently review the support or advice after providing the user time to use or evaluate any products suggested by the crowd-sourced expert.

In some configurations, the system may require that the crowd-sourced experts maintain a certain rating level to continue to provide the customer service, support or assistance. By one approach, the crowd-sourced experts may receive incentives or payment for providing the customer service or support. Thus, in some configurations, to retain the opportunity to earn the incentives or payment, the crowd-sourced experts must meet certain ratings requirements. The system 3210 also may limit the pool of crowd-sourced experts to those individuals who have demonstrated or shown some level of expertise in one or more product areas, such as by passing a questionnaire. In this manner, the system 3210 may evaluate and vet potential crowd-sourced experts so that the in-store shoppers can have a certain level of confidence in the opinions and advice received from the crowd-sourced experts. Further, a crowd-sourced expert may have developed and/or shown a level of expertise in a number of different product categories, such as, for example, sports equipment, arts and crafts, cooking, sewing, childcare, among many others), and the system may evaluate each of these areas or categories independently.

In operation, the shopping system 3210 (having a user interface 3214, a customer database 3222, and an expert database 3224 in communication with a control circuit 3212) is able, via the control circuit 3212, to obtain a first set of rules that indicate or identify a customer service need as a function of human behavior and identify a particular customer service need based on customer service behavior of the particular user sensed via store sensors, in communication with the control circuit, in the physical retail facility. For example, one of the rules may indicate that a customer who has remained in a particular location (or within a certain number of feet of a particular location) for a certain period of time is likely to need customer service, support, or assistance or that a customer who has returned to a particular location within a retail facility after previously visiting that location is likely to need customer service, support, or assistance. Accordingly, the system, which is configured to monitor the customer behavior including a customer's location within the store, route, and/or items placed within a shopping cart, among other possible behaviors, can identify those individuals likely to need the customer service, support, or assistance. By monitoring the customer behavior, the control circuit is able to compare that behavior with the first set of rules to identify those customers in need (or likely need) of customer service.

Further, the control circuit 3212 is configured to obtain a second set of rules that identify a crowd-sourced expert as a function of correspondence or alignment between customer value vectors of the particular user and expert value vectors of crowd-sourced experts and identify one or more particular crowd-sourced experts based on the second set of rules and a location of the particular user in the retail facility 3250. For example, the customer value vectors and expert value vectors, like those partiality vectors discussed above, can be used to assess the likelihood that certain crowd-sourced experts will be able to provide helpful information to the in-store shopper or user by ascertaining a degree of alignment between the customer's value vectors and expert value vectors. Further, the control circuit may identify crowd-sourced experts for the particular user or in-store shopper based on an alignment between the value vectors of the customer and that of the potential crowd-sourced experts.

In addition, the control circuit 3212 analyzes the location of the particular user in the retail facility 3250 before assigning a crowd-sourced expert to the customer. For example, if the particular user is loitering in the electronics area, particularly within the television aisle, the control circuit 3212, by one approach, selects one or more crowd-sourced experts knowledgeable about televisions from the crowd-sourced experts that matched or had aligned value vector profiles as the in-store customer. As suggested above, the experts with a value vector correspondence with the customer and an expertise in an area of interest may be provided an opportunity to accept the task of providing assistance, such as via a multi-cast arrangement.

In addition, the control circuit 3212 and the user interface 3214 are configured to present a crowd-sourced customer support service to the particular user based on the particular customer behavior and the location of the particular user in the physical retail facility. For example, the control circuit 3212 may facilitate interaction between the particular user and the particular crowd-sourced expert by permitting or facilitating a text chat, audio communication, and/or video communication, among other communication methods.

In one illustrative embodiment, a method for providing crowd-sourced customer services in a physical retail facility include maintaining a customer database of customer profiles with customer value vectors associated therewith and historical shopping behaviors, maintaining an expert database of crowd-sourced experts having expert value vectors associated therewith, providing a user interface operable on an electronic user device of a particular user, and monitoring customer behavior including customer location of the particular user as customers shop in the physical retail facility. Further, in such a configuration, the method includes determining whether the customer behavior of the particular user indicates a customer service need, matching a crowd-sourced expert to the particular user in need of the customer service based on the customer value vectors, the expert value vectors of a particular crowd-sourced expert, and a location of the customer or user in the physical retail facility, and presenting a crowd-sourced customer support service to the particular user based on the customer behavior. By one approach, the method includes sensing, for example, customer routes and locations within the physical retail facility and facilitating interaction between the particular user and the crowd-sourced expert by prompting the particular user regarding the available support via the user interface operating on the electronic user device.

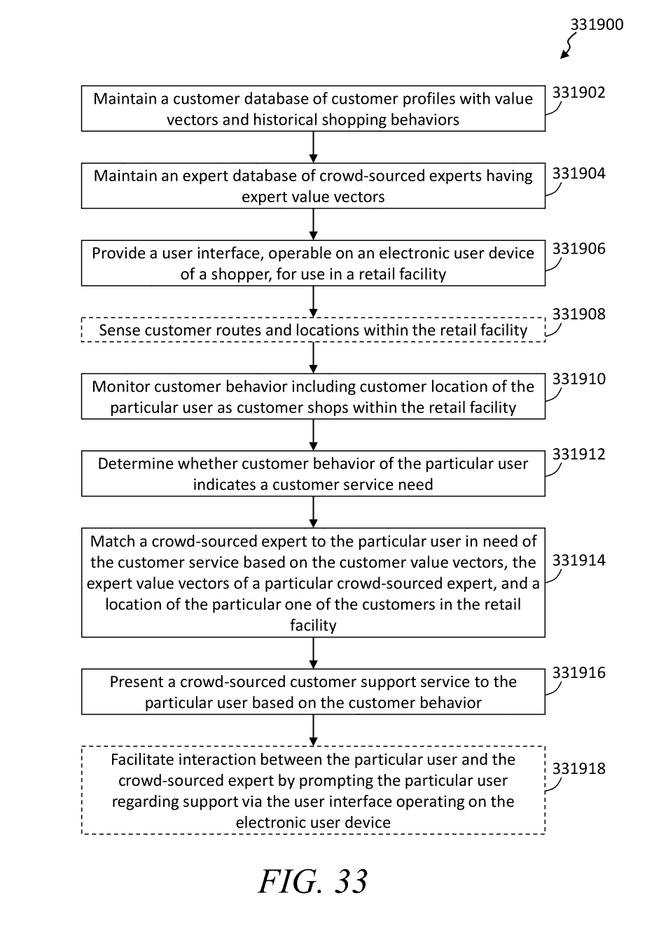

FIG. 33 illustrates a method 331900 that provides crowd-sourced customer services in a physical retail facility. In one configuration, the method maintains 331902 a customer database of customer profiles having value vectors and historical shopping behaviors stored therein, maintains 331904 an expert database of crowd-sourced experts having expert value vectors 331904, and provides 331906 a user interface operable on an electronic user device of a shopper for use in the physical retail facility. By one approach, the method senses 331908 in-store shopper or customer routes and locations within the retail facility. Accordingly, the method monitors 331910 customer behavior including customer location of the in-store shopper or user as the user shops within the retail facility. For example, as suggested above, by sensing 331908 and/or monitoring 331910 shoppers, customers, or users, their particular location, pathway, sounds, and/or dwell time may be captured. With this information, the method determines 331912 whether the customer behavior of the particular user indicates a customer service need (or likely need). As described above, the customer service need may include the need for additional information on products, a recommendation, or additional information. The method also may identify individuals that appear open to receiving additional information.

Upon a determination that the particular user likely has a customer service need, the method matches 331914 a crowd-sourced expert to the particular user in need of the customer service based on the customer value vectors in the associated customer profile with the expert value vectors of crowd-sourced experts to find a crowd-sourced expert to find an expert that will likely provide information helpful to the in-store shopper or user. The method also matches 331914 the particular user in need of the customer service with a crowd-sourced expert having expertise in the area or location of the retail facility the particular user is occupying. Thus, if the particular user is in the tabletop game aisle, the method matches the user with a crowd-sourced expert having demonstrated expertise in such products, along with having well-aligned expert value vectors.

Once the method has matched one or more crowd-sourced experts to the particular user (according to value vectors and the expertise area), the method may send a task request to the matched expert(s) providing them with an opportunity to accept the assignment or task to help the particular in-store shopper or user. As noted above, if multiple crowd-sourced experts matched with the particular user, the opportunity may be multicast to each of the matched crowd-sourced experts. Once one of the crowd-sourced experts has accepted the task, the method presents 331916 a crowd-sourced customer service to the particular user. For example, once a crowd-sourced expert has accepted the task, the method may prompt the particular in-store shopper or user by having a message or notice presented or displayed (via text or audio) on the particular user's electronic user device such via a user interface or retail mobile application (APP). The prompt may include a variety of different information, such as offering details about the matched crowd-sourced expert (e.g., the matched expert's relevant areas of expertise and/or ratings), offering specific information that may be provided by the crowd-sourced experts (e.g., asking whether the particular user would like to hear about reviews from similar shoppers), and/or information about a manner in which the crowd-sourced expert can provide additional information (e.g., informing the particular user that they can try or experience the product by visiting a nearby display), among additional information.

In some configurations, the method also facilitates 331918 the interaction between the particular user and the crowd-sourced expert by prompting the particular user regarding support via the user interface operating on the electronic user device. This facilitation also may include having other manners of providing customer support, such as, for example, having installed demonstration kiosks or tester products at the retail facility.

In another illustrative embodiment, a method for providing crowd-sourced customer services in a physical retail facility includes maintaining a customer database, maintaining an expert database, providing a user interface to in-store shoppers or users, obtaining a first set of rules that indicate a customer service need as a function of customer behavior, and identifying a particular customer service need of the particular user in the physical retail facility based on particular customer behavior of the particular user sensed via store sensors in the physical retail facility. Further, in such a configuration, the method also includes obtaining a second set of rules that identify a crowd-sourced expert as a function of correspondence between customer value vectors of the particular user, stored in the customer database, and expert value vectors of crowd-sourced experts, as stored in the expert database and identifying a particular crowd-sourced expert for the particular user based on the second set of rules. With this information, the method also presents a crowd-sourced customer support service to the particular user based on the particular customer behavior and a location of the particular user in the physical retail facility by facilitating interaction between the particular user and the particular crowd-sourced expert identified or matched. By one configuration, the method also senses customer routes and locations within the physical retail facility and facilitates the interaction between the particular user and the crowd-sourced expert via the electronic user devices of the particular user and the particular crowd-sourced expert assigned to assist the user.

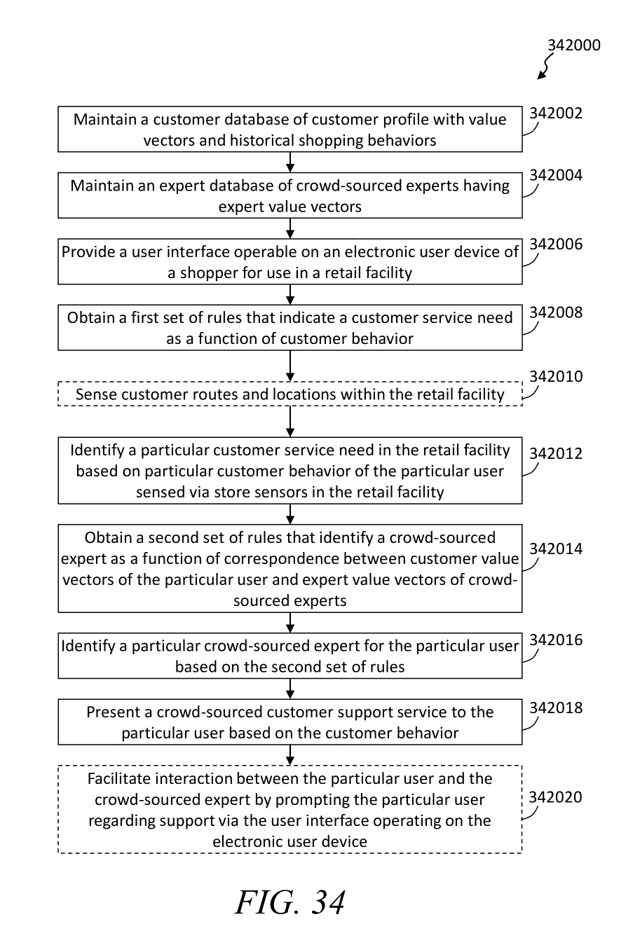

FIG. 34 illustrates a method 342000 that provides crowd-sourced customer support in a physical retail facility. In one configuration, the method maintains 342002 a customer database of customer profiles having value vectors and historical shopping behaviors stored therein, maintains 342004 an expert database of crowd-sourced experts having expert value vectors, and provides 342006 a user interface operable on an electronic user device of a shopper for use in the physical retail facility. By one approach, the method obtains 342008 a first set of rules that indicate a customer service need as a function of customer behavior. For example, the rules may indicate that a customer is likely to need and/or accept advice, suggestions, or information from an area expert if they are dwelling in a particular location for a certain amount of time, if they have taken certain paths in the retail facility (e.g., retracing their recent steps), and/or if they are visiting an area of the retail facility they typically don't visit, among other factors. By one approach, the method senses 342010 in-store shopper or customer routes and locations within the retail facility, which may include monitoring the location, pathway, sounds, and/or dwell time of customers. With this information, the method identifies 342012 a particular customer service need in the retail facility based on the particular customer behavior of the particular user sensed via sensors in the retail facility.

The method 342000 also obtains 342014 a second set of rules that identify a crowd-sourced expert as a function of correspondence between customer value vectors of the particular user and the expert value vectors of crowd-sourced experts. The second set of rules also may identify a suitable crowd-sourced expert by analyzing the overlap between the location or area of the particular user within the retail facility with an area of expertise of the crowd-sourced expert. Further, the method identifies 342016 a particular crowd-sourced expert for the particular user based on the second set of rules and presents 342018 a crowd-sourced customer support service to the particular user based on the customers behavior. In addition, the method facilitates interaction 342020 between the particular user and the crowd-sourced expert by, in part, prompting the particular user regarding available support via the user interface operating on the electronic user device.

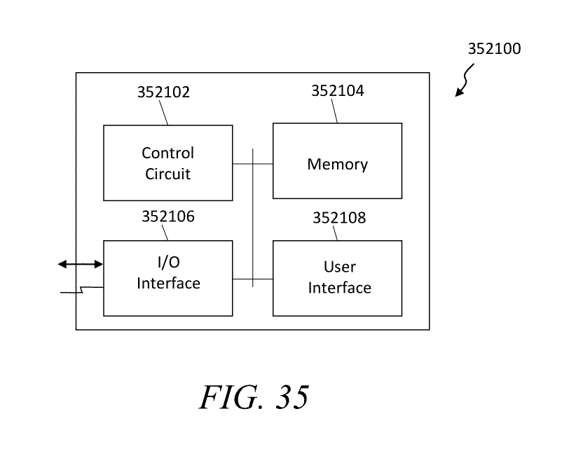

The methods, techniques, systems, devices, services, servers, sources and the like described herein may be utilized, implemented and/or run on many different types of devices and/or systems. Referring to FIG. 35, there is illustrated a system 352100 that may be used for any such implementations, in accordance with some embodiments. One or more components of the system 352100 may be used to implement any system, apparatus or device mentioned above, or parts of such systems, apparatuses or devices, such as for example any of the above or below mentioned control circuits, electronic user devices, sensor(s), databases, platforms, parts thereof, and the like. However, the use of the system 352100 or any portion thereof is, certainly not required.

By way of example, the system 352100 may include one or more control circuits 352102, memory 352104, input/output (I/O) interface 352106, and/or user interface 352108. The control circuit 352102 typically comprises one or more processors and/or microprocessors. The memory 352104 stores the operational code or set of instructions that is executed by the control circuit 352102 and/or processor to implement the functionality of the systems and devices described herein, parts thereof, and the like. In some embodiments, the memory 352104 may also store some or all of particular data that may be needed to deliver retail products outside of a retail facility.

It is understood that the control circuit 352102 and/or processor may be implemented as one or more processor devices as are well known in the art. Similarly, the memory 352104 may be implemented as one or more memory devices as are well known in the art, such as one or more processor readable, and/or computer readable media and can include volatile and/or nonvolatile media, such as RAM, ROM, EEPROM, flash memory and/or other memory technology. Further, the memory 352104 is shown as internal to the system 352100; however, the memory 352104 can be internal, external or a combination of internal and external memory. The system 352100 also may include a database (not shown in FIG. 35) as internal, external, or a combination of internal and external to the system 352100. Additionally, the system typically includes a power supply (not shown), which may be rechargeable, and/or it may receive power from an external source. While FIG. 35 illustrates the various components being coupled together via a bus, it is understood that the various components may actually be coupled to the control circuit 352102 and/or one or more other components directly.

Generally, the control circuit 352102 and/or electronic components of the system 352100 can comprise fixed-purpose hard-wired platforms or can comprise a partially or wholly programmable platform. These architectural options are well known and understood in the art and require no further description here. The system and/or control circuit 352102 can be configured (for example, by using corresponding programming as will be well understood by those skilled in the art) to carry out one or more of the steps, actions, and/or functions described herein. In some implementations, the control circuit 352102 and the memory 352104 may be integrated together, such as in a microcontroller, application specification integrated circuit, field programmable gate array or other such device, or may be separate devices coupled together.

The I/O interface 352106 allows wired and/or wireless communication coupling of the system 352100 to external components and/or systems. Typically, the I/O interface 352106 provides wired and/or wireless communication (e.g., Wi-Fi, Bluetooth, cellular, RF, and/or other such wireless communication), and may include any known wired and/or wireless interfacing device, circuit and/or connecting device, such as, but not limited to, one or more transmitter, receiver, transceiver, etc.

The user interface 352108 may be used for user input and/or output display. For example, the user interface 352108 may include any known input devices, such one or more buttons, knobs, selectors, switches, keys, touch input surfaces, audio input, and/or displays, etc. Additionally, the user interface 352108 includes one or more output display devices, such as lights, visual indicators, display screens, etc. to convey information to a user, such as but not limited to communication information, instructions regarding products, status information, order information, delivery information, notifications, errors, conditions, and/or other such information. Similarly, the user interface 352108 in some embodiments may include audio systems that can receive audio commands or requests verbally issued by a user, and/or output audio content, alerts and the like.

As noted above, these teachings can be utilized to provide a system for virtual coaching on use of a product that includes:

a library database comprising libraries of product listings, wherein each of the libraries of product listings is associated with a particular customer of a plurality of customers;

a control circuit coupled to the library database, the control circuit configured to:

predict one or more intentions of the particular customer when the particular customer is at a retail store;

determine at least one product associated with the one or more intentions of the particular customer;

provide a first how-to-use data associated with the at least one product to the particular customer in response to the control circuit determining the at least one product, wherein the first how-to-use data associated with the at least one product is provided to the particular customer via at least one transceiver and at a time when the particular customer is at the retail store; and

create a particular library of the libraries of product listings with a product identifier of the at least one product, wherein, in the particular library, the product identifier of the at least one product is associated with the first how-to-use data, and wherein the particular library is associated with the particular customer; and

the at least one transceiver coupled to the control circuit and configured to interface with at least one device associated with the particular customer.

In the above-described approach the control circuit can be further configured to:

determine at least one other product that is tangentially related to the at least one product;

determine a second how-to-use data based on a predicted intended use of the at least one product and the at least one other product by the particular customer; and

provide the second how-to-use data to the particular customer via the at least one transceiver in response to the control circuit determining the second how-to-use data, wherein the second how-to-use data is provided to the particular customer at the time when the particular customer is at the retail store.

In the above-described approach the control circuit can be further configured to:

access the particular library of the library database to provide the first how-to-use data associated with the at least one product to the particular customer in response to a first request from the particular customer to provide the first how-to-use data at a second time when the particular customer is no longer at the retail store; and

provide a second how-to-use data to the particular customer at the second time when the particular customer is no longer at the retail store,

wherein the second how-to-use data is associated with at least one other product that is tangentially related to the at least one product, and wherein providing the second how-to-use data is in response to a second request from the particular customer.

In the above-described approach the first and second requests can be sent to the control circuit by the particular customer when the particular customer is at the retail store, wherein the first and second requests comprise a customer specified setting including when to send the first and second requests, and wherein the first and second how-to-use data are provided to the particular customer based on the customer specified setting.

In the above-described approach the control circuit can be further configured to:

determine one or more second products associated with the one or more intentions of the particular customer over a period of time while the particular customer is at the retail store;

re-predict the one or more intentions of the particular customer based on the one or more second products and the at least one product over the period of time;

provide a second how-to-use data based on the re-predicted one or more intentions;

update the particular library with a second product identifier of at least one of the one or more second products; and

associate the second product identifier with the second how-to-use data in the particular library.

In the above-described approach the control circuit can be further configured to:

determine at least one other product that is tangentially related to the at least one product;

determine a second how-to-use data associated with the at least one other product; and

update the particular library with a second product identifier of the at least one other product, wherein, in the particular library, the second product identifier of the at least one other product is associated with the second how-to-use data.

The above-described system can further include a content database configured to store a plurality of how-to-use data associated with a plurality of products, wherein the control circuit is further configured to:

determine a predicted intended use by the particular customer based on at least one of the at least one product, at least one other product that is tangentially related to the at least one product, and the one or more intentions of the particular customer;
determine a second how-to-use data of the content database to associate with the at least one product based on the predicted intended use of the particular customer; and

associate the second how-to-use data with the at least one product in the particular library of the library database.

By one approach, in the above-described system the one or more intentions can be associated with one or more products at the retail store, wherein the one or more intentions correspond to predicted intended uses by the particular customer, and wherein the one or more intentions are predicted based on at least one of: a physical movement of the particular customer while viewing the one or more products, selecting one or more representations of the one or more products on a device, scanning at least one product identifier of the one or more products, and one or more verbal cues associated with the one or more products. If desired, the system can further comprise a customer profile database communicatively coupled with the control circuit, wherein the customer profile database is configured to store a plurality of customer profiles each corresponding to one of the plurality of customers and each comprising a plurality of customer partiality vectors associated with a corresponding customer of the plurality of customers, wherein the control circuit, in predicting the one or more intentions, is further configured to predict the one or more intentions based on at least one or more customer partiality vectors associated with the particular customer, and wherein each of the plurality of customer partiality vectors has a magnitude that corresponds to a determined magnitude of a strength of a belief by the corresponding customer in an amount of good that comes from an amount of order imposed upon material space time by a corresponding particular partiality. In addition to the above and/or in lieu thereof, the control circuit can be further configured to:

associate a particular how-to-use data to each of the predicted intended uses by the particular customer;

send a message to the at least one device associated with the particular customer, wherein the message comprises a listing of the predicted intended uses with at least a link to corresponding how-to-use data; and

provide a selected how-to-use data to the at least one device associated with the particular customer based on a selection by the particular customer from the listing.

As noted above, these teachings can also serve to support a method for virtual coaching on use of product comprising:

by a control circuit coupled to a library database comprising libraries of product listings, wherein each of the libraries of product listings is associated with a particular customer of a plurality of customers:

predicting one or more intentions of the particular customer when the particular customer is at a retail store;

determining at least one product associated with the one or more intentions of the particular customer;

providing a first how-to-use data associated with the at least one product to the particular customer in response to the control circuit determining the at least one product, wherein the first how-to-use data associated with the at least one product is provided to the particular customer via at least one transceiver at a time when the particular customer is at the retail store; and

creating a particular library of the libraries of product listings with a product identifier of the at least one product, wherein, in the particular library, the product identifier of the at least one product is associated with the first how-to-use data, and wherein the particular library is associated with the particular customer.

By one approach the foregoing method can further comprise:

determining at least one other product that is tangentially related to the at least one product;

determining a second how-to-use data based on a predicted intended use of the at least one product and the at least one other product by the particular customer; and

providing the second how-to-use data to the particular customer via the at least one transceiver in response to the control circuit determining the second how-to-use data, wherein the second how-to-use data is provided to the particular customer at the time when the particular customer is at the retail store.

By one approach this method can further comprise accessing the particular library of the library database to provide the first how-to-use data associated with the at least one product to the particular customer in response to a first request from the particular customer to provide the first how-to-use data at a second time when the particular customer is no longer at the retail store.

By one approach this method can further comprise providing a second how-to-use data to the particular customer at the second time when the particular customer is no longer at the retail store, wherein the second how-to-use data is associated with at least one other product that is tangentially related to the at least one product, and wherein providing the second how-to-use data is in response to a second request from the particular customer. By one approach the first and second requests are sent to the control circuit by the particular customer when the particular customer is at the retail store, and wherein the first and second requests are made through a customer specified setting such that the first and the second requests are sent based on the customer specified setting.

By one approach this method can further comprise:

determining at least one other product that is tangentially related to the at least one product;

determining a second how-to-use data associated with the at least one other product; and

updating the particular library with a second product identifier of the at least one other product, wherein, in the particular library, the second product identifier of the at least one other product is associated with the second how-to-use data.

By one approach this method can further comprise:

determining a predicted intended use by the particular customer based on at least one of the at least one product, at least one other product that is tangentially related to the at least one product, and the one or more intentions of the particular customer;

determining a second how-to-use data of a content database to associate with the at least one product based on the predicted intended use of the particular customer; and

associating the second how-to-use data with the at least one product in the particular library of the library database, wherein the content database is configured to store a plurality of how-to-use data associated with a plurality of products.

By one approach this method can further comprise:

associating the one or more intentions with one or more products at the retail store; and

predicting the one or more intentions based on at least one of: a physical movement of the particular customer while viewing the one or more products, selecting one or more representations of the one or more products on a device, scanning at least one product identifier of the one or more products, and one or more verbal cues associated with the one or more products, wherein the one or more intentions correspond to predicted intended uses by the particular customer. By one approach, predicting the one or more intentions is further based on at least customer partiality vectors associated with the particular customer, and wherein each of the customer partiality vectors has a magnitude that corresponds to a determined magnitude of a strength of a belief by the particular customer in an amount of good that comes from an amount of order imposed upon material space time by a corresponding particular partiality.

By one approach this method can further comprise:

associating a particular how-to-use data to each of the predicted intended uses by the particular customer;

sending a message to the at least one device associated with the particular customer, wherein the message comprises a listing of the predicted intended uses with at least a link to corresponding how-to-use data; and

providing a selected how-to-use data to the at least one device associated with the particular customer based on a selection of the particular customer from the listing.

As noted above, these teachings can also be utilized to provide a shopping system that comprises:

a user interface for use in a physical retail facility, the user interface configured to operate on an electronic user device of a particular user

a customer database of customer profiles with customer value vectors associated therewith and historical shopping behaviors;

an expert database of crowd-sourced experts having expert value vectors associated therewith;

a control circuit in communication with the user interface and the databases, the control circuit configured to:

monitor customer behavior including customer location of the particular user as customers shop in the physical retail facility;

determine whether the customer behavior of the particular user indicates a customer service need;

upon a determination that the customer behavior of the particular user indicates the customer service need, match a particular crowd-sourced expert to the particular user in need of the customer service based on the customer value vectors, the expert value vectors of the particular crowd-sourced expert, and a location of the particular user in the physical retail facility; and

present a crowd-sourced customer service opportunity to the particular user based on the customer behavior.

By one approach this shopping system can further comprise at least one of: one or more motion sensors, one or more sound sensors, one or more optical sensors, or one or more location sensors configured to sense customer routes and locations within the physical retail facility, and the motion sensors, sound sensors, optical sensors, or location sensors being in communication with the control circuit.

By one approach this shopping system can further comprise having the control circuit be further configured to receive data from the motion sensors, sound sensors, optical sensors, or location sensors and is configured to monitor the customer behavior by at least one of the following: determining a customer route through the physical retail facility, determining a dwell time for the particular user at a particular location, determining whether the particular user has deviated from previous routes taken through the physical retail facility, or analyzing customer sounds.

By one approach this shopping system can further comprise determining whether the customer behavior of the particular user indicates the customer service need includes identifying non-standard shopping behavior for the particular user by comparing the received data and the monitored customer behavior with the historical shopping behaviors in the customer database.

By one approach this shopping system can further comprise the user interface facilitating interaction between the particular user and the crowd-sourced expert by prompting the particular user regarding available customer support via the user interface.

By one approach this shopping system can further comprise having the crowd-sourced customer service opportunity be presented proactively and the crowd-sourced expert provides to the particular user, via the user interface, at least one of: a product suggestion, product advice, or product information.

By one approach this shopping system can further comprise at least one of an optical cart sensor or an RFID cart sensor configured to identify one or more retail products in a customer shopping cart and communicate the retail products in the customer shopping cart to the control circuit.

By one approach this shopping system can further comprise having the particular crowd-sourced expert receive a shopping cart inventory for the particular user for use in assisting the particular user with the customer service need.

By one approach this shopping system can further comprise the particular crowd-sourced expert being matched to the particular user and configured to receive at least a portion of the customer profile associated with the particular user for reference during the facilitated interaction between the particular crowd-sourced expert and the particular user.

By one approach this shopping system can further comprise the user interface providing an expert rating tool configured to permit the particular user to rate aspects of the interaction with the particular crowd-sourced expert.

By one approach this shopping system can further comprise the user interface being further configured to display an expert rating for the particular crowd-sourced expert when presenting the crowd-sourced customer service opportunity to the particular user.

By one approach this shopping system can further comprise an expert user interface configured to operate on an expert electronic user device of the particular crowd-sourced expert, the expert user interface facilitating interaction between the particular crowd-sourced expert and the particular user.

By one approach this shopping system can further comprise having at least one of the user interface or the expert user interface be provided to the electronic user devices by the control circuit.

By one approach this shopping system can further comprise having at least one of the user interface or the expert user interface be configured to be executed by the electronic user device or the expert electronic user device when in communication with the control circuit.

These teachings can also be employed to provide a shopping system that comprises:

a user interface for use within a physical retail facility, the user interface operable on an electronic user device of a particular user;

a customer database of customer profiles with customer value vectors associated therewith and historical shopping behaviors;

an expert database of crowd-sourced experts having expert value vectors associated therewith;

a control circuit in communication with the databases and the electronic user devices, the control circuit configured to:

obtain a first set of rules that indicate a customer service need as a function of customer behavior;

identify a particular customer service need of the particular user in the physical retail facility based on particular customer behavior of the particular user sensed via store sensors, in communication with the control circuit in the physical retail facility;

obtain a second set of rules that identify a crowd-sourced expert as a function of correspondence between customer value vectors of the particular user, stored in the customer database and expert value vectors of crowd-sourced experts, stored in the expert database;

identify a particular crowd-sourced expert for the particular user based on the second set of rules and a location of the particular user in the physical retail facility; and

present a crowd-sourced customer service opportunity to the particular user based on the particular customer behavior and the location of the particular user in the physical retail facility and facilitating interaction between the particular user and the particular crowd-sourced expert identified.

These teachings can also serve to provide a method for providing crowd-sourced customer services in a physical retail facility, the method comprising:

maintaining a customer database of customer profiles with customer value vectors associated therewith and historical shopping behaviors;

maintaining an expert database of crowd-sourced experts having expert value vectors associated therewith;

providing a user interface for use in a physical retail facility, the user interface configured to operate on an electronic user device of a particular user;

monitoring customer behavior including customer location of the particular user as customers shop in the physical retail facility;

determining whether the customer behavior of the particular user indicates a customer service need;

matching a crowd-sourced expert to the particular user in need of the customer service based on the customer value vectors, the expert value vectors of a particular crowd-sourced expert, and a location of the particular one of the customers in the physical retail facility; and

presenting a crowd-sourced customer service opportunity to the particular user based on the customer behavior.

By one approach this method can further comprise sensing customer routes and locations within the physical retail facility, prompting the particular user regarding available customer service support via the user interface operating on the electronic user device, and facilitating interaction between the particular user and the particular crowd-sourced expert.

By one approach these teachings can also support a method to provide crowd-sourced customer services in a physical retail facility by:

maintaining a customer database of customer profiles with customer value vectors associated therewith and historical shopping behaviors;

maintaining an expert database of crowd-sourced experts having expert value vectors associated therewith;

providing a user interface for use in a physical retail facility, the user interface configured to operate on an electronic user device of a particular user;

obtaining a first set of rules that indicate a customer service need as a function of customer behavior;

identifying a particular customer service need of the particular user in the physical retail facility based on particular customer behavior of the particular user sensed via store sensors in the physical retail facility;

obtaining a second set of rules that identify a crowd-sourced expert as a function of correspondence between customer value vectors of the particular user, stored in the customer database, and expert value vectors of crowd-sourced experts, as stored in the expert database;

identifying a particular crowd-sourced expert for the particular user based on the second set of rules; and

presenting a crowd-sourced customer service opportunity to the particular user based on the particular customer behavior and a location of the particular user in the physical retail facility and facilitating interaction between the particular user and the particular crowd-sourced expert identified.

By one approach the aforementioned mention can further comprise sensing customer routes and locations within the physical retail facility and wherein the facilitation of interaction between the particular user and the particular crowd-sourced expert occurs via the electronic user device of the particular user and an electronic user device of the particular crowd-sourced expert identified.

Also as described above, these teachings can serve to provide a mobile electronic device that is configured to render augmented reality (AR) images to a retail store customer in real-time, the device comprising:

a first sensor that obtains an image of a portion of a current field of view of a customer as the customer moves through a retail store;

a display apparatus;

a transceiver circuit that is configured to receive product placement and configuration data associated with products at the retail store, the transceiver circuit also configured to receive product characteristics, wherein the product characteristics indicate an ability of a product to enable past, present, and future order associated with a product at the retail store;

a data storage device that stores a customer profile, wherein the customer profile includes values of the customer, wherein each value of the customer comprises a belief or perception of the customer in a good or an advantage which results from supporting the order, the data storage device also storing a current location of the customer within the retail store;

a control circuit that is coupled to the display apparatus, the transceiver circuit, the first sensor, and the data storage device, the control circuit configured to:

store the received product placement and configuration data, and the product characteristics in the data storage device;

obtain the current image from the first sensor;

identify products in the current image based at least in part upon the current location of the customer and the product placement and configuration data, and subsequently obtain the product characteristics of the identified products;

based upon a comparison between the customer profile and the product characteristics of the identified products, select one or more visualization elements to overlay onto the current image of the field of view;

create a modified image by incorporating the selected one or more visualization elements into the image; and

render the modified image onto the display apparatus for viewing by the customer.

By one approach as regards the foregoing device, the product characteristics comprise vectorized product characteristics and each of the vectorized product characteristics are programmatically linked to a strength of the product characteristic, and the customer profile comprises customer partiality vectors, wherein each of the customer partiality vectors comprises a customer preference that is programmatically linked to a strength of the customer preference.

By one approach, the foregoing device further comprises a second sensor that is coupled to the control circuit, and wherein the second sensor senses data indicating a customer action, and wherein the control circuit is configured to selectively make an adjustment to the customer profile based upon detection by the control circuit of the customer action in the data from the second sensor, the adjustment being effective to change at least one of the visualization elements being rendered to the customer. By one approach the second sensor is a camera, an RFID reader, or a scanner. By one approach the first sensor and the second sensor are the same device.

By one approach the device is a smartphone, a tablet, a laptop, or headgear.

By one approach as regards the foregoing device, the one or more visualization elements comprise one or more of a chart, an icon, a graphical element, a textual element, an animated element, or a color highlight.

By one approach as regards the foregoing device, the comparison indicates at least one match between the customer profile and the product characteristic of the identified products.

By one approach as regards the foregoing device, the comparison indicates that no match exists between the customer profile for a selected product and the product characteristic of the selected product, and wherein visualizations of the selected product are removed from the modified image prior to rendering the modified image to the customer.

By one approach as regards the foregoing device, the product placement data is included in a planogram, or is sensed information obtained by the first sensor.

By one approach as regards the foregoing device, the current location of the customer is determined by the electronic device from sensed inputs, or the current location of the customer is received from a central location via the transceiver circuit.

And as is also described above, these teachings will support providing a method of rendering augmented reality (AR) images to a retail store customer in real-time, the method comprising:

obtaining at a first sensor an image of a portion of a current field of view of a customer as the customer moves through a retail store;

receiving at a transceiver circuit product placement and configuration data associated with products at the retail store, and receiving at the transceiver circuit product characteristics, wherein each of the product characteristics indicates an ability of a product to enable past, present, and future order associated with a product at the retail store;

storing a customer profile in a data storage device, wherein the customer profile includes values of the customer, wherein each value of the customer comprises a belief or perception of the customer in a good or an advantage which results from supporting the order, the data storage device also storing a current location of the customer within the retail store;

storing by a control circuit the received product placement and configuration data, and the product characteristics in the data storage device;

obtaining by the control circuit the current image from the first sensor;

at the control circuit, identifying products in the current image based at least in part upon the current location of the customer and the product placement and configuration data, and subsequently obtaining the product characteristics of the identified products from the data storage device;

based upon a comparison between the customer profile and the product characteristics of the identified products, at the control circuit selecting one or more visualization elements to overlay onto the current image of the field of view;

creating by the control circuit a modified image by incorporating the selected one or more visualization elements into the image; and

rendering by the control circuit the modified image onto the display apparatus for viewing by the customer.

By one approach as regards the foregoing method, the product characteristics comprise vectorized product characteristics and each of the vectorized product characteristics are programmatically linked to a strength of the product characteristic, and wherein the customer profile comprises customer partiality vectors, wherein each of the customer partiality vectors comprises a customer preference that is programmatically linked to a strength of the customer preference.

By one approach the foregoing method comprises, at a second sensor, sensing data indicating a customer action, and wherein the control circuit selectively makes an adjustment to the customer profile upon detection of the customer action in the data from the second sensor, the adjustment being effective to change at least one of the visualization elements being rendered to the customer. By one approach the second sensor is a camera, an RFID reader, or a scanner. By one approach the first sensor and the second sensor are the same device.

By one approach the foregoing method is implemented at a smartphone, a tablet, a laptop, or headgear.

By one approach as regards the foregoing method, one or more visualization elements comprise one or more of a chart, an icon, a graphical element, a textual element, an animated element, or a color highlight.

By one approach as regards the foregoing method, the comparison indicates a match between the customer profile and at least one product characteristic of the identified products.

By one approach as regards the foregoing method, the comparison indicates that no match exists between the customer profile for a selected product and the product characteristic of the selected product, and wherein visualizations of the selected product are removed from the modified image prior to rendering the modified image to the customer.

By one approach as regards the foregoing method, the product placement data is included in a planogram, or is sensed information obtained by the first sensor.

By one approach as regards the foregoing method, the current location of the customer is determined by the electronic device from sensed inputs, or the current location of the customer is received from a central location via the transceiver circuit.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

This application is related to, and incorporates herein by reference in its entirety, each of the following U.S. applications listed as follows by application number and filing date: 62/323,026 filed Apr. 15, 2016; 62/341,993 filed May 26, 2016; 62/348,444 filed Jun. 10, 2016; 62/350,312 filed Jun. 15, 2016; 62/350,315 filed Jun. 15, 2016; 62/351,467 filed Jun. 17, 2016; 62/351,463 filed Jun. 17, 2016; 62/352,858 filed Jun. 21, 2016; 62/356,387 filed Jun. 29, 2016; 62/356,374 filed Jun. 29, 2016; 62/356,439 filed Jun. 29, 2016; 62/356,375 filed Jun. 29, 2016; 62/358,287 filed Jul. 5, 2016; 62/360,356 filed Jul. 9, 2016; 62/360,629 filed Jul. 11, 2016; 62/365,047 filed Jul. 21, 2016; 62/367,299 filed Jul. 27, 2016; 62/370,853 filed Aug. 4, 2016; 62/370,848 filed Aug. 4, 2016; 62/377,298 filed Aug. 19, 2016; 62/377,113 filed Aug. 19, 2016; 62/380,036 filed Aug. 26, 2016; 62/381,793 filed Aug. 31, 2016; 62/395,053 filed Sep. 15, 2016; 62/397,455 filed Sep. 21, 2016; 62/400,302 filed Sep. 27, 2016; 62/402,068 filed Sep. 30, 2016; 62/402,164 filed Sep. 30, 2016; 62/402,195 filed Sep. 30, 2016; 62/402,651 filed Sep. 30, 2016; 62/402,692 filed Sep. 30, 2016; 62/402,711 filed Sep. 30, 2016; 62/406,487 filed Oct. 11, 2016; 62/408,736 filed Oct. 15, 2016; 62/409,008 filed Oct. 17, 2016; 62/410,155 filed Oct. 19, 2016; 62/413,312 filed Oct. 26, 2016; 62/413,304 filed Oct. 26, 2016; 62/413,487 filed Oct. 27, 2016; 62/422,837 filed Nov. 16, 2016; 62/423,906 filed Nov. 18, 2016; 62/424,661 filed Nov. 21, 2016; 62/427,478 filed Nov. 29, 2016; 62/436,842 filed Dec. 20, 2016; 62/436,885 filed Dec. 20, 2016; 62/436,791 filed Dec. 20, 2016; 62/439,526 filed Dec. 28, 2016; 62/442,631 filed Jan. 5, 2017; 62/445,552 filed Jan. 12, 2017; 62/463,103 filed Feb. 24, 2017; 62/465,932 filed Mar. 2, 2017; 62/467,546 filed Mar. 6, 2017; 62/467,968 filed Mar. 7, 2017; 62/467,999 filed Mar. 7, 2017; 62/471,089 filed Mar. 14, 2017; 62/471,804 filed Mar. 15, 2017; 62/471,830 filed Mar. 15, 2017; 62/479,106 filed Mar. 30, 2017; 62/479,525 filed Mar. 31, 2017; 62/480,733 filed Apr. 3, 2017; 62/482,863 filed Apr. 7, 2017; 62/482,855 filed Apr. 7, 2017; 62/485,045 filed Apr. 13, 2017; Ser. No. 15/487,760 filed Apr. 14, 2017; Ser. No. 15/487,538 filed Apr. 14, 2017; Ser. No. 15/487,775 filed Apr. 14, 2017; Ser. No. 15/488,107 filed Apr. 14, 2017; Ser. No. 15/488,015 filed Apr. 14, 2017; Ser. No. 15/487,728 filed Apr. 14, 2017; Ser. No. 15/487,882 filed Apr. 14, 2017; Ser. No. 15/487,826 filed Apr. 14, 2017; Ser. No. 15/487,792 filed Apr. 14, 2017; Ser. No. 15/488,004 filed Apr. 14, 2017; Ser. No. 15/487,894 filed Apr. 14, 2017; 62/486,801 filed Apr. 18, 2017; 62/491,455 filed Apr. 28, 2018; 62/502,870 filed May 8, 2017; 62/510,322 filed May 24, 2017; 62/510,317 filed May 24, 2017; Ser. No. 15/606,602 filed May 26, 2017; 62/511,559 filed May 26, 2017; 62/513,490 filed Jun. 1, 2017; 62/515,675 filed Jun. 6, 2018; Ser. No. 15/624,030 filed Jun. 15, 2017; Ser. No. 15/625,599 filed Jun. 16, 2017; Ser. No. 15/628,282 filed Jun. 20, 2017; 62/523,148 filed Jun. 21, 2017; 62/525,304 filed Jun. 27, 2017; Ser. No. 15/634,862 filed Jun. 27, 2017; 62/527,445 filed Jun. 30, 2017; Ser. No. 15/655,339 filed Jul. 20, 2017; Ser. No. 15/669,546 filed Aug. 4, 2017; and 62/542,664 filed Aug. 8, 2017; 62/542,896 filed Aug. 9, 2017; Ser. No. 15/678,608 filed Aug. 16, 2017; 62/548,503 filed Aug. 22, 2017; 62/549,484 filed Aug. 24, 2017; Ser. No. 15/685,981 filed Aug. 24, 2017; 62/558,420 filed Sep. 14, 2017; Ser. No. 15/704,878 filed Sep. 14, 2017; 62/559,128 filed Sep. 15, 2017; Ser. No. 15/783,787 filed Oct. 13, 2017; Ser. No. 15/783,929 filed Oct. 13, 2017; Ser. No. 15/783,825 filed Oct. 13, 2017; Ser. No. 15/783,551 filed Oct. 13, 2017; Ser. No. 15/783,645 filed Oct. 13, 2017; Ser. No. 15/782,555 filed Oct. 13, 2017; 62/571,867 filed Oct. 13, 2017; Ser. No. 15/783,668 filed Oct. 13, 2017; Ser. No. 15/783,960 filed Oct. 13, 2017; Ser. No. 15/782,559 filed Oct. 13, 2017; Ser. No. 15/921,540 filed Mar. 14, 2018; Ser. No. 15/939,788 filed Mar. 29, 2018; and Ser. No. 15/947,380 filed Apr. 6, 2018.

What is claimed is:

1. An apparatus, comprising:
a memory having stored therein information including partiality information for each of a plurality of persons in the form of a plurality of partiality vectors for each of the persons wherein the partiality vector has at least one of a magnitude and an angle that corresponds to a magnitude of the person's belief in an amount of good that comes from an order associated with that partiality, wherein the partiality information includes, at least in part, information regarding a particular person's propensity to behave as a first adopter;
a control circuit operably coupled to the memory and configured to use the partiality information in conjunction with vectorized characterizations for each of a plurality of products, wherein each of the vectorized characterizations indicates a measure regarding an extent to which a corresponding one of the products accords with a corresponding one of the plurality of partiality vectors, to select at least one product to present to a particular person.

2. The apparatus of claim 1 wherein the partiality information that includes information regarding a particular person's propensity to behave as a first adopter includes a first adopter characterization for each of a plurality of product categories.

3. The apparatus of claim 1 wherein the partiality information further includes, at least in part, information regarding a particular person's propensity to behave as a late adopter.

4. The apparatus of claim 3 wherein the information regarding a particular person's propensity to behave as a late adopter includes a late adopter characterization for each of a plurality of product categories.

5. The apparatus of claim 4 wherein the information regarding a particular person's propensity to behave as a first adopter includes a first adopter characterization for each of a plurality of product categories.

6. The apparatus of claim 1 wherein the control circuit is further configured to:
form the partiality information regarding a particular person's propensity to behave as a first adopter as a function, at least in part, of objective information regarding the particular person.

7. The apparatus of claim 6 wherein the objective information includes information regarding specific products acquired by the particular person.

8. The apparatus of claim 7 wherein the objective information further includes a time of acquiring the specific products by the particular person.

9. The apparatus of claim 8 wherein the objective information further includes a time of product availability for the specific products acquired by the particular person.

10. The apparatus of claim 6 wherein the control circuit is further configured to:
form the partiality information regarding a particular person's propensity to behave as a first adopter as a function, at least in part, of subjective information regarding the particular person.

11. The apparatus of claim 10 wherein the subjective information includes information regarding at least one affinity group to which the particular person belongs.

12. The apparatus of claim 10 wherein the subjective information includes information regarding social-networking expressions posted by the particular person.

13. A method to facilitate selecting a particular product for a particular person, comprising: by a control circuit:
accessing partiality information for a particular person in the form of a plurality of partiality vectors wherein each of the partiality vectors has at least one of a magnitude and an angle that corresponds to a magnitude of the particular person's belief in an amount of good that comes from an order associated with that partiality, wherein the partiality information includes, at least in part, information regarding the particular person's propensity to behave as a first adopter;
using the partiality information in conjunction with vectorized characterizations for each of a plurality of products, wherein each of the vectorized characterizations indicates a measure regarding an extent to which a corresponding one of the products accords with a corresponding one of the plurality of partiality vectors, to select at least one product to present to the particular person.

14. The method of claim 13 wherein the partiality information that includes information regarding a particular person's propensity to behave as a first adopter includes a first adopter characterization for each of a plurality of product categories.

15. The method of claim 13 wherein the partiality information further includes, at least in part, information regarding a particular person's propensity to behave as a late adopter.

16. The method of claim 13 further comprising:
forming the partiality information regarding the particular person's propensity to behave as a first adopter as a function, at least in part, of objective information regarding the particular person.

17. The method of claim 16 wherein the objective information includes:
information regarding specific products acquired by the particular person;
a time of acquiring the specific products by the particular person; and
a time of product availability for the specific products acquired by the particular person.

18. The method of claim 16 further comprising:
forming the partiality information regarding the particular person's propensity to behave as a first adopter as a function, at least in part, of subjective information regarding the particular person.

19. The method of claim 18 wherein the subjective information includes information regarding at least one affinity group to which the particular person belongs.

20. The method of claim 18 wherein the subjective information includes information regarding social-networking expressions posted by the particular person.
